(19) United States
(12) Patent Application Publication
(10) Pub. No.: US 2023/0291895 A1
(43) Pub. Date: Sep. 14, 2023

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Sooyeon LEE, Seoul (KR); Sejin OH, Seoul (KR); Donggyu SIM, Seoul (KR); Joohyung BYEON, Seoul (KR); Hansol CHOI, Seoul (KR)

(21) Appl. No.: 18/016,771

(22) PCT Filed: Jul. 23, 2021
(86) PCT No.: PCT/KR2021/009573

§ 371 Date: Jan. 18, 2023

(30) Foreign Application Priority Data
Jul. 23, 2020 (KR) 10-2020-0091573
Aug. 6, 2020 (KR) 10-2020-0098748

(51) Int. Cl. H04N 19/107; H04N 19/136; H04N 19/105; H04N 19/423; H04N 19/13; H04N 19/167; H04N 19/597

(52) U.S. Cl. CPC H04N 19/107; H04N 19/136; H04N 19/105; H04N 19/423; H04N 19/13; H04N 19/167; H04N 19/597

(57) ABSTRACT

A point cloud data transmission method according to embodiments may comprise the steps of: acquiring point cloud data; encoding geometry information including the positions of points of the point cloud data by applying inter-prediction or intra-prediction; encoding attribute information including attribute values of the points of the point cloud data on the basis of the geometry information by applying the inter-prediction or intra-prediction; and transmitting the encoded geometry information, the encoded attribute information, and signaling information.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space (or volume). The point cloud content may express media configured in three dimensions, and is used to provide various services such as virtual reality (VR), augmented reality (AR), mixed reality (MR), extended reality (XR), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for efficiently transmitting and receiving a geometry-point cloud compression (G-PCC) bitstream.

Another object of the present disclosure is to provide a point cloud data transmission device, a point cloud data transmission method, a point cloud data reception device, and a point cloud data reception method that may enable inter-prediction reflecting information about a reference region and shift, rotation, affine transformation, and the like of the referenced region in encoding/decoding point cloud data by applying the inter-prediction.

Another object of the present disclosure is to provide a point cloud data transmission device and a point cloud data transmission method for representing the position of a reference region as a vector and efficiently processing multiple vectors in encoding/decoding point cloud data by applying the inter-prediction.

Another object of the present disclosure is to provide a point cloud data reception device and a point cloud data reception method for efficiently managing a buffer in encoding/decoding point cloud data by applying the inter-prediction.

Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with the purpose of the disclosure, as embodied and broadly described herein, a method of transmitting point cloud data, the method may include acquiring the point cloud data, encoding geometry information including positions of points of the point cloud data by applying inter-prediction or intra-prediction, encoding attribute information including attribute values of the points of the point cloud data by applying the inter-prediction or the intra-prediction based on the geometry information, and transmitting the encoded geometry information, the encoded attribute information, and signaling information.

In an embodiment, the signaling information may include information related to prediction of the point cloud data, and the information related to the prediction of the point cloud data may include geometry-related prediction information and attribute-related prediction information.

In an embodiment, the encoding of the geometry information may include deriving one or more reference regions of a current node of the geometry information from reconstructed geometry information stored in a buffer, and generating predicted geometry information based on the one or more derived reference regions, outputting a difference between the geometry information and the predicted geometry information as residual geometry information, and entropy-encoding the residual geometry information and outputting a geometry bitstream.

In an embodiment, the encoding of the geometry information may include reconstructing the geometry information by adding the predicted geometry information and the residual geometry information, and storing the reconstructed geometry information in the buffer for the derivation of the one or more reference regions from the reconstructed geometry information.

In an embodiment, the encoding of the geometry information may include storing, in the buffer, reconstructed geometry information temporally close to the geometry information to be currently encoded and removing, from the buffer, reconstructed geometry information temporally distant from the geometry information to be currently encoded.

In an embodiment, the signaling information further may include buffer management information related to management of the buffer.

In another aspect of the present disclosure, a device for transmitting point cloud data may include a data acquirer configured to acquire the point cloud data, a geometry encoder configured to encode geometry information including positions of points of the point cloud data by applying inter-prediction or intra-prediction, an attribute encoder configured to encode attribute information including attribute values of the points of the point cloud data by applying the inter-prediction or the intra-prediction based on the geometry information, and a transmitter configured to transmit the encoded geometry information, the encoded attribute information, and signaling information,

In an embodiment, the signaling information may include information related to prediction of the point cloud data, and the information related to the prediction of the point cloud data may include geometry-related prediction information and attribute-related prediction information.

In an embodiment, the geometry encoder may include a geometry information predictor configured to derive one or more reference regions of a current node of the geometry information from reconstructed geometry information stored in a buffer, and generating predicted geometry information based on the one or more derived reference regions, a residual geometry information generator configured to output a difference between the geometry information and the predicted geometry information as residual geometry information, and an entropy encoder configured to output entropy-encode the residual geometry information and output a geometry bitstream.

In an embodiment, the geometry encoder may include a geometry information reconstructor configured to reconstruct the geometry information by adding the predicted geometry information and the residual geometry information, and a buffer configured to store the reconstructed geometry information for the derivation of the one or more reference regions from the reconstructed geometry information.

In an embodiment, the geometry encoder may store, in the buffer, reconstructed geometry information temporally close to the geometry information to be currently encoded and remove, from the buffer, reconstructed geometry information temporally distant from the geometry information to be currently encoded.

In an embodiment, the signaling information further may include buffer management information related to management of the buffer.

In another aspect of the present disclosure, a method of receiving point cloud data may include receiving geometry information, attribute information, and signaling information, decoding the geometry information by applying inter-prediction or intra-prediction based on the signaling information and reconstructing positions of points, decoding the attribute information by applying the inter-prediction or the intra-prediction based on the signaling information and the geometry information and reconstructing attribute values of the points, and rendering the point cloud data that is reconstructed based on the positions and attribute values of the points.

In an embodiment, the signaling information may include information related to prediction of the point cloud data, and the information related to the prediction of the point cloud data may include geometry-related prediction information and attribute-related prediction information.

In an embodiment, the decoding of the geometry information may include entropy-decoding residual geometry information included in the received geometry information, deriving one or more reference regions of a current node of geometry information to be decoded from reconstructed geometry information stored in a buffer based on the signaling information, and generating predicted geometry information based on the one or more derived reference regions, and outputting reconstructed geometry information by adding the entropy-decoded residual geometry information and the predicted geometry information.

In an embodiment, the decoding of the geometry information further may include storing the reconstructed geometry information in the buffer for the derivation of the one or more reference regions from the reconstructed geometry information.

In an embodiment, the decoding of the geometry information further may include storing reconstructed geometry information temporally close to the geometry information to be currently decoded in the buffer and removing, from the buffer, reconstructed geometry information temporally distant from the geometry information to be currently decoded.

In an embodiment, the signaling information further may include buffer management information related to management of the buffer.

### Advantageous Effects

A point cloud data transmission method, a point cloud data transmission device, a point cloud data reception method, and a point cloud data reception device according to embodiments may provide a good-quality point cloud service.

A point cloud data transmission method, a point cloud data transmission device, a point cloud data reception method, and a point cloud data reception device according to embodiments may achieve various video codec methods.

A point cloud data transmission method, a point cloud data transmission device, a point cloud data reception method, and a point cloud data reception device according to embodiments may provide universal point cloud content such as a self-driving service (or an autonomous driving service).

A point cloud data transmission method, a point cloud data transmission device, a point cloud data reception method, and a point cloud data reception device according to embodiments may perform space-adaptive partition of point cloud data for independent encoding and decoding of the point cloud data, thereby improving parallel processing and providing scalability.

A point cloud data transmission method, a point cloud data transmission device, a point cloud data reception method, and a point cloud data reception device according to embodiments may perform encoding and decoding by partitioning the point cloud data in units of tiles and/or slices, and signal necessary data therefore, thereby improving encoding and decoding performance of the point cloud.

With a point cloud data transmission method, a point cloud data transmission device, a point cloud data reception method, and a point cloud data reception device according to embodiments, in performing inter-frame prediction (i.e., inter-prediction) during point cloud coding, the inter-frame prediction may be enabled based on information about a reference region and shift, rotation, affine transformation, and the like of the referenced region.

With a point cloud data transmission method, a point cloud data transmission device, a point cloud data reception method, and a point cloud data reception device according to embodiments, the position of a reference region may be represented as a vector and multiple vectors may be efficiently process in inter-frame prediction.

With a point cloud data transmission method, a point cloud data transmission device, a point cloud data reception method, and a point cloud data reception device according to embodiments, conditions such as affine may be reflected along with the existing simple shift and rotation. Thereby, accuracy of inter-frame prediction may be increased and an area usable as a reference region may be widened.

With a point cloud data transmission method, a point cloud data transmission device, a point cloud data reception method, and a point cloud data reception device according to embodiments, an issue related to limited use of storage and reference of reference point cloud data that may occur due to capacity limitations may be addressed through efficient buffer management. Therefore, with the point cloud data transmission method, point cloud data transmission device, point cloud data reception method, and point cloud data reception device, a buffer required for encoding/decoding may be efficiently managed.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of a point cloud content for each LOD according to embodiments.

FIG. 9 illustrates an example of point configuration of a point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operable in connection with point cloud data methods/devices according to embodiments.

FIG. 15 is a diagram illustrating another example of a point cloud transmission device according to embodiments.

FIG. 16 is a detailed block diagram of a geometry encoder and an attribute encoder according to embodiments.

FIG. 17 is an exemplary detailed block diagram of a geometry information predictor according to embodiments.

FIG. 18 is an exemplary detailed block diagram of a predictive geometry information generator according to embodiments.

FIG. 19 is an exemplary detailed block diagram of a reference region information deriver according to embodiments.

FIG. 20-(a) illustrates an example of starting voxel positions of M vectors and a reference region in a vector representation method according to embodiments.

FIG. 20-(b) illustrates another example of starting voxel positions of M vectors and a reference region in the vector representation method according to the embodiments.

FIG. 21-(a) illustrates an example of a vector reference node and a reference vector list according to embodiments.

FIG. 21-(b) illustrates another example of a vector reference node and a reference vector list according to embodiments.

FIG. 22 illustrates an example of derivation of a transformation parameter per reference region and transformation of geometry information about points in a reference region according to embodiments.

FIGS. 23-(a) to FIG. 23-(c) illustrate examples of a reference region derivation method according to embodiments.

FIG. 24 illustrates another example of a point cloud reception device according to embodiments.

FIG. 25 is a detailed block diagram illustrating another example of a geometry decoder and an attribute decoder according to embodiments.

FIG. 26 is a diagram illustrating an exemplary configuration of a reference point cloud list according to embodiments.

FIG. 27 is a flowchart illustrating an example of a method of managing a buffer according to embodiments.

FIG. 28 is a diagram illustrating an exemplary case where a decoding order and a display order of point cloud data are different from each other according to embodiments.

FIG. 29 illustrates an example of an inter-point-cloud reference structure and an RPS according to embodiments.

FIG. 30 is a diagram illustrating an example of a method of managing a buffer according to embodiments.

FIG. 31 is an exemplary detailed block diagram of the point cloud decoder of FIG. 30 according to embodiments.

FIG. 32 illustrates an example of a bitstream structure of point cloud data for transmission/reception according to embodiments.

FIG. 33 shows an exemplary syntax structure of a sequence parameter set according to embodiments.

FIG. 34 shows an exemplary syntax structure of a sequence parameter set including information related to prediction of point cloud data according to embodiments.

FIG. 35 is a table showing exemplary prediction modes for a current node allocated to a pred_mode field according to embodiments.

FIG. 36 is a table showing exemplary methods of representing reference region information related to a current node as allocated to a predarea_rep_idx field according to embodiments.

FIG. 37 shows an exemplary syntax structure of a sequence parameter set including buffer management information according to embodiments.

FIG. 38 is a table showing examples of data types of reconstructed geometry information allocated to a POC_geom_coordinates_type field according to embodiments.

FIG. 39 is a table showing exemplary information storage methods allocated to a POC_data_type field according to embodiments.

FIG. 40 is a table showing examples of data types of a motion vector allocated to a POC_motionvector_coordinates_type field according to embodiments.

FIG. 41 is a table showing examples of a duplicate point processing method allocated to a processing_method_type field according to embodiments.

FIG. 42 shows an exemplary syntax structure of a tile parameter set according to embodiments.

FIG. 43 shows an exemplary syntax structure of a tile parameter set including information related to prediction of point cloud data according to embodiments.

FIG. 44 shows another exemplary syntax structure of a tile parameter set including buffer management information according to embodiments.

FIG. 45 shows an exemplary syntax structure of a geometry parameter set according to embodiments.

FIG. 46 shows another exemplary syntax structure of a geometry parameter set including information related to prediction of point cloud data according to embodiments.

FIG. 47 shows another exemplary syntax structure of a geometry parameter set including buffer management information according to embodiments.

FIG. 48 shows an exemplary syntax structure of an attribute parameter set according to embodiments.

FIG. 49 shows another exemplary syntax structure of an attribute parameter set including information related to prediction of point cloud data according to embodiments.

FIG. 50 shows another exemplary syntax structure of an attribute parameter set including buffer management information according to embodiments.

FIG. 51 shows an exemplary syntax structure of a geometry slice bitstream( ) according to embodiments.

FIG. 52 shows an exemplary syntax structure of a geometry slice header according to embodiments.

FIG. 53 shows another exemplary syntax structure of a geometry slice header including information related to prediction of point cloud data according to embodiments.

FIG. 54 shows another exemplary syntax structure of a geometry slice header including buffer management information according to embodiments.

FIG. 55 shows an exemplary syntax structure of geometry slice data according to embodiments.

FIG. 56 shows another exemplary syntax structure of geometry slice data including buffer management information according to embodiments.

FIG. 57 shows an exemplary syntax structure of an attribute slice bitstream( ) according to embodiments.

FIG. 58 shows an exemplary syntax structure of an attribute slice header according to embodiments.

FIG. 59 shows another exemplary syntax structure of an attribute slice header including information related to prediction of point cloud data according to embodiments.

FIG. 60 shows an exemplary syntax structure of attribute slice data according to embodiments.

FIG. 61 shows an exemplary syntax structure of an RPS parameter set including buffer management information according to embodiments.

FIG. 62 is a flowchart of a point cloud data transmission method according to embodiments.

FIG. 63 is a flowchart of a point cloud data reception method according to embodiments.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present discloure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

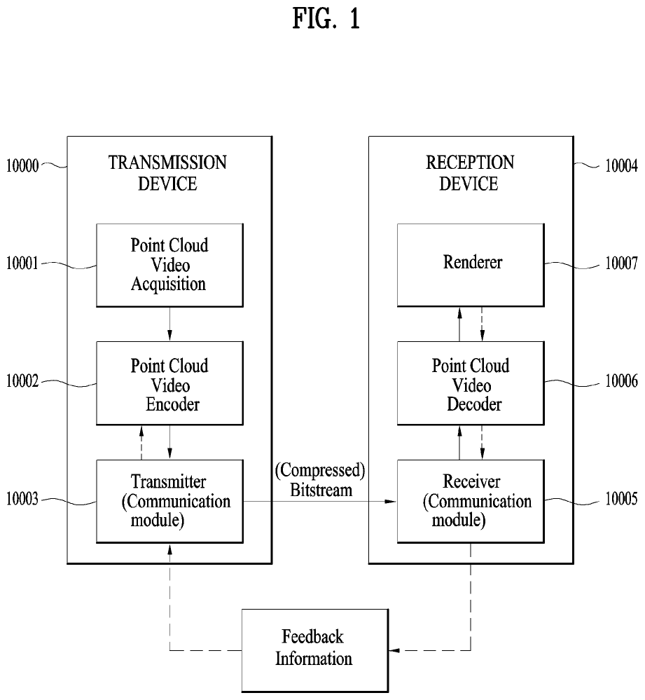

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component or module) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the reverse process of the point cloud compression. The point cloud decompression coding includes G-PCC coding.

The renderer 10007 renders the decoded point cloud video data. According to an emboidiment, the renderer 10007 may render the decoded point cloud data according to a viewport. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to the embodiments may represent information about a position, orientation, angle, and motion of a user's head. The reception device 10004 according to the embodiments may calculate viewport information based on the head orientation information. The viewport information is information about a region of a point cloud video that the user is viewing (that is, a region that the user is currently viewing). That is, the viewport information is information about a region that the user is currently viewing in the point cloud video. In other words, the viewport or viewport region may represent a region that the user is viewing in the point cloud video. A viewpoint is a point that the user is viewing in the point cloud video, and may represent a center point of the viewport region. That is, the viewport is a region centered on a viewpoint, and the size and shape of the region may be determined by a field of view (FOV). Accordingly, the reception device 10004 may extract the viewport information based on a vertical or horizontal FOV supported by the device as well as the head orientation information. In addition, the reception device 10004 may perform gaze analysis or the like based on the head orientation information and/or the viewport information to determine the way the user consumes a point cloud video, a region that the user gazes at in the point cloud video, and the gaze time. According to embodiments, the reception device 10004 may transmit feedback information including the result of the gaze analysis to the transmission device 10000. According to embodiments, a device such as a VR/XR/AR/MR display may extract a viewport region based on the position/orientation of a user's head and a vertical or horizontal FOV supported by the device. According to embodiments, the head orientation information and the viewport information may be referred to as feedback information, signaling information, or metadata.

The feedback information according to the embodiments may be acquired in the rendering and/or display process. The feedback information may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The feedback information may not only be transmitted to the transmitting side, but also be consumed by the receiving side. That is, the point cloud content providing system may process (encode/decode/render) point cloud data based on the feedback information. For example, the point cloud video decoder 10006 and the renderer 10007 may preferentially decode and render only the point cloud video for a region currently viewed by the user, based on the feedback information, that is, the head orientation information and/or the viewport information.

The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

Elements of the point cloud content providing system illustrated in FIG. 1 may be implemented as hardware, software, processors, and/or combinations thereof.

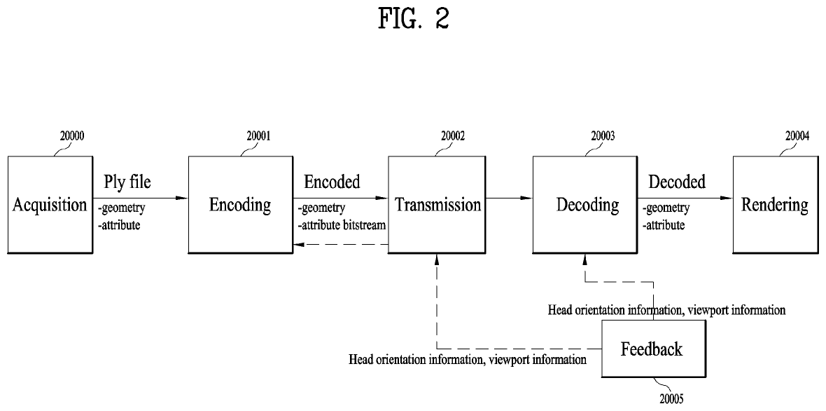

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC). The point cloud content providing system according to the embodiments (for example, the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like.

The point cloud content providing system (for example, the point cloud transmission device 10000 or the point cloud video acquisition unit 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (for example, the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

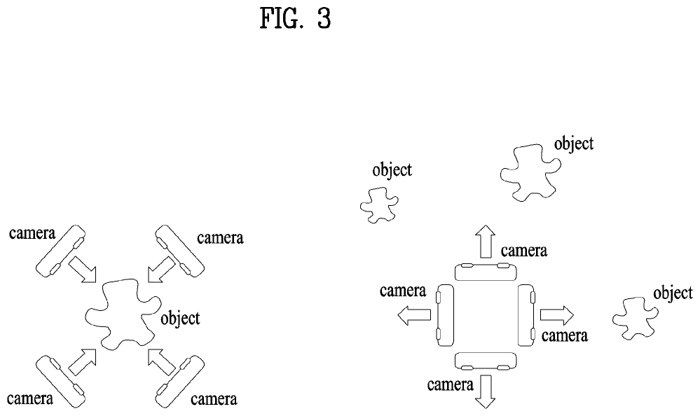

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

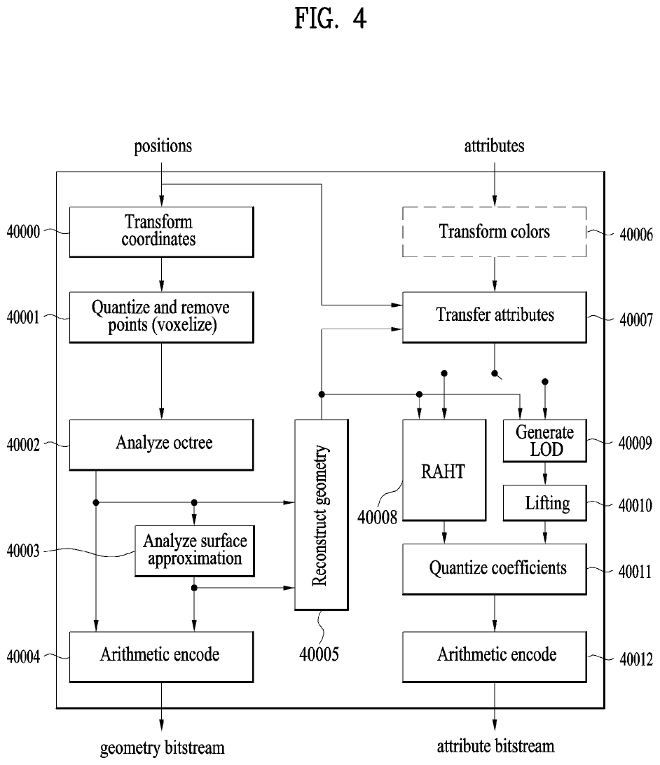

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 to 2, the point cloud video encoder may perform geometry encoding and attribute encoding. The geometry encoding is performed before the attribute encoding.

The point cloud video encoder according to the embodiments includes a coordinate transformation unit 40000, a quantization unit 40001, an octree analysis unit 40002, and a surface approximation analysis unit 40003, an arithmetic encoder 40004, a geometry reconstruction unit 40005, a color transformation unit 40006, an attribute transformation unit 40007, a region adaptive hierarchical transform (RAHT) transformation unit 40008, an LOD generation unit 40009, a lifting transformation unit 40010, a coefficient quantization unit 40011, and/or an arithmetic encoder 40012.

The coordinate transformation unit 40000, the quantization unit 40001, the octree analysis unit 40002, the surface approximation analysis unit 40003, the arithmetic encoder 40004, and the geometry reconstruction unit 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformation unit 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantization unit 40001 according to the embodiments quantizes the geometry information. For example, the quantization unit 40001 may quantize the points based on a minimum position value of all points (for example, a minimum value on each of the X, Y, and Z axes). The quantization unit 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantization unit 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantization unit 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analysis unit 40002 according to the embodiments performs octree geometry coding (or octree coding) to present voxels in an octree structure. The octree structure represents points matched with voxels, based on the octal tree structure.

The surface approximation analysis unit 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformation unit 40006, the attribute transformation unit 40007, the RAHT transformer 40008, the LOD generation unit 40009, the lifting transformation unit 40010, the coefficient quantization unit 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformation unit 40006 according to the embodiments performs color transform coding of transforming color values (or textures) included in the attributes. For example, the color transformation unit 40006 may transform the format of color information (for example, from RGB to YCbCr). The operation of the color transformation unit 40006 may be optionally applied according to the color values included in the attributes.

The geometry reconstruction unit 40005 according to the embodiments reconstructs (decompresses) the octree and/or the approximated octree. The geometry reconstruction unit 40005 reconstructs the octree/voxels based on the result of analyzing the distribution of points. The reconstructed octree/voxels may be referred to as reconstructed geometry (restored geometry).

The attribute transformation unit 40007 according to the embodiments performs attribute transformation to transform the attributes based on the reconstructed geometry and/or the positions on which geometry encoding is not performed. As described above, since the attributes are dependent on the geometry, the attribute transformation unit 40007 may transform the attributes based on the reconstructed geometry information. For example, based on the position value of a point included in a voxel, the attribute transformation unit 40007 may transform the attribute of the point at the position. As described above, when the position of the center of a voxel is set based on the positions of one or more points included in the voxel, the attribute transformation unit 40007 transforms the attributes of the one or more points. When the trisoup geometry encoding is performed, the attribute transformation unit 40007 may transform the attributes based on the trisoup geometry encoding.

The attribute transformation unit 40007 may perform the attribute transformation by calculating the average of attributes or attribute values of neighboring points (e.g., color or reflectance of each point) within a specific position/radius from the position (or position value) of the center of each voxel. The attribute transformation unit 40007 may apply a weight according to the distance from the center to each point in calculating the average. Accordingly, each voxel has a position and a calculated attribute (or attribute value).

The attribute transformation unit 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) may be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformation unit 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generation unit 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generation unit 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformation unit 40010 according to the embodiments performs lifting transform coding of transforming the attributes a point cloud based on weights. As described above, lifting transform coding may be optionally applied.

The coefficient quantization unit 40011 according to the embodiments quantizes the attribute-coded attributes based on coefficients.

The arithmetic encoder 40012 according to the embodiments encodes the quantized attributes based on arithmetic coding.

Although not shown in the figure, elements of the point cloud video encoder of FIG. 4 may be implemented as hardware including one or more processors or integrated circuits configured to communicate with one or more memories included in the point cloud content providing device, software, firmware, or combinations thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

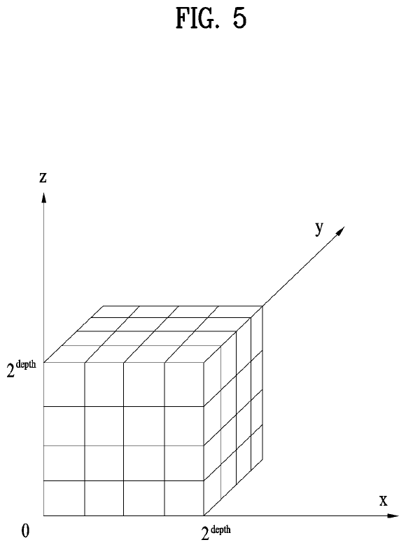

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantization unit 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2d, 2d, 2d) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

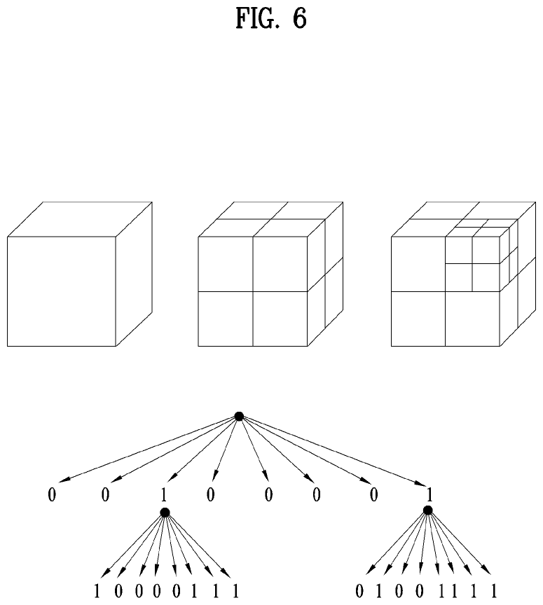

FIG. 6 shows an example of an octree and occupancy code according to embodiments.

As described with reference to FIGS. 1 to 4, the point cloud content providing system (the point cloud video encoder 10002 or the octree analysis unit 40002 of the point cloud video encoder) performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1)) Equation 1

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (e.g., the arithmetic encoder 40004) according to the embodiments may perform entropy encoding on the occupancy codes. In order to increase the compression efficiency, the point cloud video encoder may perform intra/inter-coding on the occupancy codes. The reception device (e.g., the reception device 10004 or the point cloud video decoder 10006) according to the embodiments reconstructs the octree based on the occupancy codes.

The point cloud video encoder (e.g., the octree analysis unit 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (e.g., the surface approximation analysis unit 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (e.g., the geometry reconstruction unit 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$[ Equation 2 ]$$

$$[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] ; \qquad i )$$

$$[ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] ; \qquad ii )$$

$$[ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] . \qquad iii )$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of 0 is estimated through a tan 2(bi, ai), and the vertices are ordered based on the value of 0. Table 1 below shows a combination of vertices for creating a triangle according to the number of the vertices. The vertices are ordered from 1 to n. Table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 1
Triangles formed from vertices ordered 1, . . . , n

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), (9, 1, 5) |
| 11 | (1, 2, 3), (3, 4, 5), (5, 6, 7), (7, 8, 9), (9, 10, 11), (11, 1, 3), (3, 5, 7), (7, 9, 11), (11, 3, 7) |
| 12 | (1, 2, 3), (3, 4, 5), (5, 6, 7), (7, 8, 9), (9, 10, 11), (11, 12, 1), (1, 3, 5), (5, 7, 9), (9, 11, 1), (1, 5, 9) |

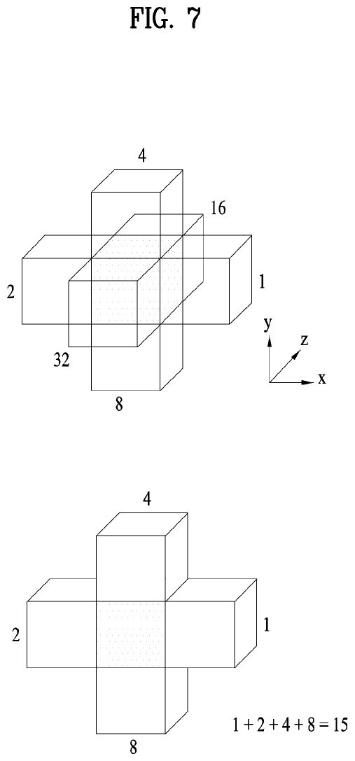

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values). FIG. 7 shows an example of a neighbor node pattern according to embodiments. In order to increase the compression efficiency of the point cloud video, the point cloud video encoder according to the embodiments may perform entropy coding based on context adaptive arithmetic coding.

The point cloud video encoder may entropy encode based on a context adaptive arithmetic coding to enhance compression efficiency of the point cloud video.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 23=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The upper part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (e.g., when the neighbor node pattern value is 63, 64 kinds of coding may be performed). According to embodiments, the point cloud video encoder may reduce coding complexity by changing a neighbor node pattern value (based on, for example, a table by which 64 is changed to 10 or 6).

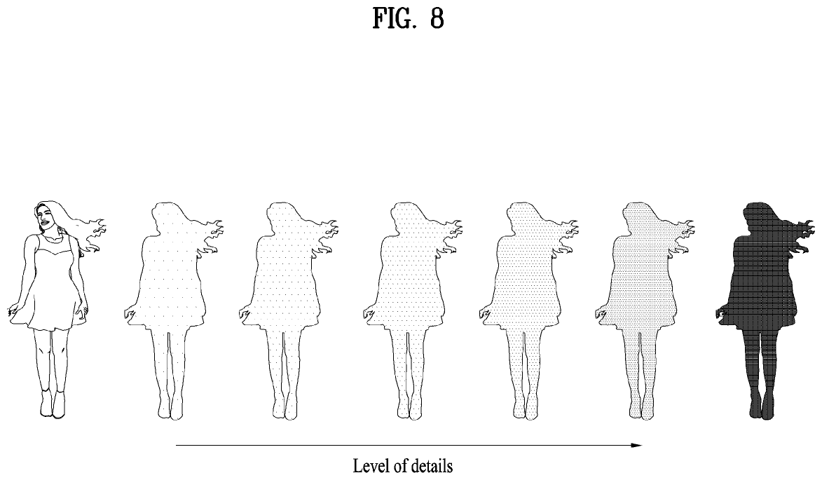

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (e.g., the LOD generator 40009) may classify (reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

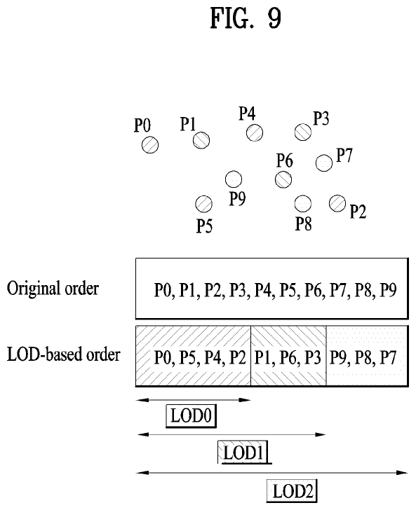

FIG. 9 illustrates an example of point configuration for each LOD according to embodiments.

As described with reference to FIGS. 1 to 8, the point cloud content providing system, or the point cloud video encoder (e.g., the point cloud video encoder 10002 of FIG. 1, the point cloud video encoder of FIG. 4, or the LOD generation unit 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (e.g., the coefficient quantization unit 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in Tble 3.

TABLE 2

int PCCQuantization(int value, int quantStep) {
if( value >=0) {
return floor(value/quantStep + 1.0/3.0);
} else {
return −floor(−value/quantStep + 1.0/3.0);
}
}

TABLE 3

int PCCInverseQuantization(int value, int quantStep) {
if( quantStep == 0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. When the predictor of each point has no neighbor point, the point cloud video encoder (e.g., the arithmetic encoder 40012) may perform entropy coding on the attributes of the corresponding point without performing the above-described operation. The point cloud video encoder (e.g., the lifting transformation unit 40010) may generate a predictor for each point, set the calculated LOD and register neighbor points in the predictor, and set weights according to the distances to the neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to the embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud video encoder (e.g., coefficient quantization unit 40011) according to the embodiments quantizes the predicted attribute values. In addition, the point cloud video encoder (e.g., the arithmetic encoder 40012) performs entropy coding on the quantized attribute values.

The point cloud video encoder (e.g., the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$[ Equation 3 ]$$

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 40012). The weights are calculated as wₗ_{_{−1x,y,z}}=wₗ_{_{2x,y,z}}+wₗ_{_{2x+1,y,z}}. The root node is created through the g₁_{_{0,0,0}} and g₁_{_{0,0,1}} as Equation 4.

$$[ Equation 4 ]$$

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

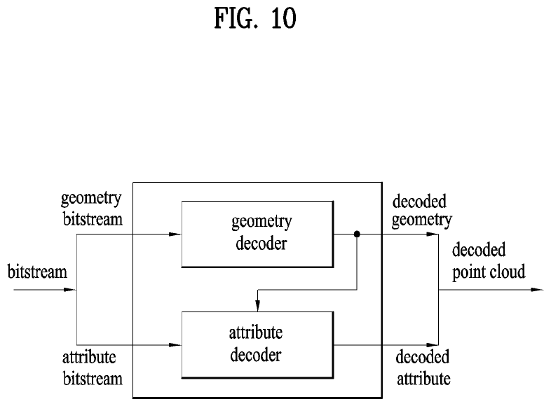

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

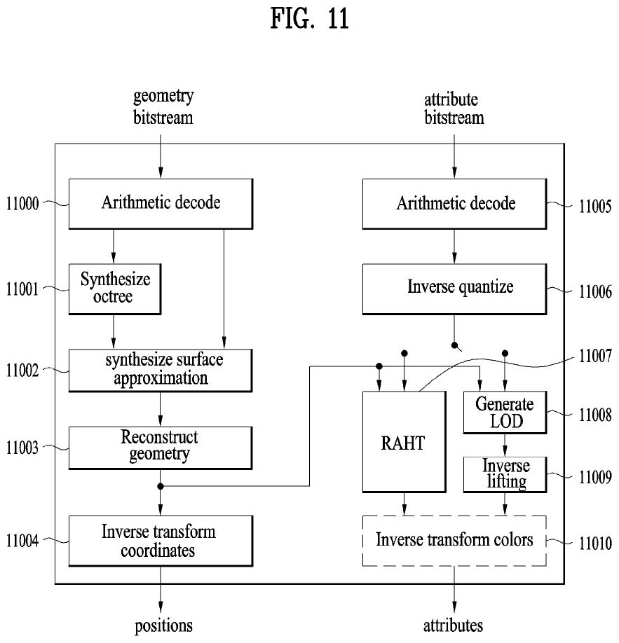

FIG. 11 illustrates a point cloud video decoder according to embodiments.

The point cloud video decoder illustrated in FIG. 11 is an example of the point cloud video decoder illustrated in FIG. 10, and may perform a decoding operation, which is a reverse process of the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstruction unit (Reconstruct geometry) 11003, a coordinate inverse transformer (Inverse transform coordinates) 11004, an arithmetic decoder (Arithmetic decode) 11005, an inverse quantization unit (Inverse quantize) 11006, a RAHT transformer 11007, an LOD generation unit (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstruction unit 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an reverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the reverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstruction unit 11003 according to the embodiments may regenerate geometry based on the surface and/or the decoded geometry. As described with reference to FIGS. 1 to 9, direct coding and trisoup geometry encoding are selectively applied. Accordingly, the geometry reconstruction unit 11003 directly imports and adds position information about the points to which direct coding is applied. When the trisoup geometry encoding is applied, the geometry reconstruction unit 11003 may reconstruct the geometry by performing the reconstruction operations of the geometry reconstruction unit 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantization unit 11006, the RAHT transformer 11007, the LOD generation unit 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantization unit 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generation unit 11008, and/or the inverse lifter 11009 may process the reconstructed geometry and the inversely quantized attributes. As described above, the RAHT transformer 11007, the LOD generation unit 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformation unit 40006 of the point cloud video encoder.

Although not shown in the figure, elements of the point cloud video decoder of FIG. 11 may be implemented as hardware including one or more processors or integrated circuits configured to communicate with one or more memories included in the point cloud content providing device, software, firmware, or combinations thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

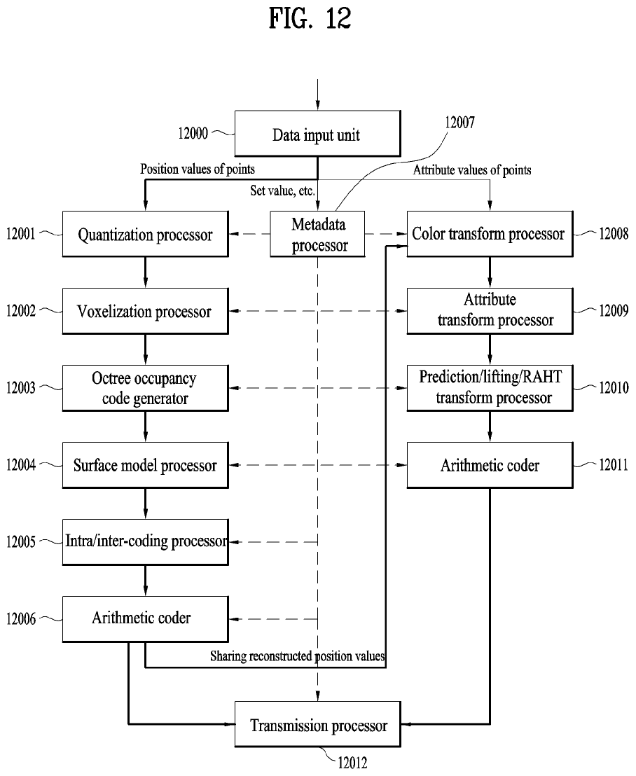

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantization unit 40001 described with reference to FIG. 4. Details are the same as those described with reference to FIGS. 1 to 9.

The voxelization processor 12002 voxelizes the quantized position values of the points. The voxelization processor 12002 may perform an operation and/or process the same or similar to the operation and/or the voxelization process of the quantization unit 40001 described with reference to FIG. 4. Details are the same as those described with reference to FIGS. 1 to 9.

The octree occupancy code generator 12003 performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analysis unit 40002) described with reference to FIGS. 4 and 6. Details are the same as those described with reference to FIGS. 1 to 9.

The surface model processor 12004 according to the embodiments may perform trigsoup geometry encoding based on a surface model to reconstruct the positions of points in a specific region (or node) on a voxel basis. The surface model processor 12004 may perform an operation and/or method the same as or similar to the operation and/or method of the point cloud video encoder (e.g., the surface approximation analysis unit 40003) described with reference to FIG. 4. Details are the same as those described with reference to FIGS. 1 to 9.

The intra/inter-coding processor 12005 may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformation unit 40006 described with reference to FIG. 4 is performed. A detailed description thereof is omitted.

The attribute transform processor 12009 performs attribute transformation to transform the attributes based on the reconstructed geometry and/or the positions on which geometry encoding is not performed. The attribute transform processor 12009 performs an operation and/or method the same as or similar to the operation and/or method of the attribute transformation unit 40007 described with reference to FIG. 4. A detailed description thereof is omitted. The prediction/lifting/RAHT transform processor 12010 may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generation unit 40009, and the lifting transformation unit 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 may encode the coded attributes based on the arithmetic coding. The arithmetic coder 12011 performs an operation and/or method the same as or similar to the operation and/or method of the arithmetic encoder 40012.

The transmission processor 12012 may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰. The TPS (or tile inventory) according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 may perform an operation and/or transmission method the same as or similar to the operation and/or transmission method of the transmitter 10003. Details are the same as those described with reference to FIGS. 1 and 2, and thus a description thereof is omitted.

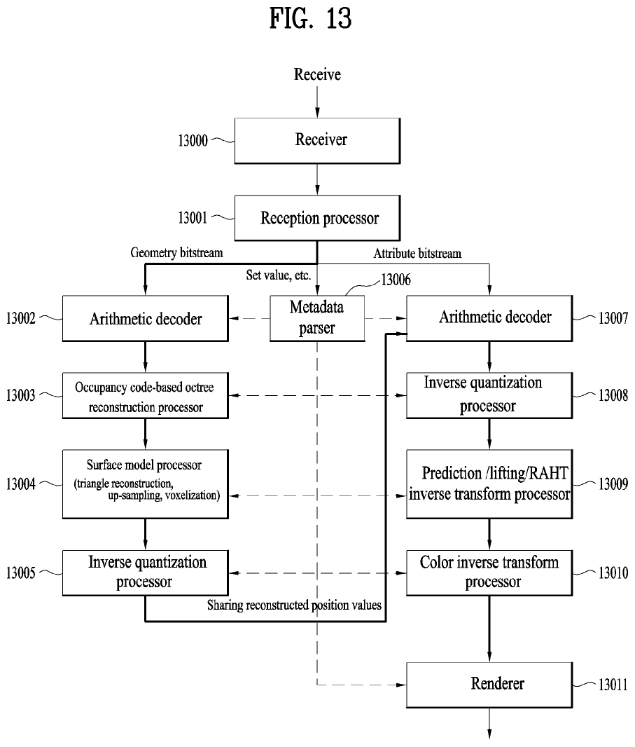

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment may include a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform a reverse process of the operation of a corresponding element for encoding according to the embodiments.

The receiver 13000 receives point cloud data. The receiver 13000 may perform an operation and/or reception method the same as or similar to the operation and/or reception method of the receiver 10005 of FIG. 1. A detailed description thereof is omitted.

The reception processor 13001 may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 may perform trisoup geometry decoding and related geometry reconstruction (e.g., triangle reconstruction, up-sampling, voxelization) based on the surface model method. The surface model processor 13004 performs an operation the same as or similar to that of the surface approximation synthesizer 11002 and/or the geometry reconstruction unit 11003.

The inverse quantization processor 13005 may inversely quantize the decoded geometry.

The metadata parser 13006 may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 may inversely quantize the decoded attribute bitstream. The inverse quantization processor 13008 performs an operation and/or method the same as or similar to the operation and/or inverse quantization method of the inverse quantization unit 11006.

The prediction/lifting/RAHT inverse transform processor 13009 may process the reconstructed geometry and the inversely quantized attributes. The prediction/lifting/RAHT inverse transform processor 13009 performs one or more of operations and/or decoding which are the same as or similar to the operations and/or decoding of the RAHT transformer 11007, the LOD generation unit 11008, and/or the inverse lifter 11009. The color inverse transform processor 13010 performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 may render the point cloud data.

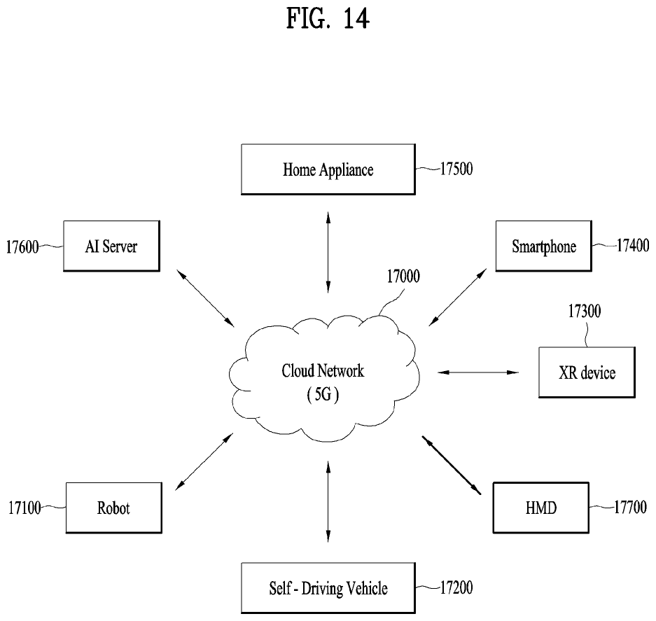

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17000. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception according to the above-described embodiments.

<PCC+XR>

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

<PCC+Self-Driving+XR>

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described with reference to FIGS. 1 to 14, point cloud data is composed of a set of points, and each of the points may have geometry (or referred to as geometry information) and attributes (or referred to as attribute information). The geometry information is 3D position information (e.g, x, y, and z coordinates) about each point. That is, the position of each point is represented by parameters of a coordinate system representing a three-dimensional space (e.g., parameters x, y, and z for three axes representing the space, such as the X-axis, Y-axis, and Z-axis). In addition, the attribute information represents a color (RGB, YUV, etc.), reflectance, a normal vectors transparency, and the like of the point. The attribute information may be expressed in a scalar or vector form.

According to embodiments, the point cloud data may be classified into category 1 of static point cloud data, category 2 of dynamic point cloud data, and category 3, which is acquired through dynamic movement, according to the type and acquisition method of the point cloud data. For example, the data of Category 1 is composed of a point cloud of a single frame with a high density of points for an object or space. The data of category 3 is divided into frame-based data having multiple frames acquired through dynamic movement and fused data of a fused single frame obtained by matching a point cloud acquired through a LiDAR sensor and a color image acquired as a 2D image for a large space.

According to embodiments, in order to efficiently compress 3D point cloud data having multiple frames according to time, such as frame-based point cloud data having multiple frames, inter-prediction coding/decoding may be used. Inter-prediction coding/decoding may be applied to either geometry information or attribute information, or both. According to embodiments, intra-prediction may be referred to as intra-frame prediction, and inter-prediction may be referred to as inter-frame prediction. That is, point cloud data having one frame may be subjected to inter-prediction.

In the present disclosure, inter-prediction coding/decoding is applied to increase the compression efficiency and processing speed of point cloud data having one or more frames, and an efficient signaling method for a reference region is proposed.

In the present disclosure, a method of coding a reference region using a vector and forming various prediction nodes for effective compression of point cloud data having multiple frames is proposed.

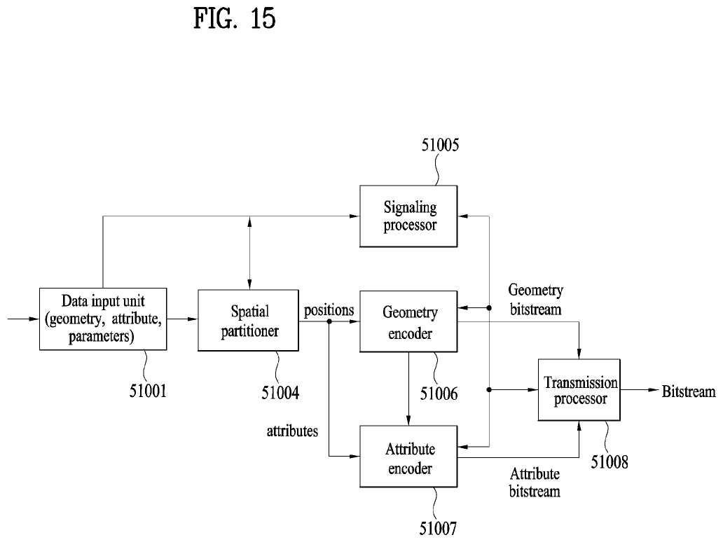

FIG. 15 is a diagram illustrating another example of a point cloud transmission device according to embodiments.

The point cloud transmission device according to the embodiments may include a data input unit 51001, a spatial partitioner 51004, a signaling processor 51005, a geometry encoder 51006, an attribute encoder 51007, and a transmission processor 51008. According to embodiments, the spatial partitioner 51004, the geometry encoder 51006, and the attribute encoder 51007 may be referred to as a point cloud video encoder.

The data input unit 51001 may perform some or all of the operations of the point cloud video acquisition unit 10001 in FIG. 1 or some or all of the operations of the data input unit 12000 in FIG. 12.

Point cloud data input through the data input unit 51001 may be composed of geometry information and/or attribute information about each point.

The geometry information may be a coordinate vector of (x, y) in a 2-dimensional Cartesian coordinate system, (γ, θ) in a cylindrical coordinate system, (x, y, z) in a 3-dimensional Cartesian coordinate system, (γ, θ, z) in a cylindrical coordinate system, or (γ, θ, ϕ) in a spherical coordinate system.

The attribute information may be a vector of values acquired from one or more sensors, such as a vector (R, G, B) representing the color of a point, and/or a brightness value, and/or a reflection coefficient of LiDAR, and/or a temperature obtained from a thermal imaging camera. The spatial partitioner 51004 may spatially partition the point cloud data input through the data input unit 51001 into one or more 3D blocks based on a bounding box and/or a sub-bounding box. In this case, the 3D block may represent a tile group, a tile, a slice, a coding unit (CU), a prediction unit (PU), or a transformation unit (TU). The partitioning may be performed based on at least one of an octree, a quadtree, a binary tree, a triple tree, or a k-d tree. Alternatively, the data may be partitioned into blocks of predetermined width and height. Alternatively, the partitioning may be performed by selectively determining various positions and sizes of blocks. That is, input point cloud data may be partitioned into voxel groups such as slices, tiles, bricks, or subframes. In addition, the input point cloud data may be equally or unequally partitioned by one or more axes in a Cartesian coordinate system (x, y, z), a cylindrical coordinate system (γ, θ, z), or a spherical coordinate system (γ, θ, ϕ). In addition, signaling information for the partitioning is entropy-encoded by the signaling processor 51005 and then transmitted in the form of a bitstream via the transmission processor 51008.

In one embodiment, the point cloud content may be one person such as an actor, several people, one object, or several objects, but to a greater extent. In a broader sense, it may be a map for self-driving or a map for indoor navigation of a robot. In such cases, point cloud content may be a vast amount of locally linked data. In this case, the point cloud content cannot be encoded/decoded at once, and therefore tile partitioning may be performed before compressing the point cloud content. For example, in a building, room #101 may be partitioned into one tile and room #102 may be partitioned into another tile. In order to support fast encoding/decoding by applying parallelization to the partitioned tiles, the tiles may be partitioned into slices again. This operation may be referred to as slice partitioning (or splitting).

That is, a tile may represent a partial region (e.g., a rectangular cuboid) of a 3D space occupied by point cloud data according to embodiments. According to embodiments, a tile may include one or more slices. The tile may be partitioned into one or more slices, and thus the point cloud video encoder may encode point cloud data in parallel.

A slice may represent a unit of data (or bitstream) that may be independently encoded by the point cloud video encoder according to the embodiments and/or a unit of data (or bitstream) that may be independently decoded by the point cloud video decoder. A slice may be a set of data in a 3D space occupied by point cloud data, or a set of some data among the point cloud data. A slice ments may represent a region or set of points included in a tile according to embodiments. According to embodiments, a tile may be partitioned into one or more slices based on the number of points included in the tile. For example, one tile may be a set of points partitioned by the number of points. According to embodiments, a tile may be partitioned into one or more slices based on the number of points, and some data may be split or merged in the partitioning process. That is, a slice may be a unit that may be independently coded within a corresponding tile. A tile obtained by spatial partitioning as described above, may be partitioned into one or more slices for fast and efficient processing.

The point cloud video encoder according to the embodiments may encode point cloud data on a slice-by-slice basis or a tile-by-tile basis, wherein a tile may include one or more slices. In addition, the point cloud video encoder may perform different quantization and/or transformation on each tile or each slice.

Positions of one or more 3D blocks (e.g., slices) spatially partitioned by the spatial partitioner 51004 are output to a geometry encoder 51006, and attribute information (or referred to as attributes) is output to the attribute encoder 51007. The positions may be position information about points included in a partitioned unit (a box, block, coding unit, prediction unit, transformation unit, tile, tile group, or slice), and is referred to as geometry information.

The geometry encoder 51006 may perform some or all of the operations of the point cloud video encoder 10002 of FIG. 1, the encoding 20001 of FIG. 2, the point cloud video encoder of FIG. 4, and the point cloud video encoder of FIG. 12.

The geometry encoder 51006 compresses the positions (i.e., geometry information) output from the spatial partitioner 51004 by intra-prediction or inter-prediction, performs entropy coding, and outputs a geometry bitstream. According to embodiments, encoding by the geometry encoder 51006 may be performed on the entire point cloud or according to sub-point cloud units or coding units (CUs), and inter-prediction (i.e., inter-frame prediction) or intra-prediction (i.e., intra-frame prediction) may be selected for each CU. Also, an inter-prediction mode or an intra-prediction mode may be selected for each prediction unit. The geometry bitstream generated by the geometry encoder 51006 may be transmitted to the reception device via the transmission processor 51008. Also, the geometry information compressed by inter-prediction or intra-prediction is reconstructed for attribute compression. The reconstructed geometry information (or referred to as restored geometry information) is output to the attribute encoder 51007.

The attribute encoder 51007 compresses the attribute information output from the spatial partitioner 51004 using intra-prediction or inter-prediction based on the reconstructed geometry information, and performs entropy coding to output an attribute bitstream. The attribute bitstream generated by the attribute encoder 51007 may be transmitted to the reception device via the transmission processor 51008.

The transmission processor 51008 may perform an operation and/or transmission method identical or similar to the operation and/or transmission method of the transmission processor 12012 of FIG. 12, and perform an operation and/or transmission method identical or similar to the operation and/or transmission method of the transmitter 10003 of FIG. 1. For details, refer to the description of FIG. 1 or 12.

The transmission processor 51008 may transmit the geometry bitstream output from the geometry encoder 51006, the attribute bitstream output from the attribute encoder 51007, and the signaling bitstream output from the signaling processor 51005, respectively, or may transmit one bitstream into which the bitstreams are multiplexed.

The transmission processor 51008 may encapsulate the bitstream into a file or segment (e.g., a streaming segment) and then transmit the encapsulated bitstream over various networks such as a broadcasting network and/or a broadband network.

The signaling processor 51005 may generate and/or process signaling information and output the same to the transmission processor 51008 in the form of a bitstream. The signaling information generated and/or processed by the signaling processor 51005 may be provided to the geometry encoder 51006, the attribute encoder 51007, and/or the transmission processor 51008 for geometry encoding, attribute encoding, and transmission processing. Alternatively, the signaling processor 51005 may receive signaling information generated by the geometry encoder 51006, the attribute encoder 51007, and/or the transmission processor 51008.

In the present disclosure, the signaling information may be signaled and transmitted on a per parameter set (sequence parameter set (SPS), geometry parameter set (GPS), attribute parameter set (APS), tile parameter set (TPS), or the like) basis. Alternatively, it may be signaled and transmitted on the basis of a coding unit of each image, such as slice or tile. In the present disclosure, the signaling information may include metadata (e.g., set values) related to point cloud data, and may be provided to the geometry encoder 51006, the attribute encoder 51007, and/or the transmission processor 51008 for geometry encoding, attribute encoding, and transmission processing. Depending on the application, the signaling information may also be defined at the system side, such as a file format, dynamic adaptive streaming over HTTP (DASH), or MPEG media transport (MMT), or at the wired interface side, such as high definition multimedia interface (HDMI), Display Port, Video Electronics Standards Association (VESA), or CTA.

Although not shown in the figure, elements of the point cloud transmission device of FIG. 15 may be implemented as hardware including one or more processors or integrated circuits configured to communicate with one or more memories, software, firmware, or combinations thereof. The one or more processors may perform at least one of the operations and/or functions of the elements of the point cloud transmission device of FIG. 15 described above. Additionally, the one or more processors may operate or execute a set of software programs and/or instructions for execution of the operations and/or functions of the elements of the point cloud transmission device of FIG. 15. The one or more memories may include a high speed random access memory, or include a non-volatile memory (e.g., one or more magnetic disk storage devices, flash memory devices, or other non-volatile solid-state memory devices).

According to embodiments, in order to perform inter-prediction in FIG. 15, information about a reference frame or a prediction unit to be referenced should be generated. In conventional cases, the content to be sent as reference prediction information is determined. Further, there is no method to reflect a modified form when inter-prediction is performed based on the reference prediction information. In addition, since the modified form can be reflected only for shift and rotation of a current simple reference region, prediction accuracy may deteriorate due to the limitation of candidate regions to which the reference region is applicable.

The present disclosure, which is intended to address the aforementioned issues, proposes a method for signaling reference prediction information and information that may reflect not only a simple shift but also a state of a modified form based on the reference prediction information when inter-prediction is performed by the point cloud transmission device of FIG. 15.

According to embodiments, a reference frame may be a frame referenced (or involved) in order to encode/decode a current frame. Here, the reference frame may be a frame before the current frame, the next frame after the current frame, or a plurality of previous frames. Here, a frame may be referred to as a picture.

In the present disclosure, inter-prediction may be processed in a different manner according to preconfigured information. Also, predicted geometry information may vary according to the mode.

In the present disclosure, reference region information may be disginuished by an index. The reference region information may be represented as a vector.

According to the present disclosure, multiple vectors may be efficiently coded. In addition, according to the present disclosure, inter-prediction may be performed by vectors, matrix transformation, rotation transformation, affine transformation, and the like based on the reference region information according to the representation mode.

In the present disclosure, the reference region information may be divided into sub-units and processed, and respective pieces of sub-reference region information may be processed in different representation moded.

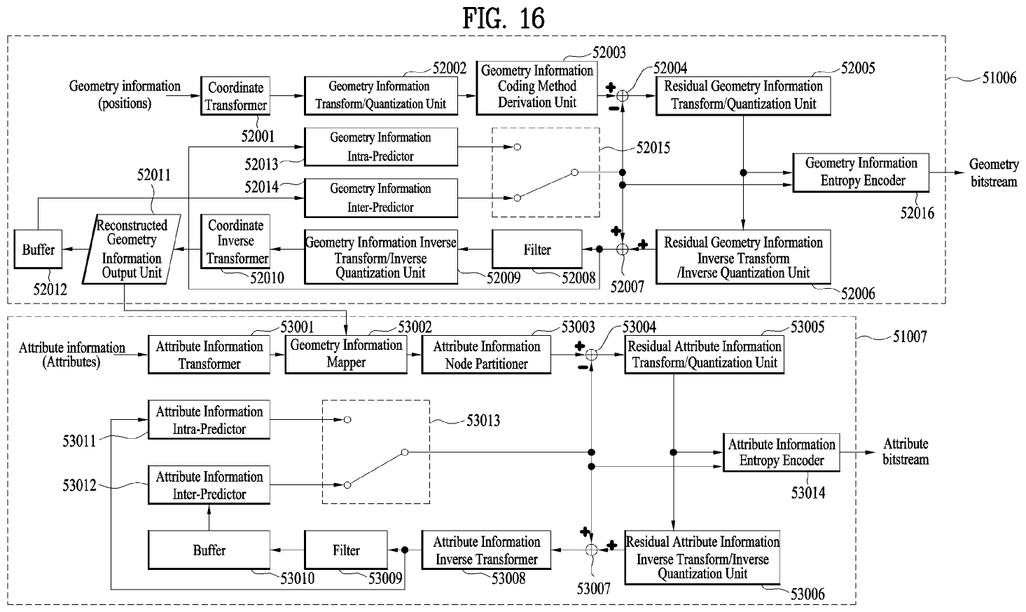

FIG. 16 is a detailed block diagram of a geometry encoder and an attribute encoder according to embodiments. The geometry encoder and attribute encoder of FIG. 16 may include one or more processors and one or more memories electrically or communicatively coupled with the one or more processors for compression of geometry information and attribute information. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for processing the point cloud data.

Elements of the point geometry encoder and attribute encoder shown in FIG. 16 may be implemented as hardware, software, processors, and/or combinations thereof.

In FIG. 16, the geometry encoder 51006 may include a coordinate transformer 52001, a geometry information transform/quantization unit 52002, a geometry information coding method derivation unit 52003, a subtractor 52004, a residual geometry information transform/quantization unit 52005, a residual geometry information inverse transform/inverse quantization unit 52006, an adder 52007, a filter 52008, a geometry information inverse transform/inverse quantization unit 52009, a coordinate inverse transformer 52010, a reconstructed geometry information output unit 52011, a buffer 52012, a geometry information intra-predictor 52013, a geometry information inter-predictor 52014, a switching unit 52015, and a geometry information entropy encoder 52016. The buffer 52012 may be referred to as a memory or a reconstructed point cloud buffer. Instead of the spatial partitioner 51004 of FIG. 15, a geometry information partitioner may be provided in front of the coordinate transformer 52001. In this case, the geometry information partitioner may partition input geometry information into slices, tiles, bricks, subframes, or the like.

In FIG. 16, the attribute encoder 51007 may include an attribute information transformer 53001, a geometry information mapper 53002, an attribute information node partitioner 53003, a subtractor 53004, a residual attribute information transform/quantization unit 53005, a residual attribute information inverse transform/inverse quantization unit 53006, an adder 53007, an attribute information inverse transformer 53008, a filter 53009, a buffer 53010, an attribute information intra-predictor 53011, an attribute information inter-predictor 53012, a switching unit 53013, and an attribute information entropy encoder 53014. The buffer 53010 may be referred to as a memory or a reconstructed point cloud buffer.

The buffer 52012 of the geometry encoder 51006 and the buffer 53010 of the attribute encoder 51007 may be the same buffer or separate buffers. That is, the reconstructed geometry information and reconstructed attribute information may be managed in one buffer or independent buffers. When the information is managed in independent buffers, mapping between the geometry information and the attribute information may be performed by storing the reconstructed geometry information and the reconstructed attribute information in the same order.

According to embodiments, point cloud data may be input to the coordinate transformer 52001 on a frame-by-frame basis or in units of geometry information partitioned by the spatial partitioner 51004 or the geometry information partitioner. The coordinate transformer 52001 may transform the coordinates of geometry information related to the input point cloud data into other coordinates. Alternatively, coordinate transformation may not be performed. In an embodiment of the present disclosure, the coordinate transformation is performed. The geometry information whose coordinates are transformed by the coordinate transformer 52001 are provided to the geometry information transform/quantization unit 52002.

Information about whether coordinate transformation is performed by the coordinate transformer 52001 and the coordinate information may be signaled for each unit such as sequence, frame, tile, slice, block, or the like, or may be derived based on the status of coordinate transformation of neighbor blocks, the size of a block, the number of points, a quantization value, a block partitioning depth, a position of the unit, a distance between the unit and the origin, and the like

In the case where the coordinates is transformed after checking whether the coordinates are to be transformed, the coordinate information to be transformed may be signaled for each units such as sequence, frame, tile, slice, block, or the like, or may be derived based on the status of coordinate transformation of neighbor blocks, the size of a block, the number of points, a quantization value, a block partitioning depth, a position of the unit, a distance between the unit and the origin, and the like.

The geometry information transform/quantization unit 52002 receives geometry information on which coordinate transformation has or has not been performed as an input, performs one or more transformations such as position transformation and/or rotation transformation thereon, and partitions and quantizes geometry information by a quantization value (or quantization parameter) to generate transformed quantized geometry information. The transformed quantized geometry information generated by the geometry information transformation quantization unit 52002 is provided to the geometry information coding method derivation unit 52003.

The geometry information coding method derivation unit 52003 may derive or determine a coding method such as a partitioning mode and a coding mode of the geometry information by receives the transformed quantized geometry information in each unit such as frame, slice, or tile. In addition, the status of execution of the residual geometry information transform/quantization unit 52005, the geometry information intra-predictor 52013, and the geometry information inter-predictor 52014 and the execution method therefor may be derived according to the coding method determined by the geometry information coding method derivation unit 52003.

The subtractor 52004 outputs the difference (referred to as residual geometry information) between the geometry information input through the geometry information coding method derivation unit 52003 and the intra-predicted or inter-predicted geometry information into residual geometry information to the residual geometry information transform/quantization unit 52005.

The residual geometry information transform/quantization unit 52005 receives residual geometry information corresponding to the difference between the geometry information and the predicted geometry information, and then transforms the same or quantizes the same with a quantization value (or referred to as a quantization parameter) to generate quantized residual geometry information. The quantized residual geometry information generated by the residual geometry information transform/quantization unit 52005 is provided to the geometry information entropy encoder 52016 and the residual geometry information inverse transform/inverse quantization unit 52006.

The geometry information entropy encoder 52016 receives the quantized residual geometry information and prediction information (or referred to as geometry-related prediction information) and performs entropy encoding. The prediction information may be predicted geometry information output from the geometry information intra-predictor 52013 or the geometry information inter-predictor 52014, or information related to geometry information prediction. The geometry information entropy encoder 52016 may use various encoding methods such as, for example, exponential Golomb, context-adaptive variable length coding (CAVLC), and context-adaptive binary arithmetic coding (CABAC). As a result of the entropy encoding by the geometry information entropy encoder 52016, a geometry bitstream is generated. The geometry bitstream is transmitted to the reception device via the transmission processor 51008.

The residual geometry information inverse transform/inverse quantization unit 52006 scales the quantized residual geometry information with a quantization value (or quantization parameter) or inversely transforms the same to reconstruct the residual geometry information.

The residual geometry information reconstructed by the residual geometry information inverse transform/inverse quantization unit 52006 is output to the adder 52007, and the adder 52007 adds the reconstructed residual geometry information and the inter-predicted or intra-predicted geometry information to reconstruct the geometry information. The reconstructed geometry information is output to the filter 52008 and the geometry information intra-predictor 52013.

The filter 52008 filters the reconstructed geometry information. The filter 52008 may include a deblocking filter, an offset corrector, and an adaptive loop filter (ALF) for filtering of the reconstructed geometry information.

Geometry information calculated through the filter 52008 or geometry information prior to the filtering may be stored in the buffer 52012 so as to be used as reference information.

In another embodiment, the geometry information inverse transform/inverse quantization unit 52009 and the coordinate inverse transformer 52010 may be further provided between the filter 52008 and the buffer 52012.

The geometry information inverse transform/inverse quantization unit 52009 may generate inversely quantized reconstructed geometry information by multiplying the reconstructed geometry information by the quantization value (or quantization parameter) provided by the geometry information transform/quantization unit 52002. The geometry information inverse transform/inverse quantization unit 52009 may be operated before the geometry information is stored in the buffer 52012 or after the geometry information is stored in the buffer 52012.

The coordinate inverse transformer 52010 may inversely transform the coordinates of the reconstructed geometry information back into the coordinates given before the coordinate transformation performed by the coordinate transformer 52001.

The reconstructed geometry information output unit 52011 stores, in the buffer 52012, the reconstructed geometry information whose coordinates are inversely transformed by the coordinate inverse transformer 52010, and outputs the same to the geometry information mapper 52003 of the attribute encoder 51007 for attribute encoding.

The geometry information intra-predictor 52013 predicts geometry information based on the geometry information that has been previously reconstructed in the same frame, and outputs the predicted geometry information to the subtractor 52004 and the adder 52007 via the switching unit 52015. The prediction information used for intra-prediction of the geometry information is entropy-encoded by the entropy encoder 52016.

The geometry information inter-predictor 52014 predicts the geometry information about the current frame based on the previously reconstructed geometry information about another frame stored in the buffer 52012, and outputs the predicted geometry information to the subtractor 52004 and the adder 52007 via the switching unit 52015. The prediction information used for inter-prediction of the geometry information is entropy-encoded by the entropy encoder 52016.

When prediction is to be performed, the geometry information stored in the buffer 52012 may be provided to the geometry information inter-predictor 52014 or the geometry information intra-predictor 52013.

The switching unit 52015 may provide the geometry information intra-predicted by the geometry information intra-predictor 52013 or the geometry information inter-predicted by the geometry information inter-predictor 52014 to the subtractor 52004 and the adder 52007 according to a signal indicating whether inter-prediction or intra-prediction is performed (provided by, for example, a controller (not shown)).

When the input attribute information indicates a color space, the attribute information transformer 53001 may transform the color space of the attribute information. The attribute information was color space is transformed or not transformed by the attribute information transformer 53001 is output to the geometry information mapper 53002.

The geometry information mapper 53002 maps the attribute information received from the attribute information transformer 53001 and the reconstructed geometry information received from the geometry information output unit 52011 of the geometry encoder 51006 to reconstruct attribute information. According to embodiments, in the attribute information reconstruction, an attribute value may be derived based on the attribute information about one or more points according to the reconstructed geometry information. The reconstructed attribute information is output to the attribute information node partitioner 53003.

The attribute information node partitioner 53003 may partition the attribute information reconstructed by the geometry information mapper 53002 into nodes and output the nodes to the subtractor 53004. That is, the attribute information node partitioner 53003 may partition a node, which is a region containing point cloud data, into sub-nodes such as slices or tiles. The slices or tiles may be divided into nodes according to a specific partitioning structure. The partitioned nodes may be encoded in a depth-first search order. Nodes at the same depth may be encoded in a specific order.

The subtractor 53004 outputs a difference between the attribute information partitioned into the nodes and the intra-predicted or inter-predicted attribute information (which is referred to as residual attribute information) to the residual attribute information transform/quantization unit 53005.

The residual attribute information transform/quantization unit 53005 may or may not transform a residual 3D block including the received residual attribute information using a transform type such as discrete cosine transform (DCT), discrete sine transform (DST), shape adaptive discrete cosine transform (SADCT), or RAHT. The residual attribute information transform/quantization unit 53005 may quantize the transformed or untransformed residual attribute information with a quantization value (or referred to as a quantization parameter). The transformed quantized residual attribute information is output to the attribute information entropy encoder 53014 and the residual attribute information inverse transform/inverse quantization unit 53006.

The transform type applied by the residual attribute information transform/quantization unit 53005 to transform the residual 3D block is entropy-encoded by the attribute information entropy encoder 53014 and then transmitted to the reception device via the transmission processor 51008.

The attribute information entropy encoder 53014 receives the transformed quantized residual attribute information and prediction information (or referred to as attribute prediction information) and performs entropy encoding. The prediction information may be predicted attribute information output from the attribute information intra-predictor 53011 or the attribute information inter-predictor 53012, or prediction mode information corresponding to the predicted attribute information. The attribute information entropy encoder 53014 may use various encoding methods such as, for example, exponential Golomb, context-adaptive variable length coding (CAVLC), and context-adaptive binary arithmetic coding (CABAC). As a result of the entropy encoding by the attribute information entropy encoder 53014, an attribute bitstream is generated. The attribute bitstream is transmitted to the reception device via the transmission processor 51008.

The residual attribute inverse transform/inverse quantization unit 53006 may inversely transform the received 3D residual block including the transformed quantized residual attribute information using a transform type such as DCT, DST, SADCT, or RAHT. In addition, the residual attribute inverse transform/inverse quantization unit 53006 may reconstruct residual attribute information by scaling the inversely transformed residual attribute information with a quantization value (or referred to as a quantization parameter). The residual attribute inverse transform/inverse quantization unit 53006 performs inverse transformation and/or inverse quantization depending on whether transformation and/or quantization is performed by the residual attribute information transform/quantization unit 53005. The residual attribute information reconstructed by the residual attribute inverse transform/inverse quantization unit 53006 is provided to the adder 53007. The adder 53007 reconstructs attribute information by adding the reconstructed residual attribute information and the inter-predicted or intra-predicted attribute information. The reconstructed attribute information is output to the attribute information inverse transformer 53008.

The attribute information inverse transformer 53008 reconstructs attribute information by performing a reverse process of the operations of the attribute information transformation unit 53001. The attribute information inverse transformer 53008 may receive the attribute information type and transformation information from the signaling processor 51005, and perform various color space inverse transforms such as RGB-YUV and RGB-YUV. In the case where the color space is not transformed by the attribute information transformer 53001, the attribute information inverse transformer 53008 skips the color space inverse transformation.

The reconstructed attribute information is output to the filter 53009 and the attribute information intra-predictor 53011.

The filter 53009 filters the reconstructed attribute information. The filter 53009 may include a deblocking filter, an offset corrector, and an adaptive loop filter (ALF) for filtering of the reconstructed attribute information.

Attribute information calculated through the filter 53009 or attribute information prior to the filtering may be stored in the buffer 52012 so as to be used as reference information. When prediction is to be performed, the attribute information stored in the buffer 53009 may be provided to the attribute information inter-predictor 53012 or the attribute information intra-predictor 53011.

The attribute information intra-predictor 53011 predicts attribute information based on the attribute information and/or geometry information of points that have been previously reconstructed in the same frame, and outputs the predicted attribute information into the subtractor 53004 and the adder 53007 via the switching unit 53013. The prediction information used for intra-prediction of the attribute information is entropy-encoded by the entropy encoder 53014.

The attribute information inter-predictor 53012 predicts the attribute information about the current frame based on the previously reconstructed attribute information and/or geometry information about points in another frame stored in the buffer 53010, and outputs the predicted attribute information to the subtractor 53004 and the adder 53007 via the switching unit 53013. The prediction information used for inter-prediction of the attribute information is entropy-encoded by the entropy encoder 53014.

The switching unit 53013 may provide the attribute information intra-predicted by the attribute information intra-predictor 53011 or the attribute information inter-predicted by the attribute information inter-predictor 53012 to the subtractor 53004 and the adder 53007 according to a signal indicating whether inter-prediction or intra-prediction is performed (provided by, for example, a controller (not shown)).

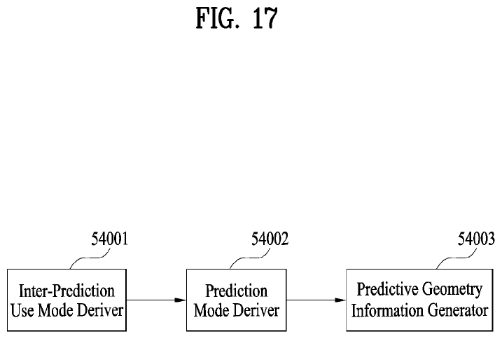

FIG. 17 is an exemplary detailed block diagram of a geometry information predictor according to embodiments.

Elements of the geometry information predictor shown in FIG. 17 may be implemented as hardware, software, processors, and/or combinations thereof.

In FIG. 17, the geometry information predictor may include an inter-prediction use mode deriver 54001, a prediction mode deriver 54002, and a predictive geometry information generator 54003.

According to embodiments, the geometry information predictor may generate predictive (or predicted) geometry information about multiple points within a current node. According to embodiments, the generation of the predictive geometry information about the multiple points within the current node may be performed through a process as shown in FIG. 17. Each operation in FIG. 17 may be omitted or the operations may be performed in a different order.

The inter-prediction use mode deriver 54001 may parse (or determine) whether to reference geometry information of another frame in predicting the geometry information about a current node. When the geometry information of the other frame is referenced, the geometry information inter-predictor 52014 may be executed. When the geometry information of the other frame is not referenced, the geometry information intra-predictor 52013 may be executed. According to embodiments, whether to reference the geometry information of the other frame may be parsed at the level of nodes, tiles, slices, or frames. Operations after the inter-prediction use mode deriver 54001 may be performed by the geometry information inter-predictor 52014 or the geometry information intra-predictor 52013.

The prediction mode deriver 54002 may parse or derive a prediction mode of the intra-prediction or inter-prediction. According to embodiments, the prediction mode may be parsed in a unit such as a node, a tile, a slice, or a frame. According to embodiments, the intra-prediction mode may include a node prediction mode, a scalable prediction mode, and a surface approximation mode, and the inter-prediction mode may include a node prediction mode.

The predictive geometry information generator 54003 may generate predictive geometry information about all or some points of the current node using a separate method according to the prediction mode. In this case, when the prediction mode is the node prediction mode, a reference region of the current node may be derived and the transformed geometry information about the points in the reference region may be designated as predictive geometry information.

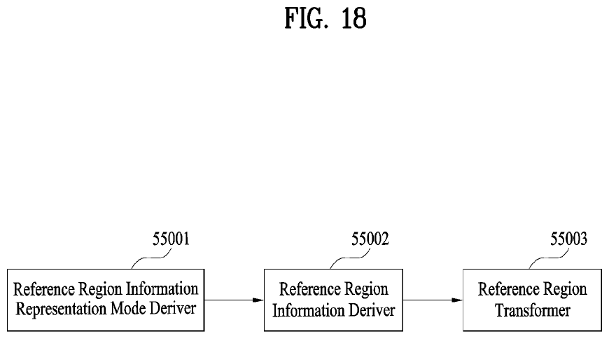

According to embodiments, when the node prediction mode is inter-prediction or intra-prediction, predictive geometry information may be generated as illustrated in FIG. 18. Any of the operations in FIG. 18 may be skipped or the order of the operations may be changed.

FIG. 18 is an exemplary detailed block diagram of a predictive geometry information generator according to embodiments.

Elements of the predictive geometry information generator shown in FIG. 18 may be implemented as hardware, software, processors, and/or combinations thereof.

That is, when the prediction mode is parsed (or determined or derived) as a node prediction mode by the prediction mode deriver 54002, the predictive geometry information generator 54003 may include a reference region information representation mode deriver 55001, a reference region information deriver 55002, and a reference region transformer 55003.

The reference region information representation mode deriver 55001 may parse or derive an index of a reference region information representation method for a current node among multiple reference representation methods for representing reference region information. According to embodiments, the reference region information representation methods may include vector representation, transformation matrix representation, transformation parameter representation, and rotational shift representation. The reference region information representation method may be parsed or derived in a unit such as a slice, a tile, a node, or the like. The reference region information representation method (or referred to as a reference region information representation mode or reference region information representation method index) parsed or derived by the reference region information representation mode deriver 55001 is output to the reference region information deriver 55002.

The reference region information deriver 55002 may derive reference region information about the current node according to the reference region information representation method parsed or derived by the reference region information representation mode deriver 55001. In addition, a reference region may be derived based on the derived reference region information. According to embodiments, the reference region information representation methods may include vector representation, transformation matrix representation, transformation parameter representation, and rotation representation. According to embodiments, in the method of the vector representation, a vector from each vertex of the current node to each corresponding vertex in the reference region may be parsed or derived. According to embodiments, in the method of the transformation parameter representation, one or more 3D transformation parameters for transforming the current node into the reference region may be parsed or derived.

According to embodiments, in the inter-prediction, an index of a frame to be referenced to derive a reference region may be parsed in a unit such as a picture or a slice. According to embodiments, a reference frame index and reference region information may be present as a pair, and the reference region may be derived based on the reference region information in a frame having a corresponding index. According to embodiments, syntax indicating the number of reference regions to be referenced to generate predictive geometry information may be parsed, and as many reference regions as the number may be derived. The predictive geometry information may be generated based on the derived reference regions.

The reference region transformer 55003 may transform the reference region to the same position as the current node in a unit of node or subnode based on the reference region information derived by the reference region information deriver 55002.

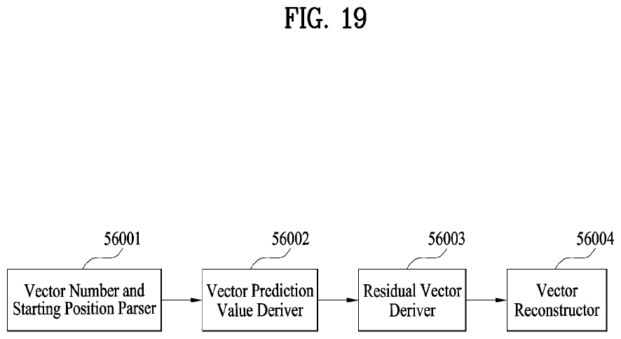

FIG. 19 is an exemplary detailed block diagram of a reference region information deriver according to embodiments.

According to embodiments, when the reference region information deriver 55002 of FIG. 18 derives the reference region information using the method of vector representation, the reference region information may be derived as shown in FIG. 19. Any of the operations of FIG. 19 may be skipped or the order of the operations may be changed.

Elements of the reference region information deriver shown in FIG. 19 may be implemented as hardware, software, processors, and/or combinations thereof.

The reference region information deriver 55002 may include a vector number and starting position parser 56001, a vector prediction value deriver 56002, a residual vector deriver 56003, and a vector reconstructor 56004.

That is, the reference region information deriver 55002 of FIG. 18 may derive the reference region information about the current node according to the reference region information representation method.

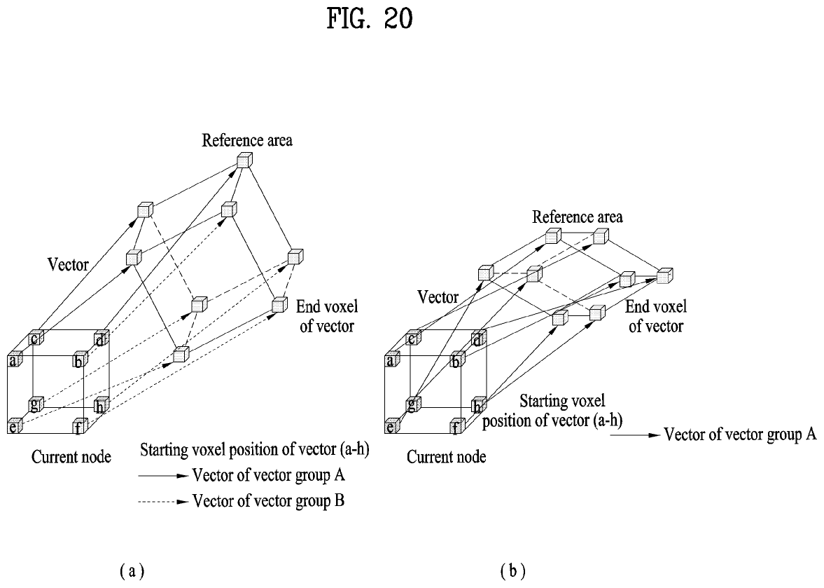

For example, when the reference region information representation method is vector representation, a vector from a specific voxel of the current node to a specific voxel of the reference region may be parsed or derived as shown in FIG. 20-(a) or 20-(b). According to embodiments, the process of deriving reference region information according to the vector representation illustrated in FIG. 19 may be applied to inter-prediction and/or intra-prediction.

FIG. 20-(a) is a diagram illustrating an example of starting voxel positions of M vectors and a reference region in the method of vector representation according to embodiments. FIG. 20-(a) illustrates an example of parsing or deriving a vector from a specific voxel of the current node to a specific voxel of the reference region when the reference region is a cube.

FIG. 20-(b) is a diagram illustrating another example of starting voxel positions of M vectors and a reference region in the method of vector representation according to embodiments. FIG. 20-(b) illustrates an example of parsing or deriving a vector from a specific voxel of the current node to a specific voxel of the reference region when the reference region is a deformed shape other than a cube.

According to embodiments, some of the vectors of the current node may be parsed, and the others may be derived based on the parsed vectors.

According to embodiments, the vector number and starting position parser 56001 may parse M, which is the number of received vectors of the current node (wherein the vectors are referred to as vectors in vector group A), and M starting voxel positions. The entire vectors of the current node may be configured in multiple vector groups. As shown in FIG. 20-(a), there may be vector group A, vector group B, and the like. According to the embodiments, except for the parsed starting voxel position(s) of vector group A, the remaining starting voxel position(s) are set as the starting position(s) of the vectors of vector group B. In this case, each vector in vector group A may be reconstructed through prediction value derivation and residual parsing, or may be reconstructed by parsing the vector values. Vector group B may be derived from the vectors of vector group A.

According to embodiments, the vector prediction value deriver 56002 and the residual vector parser 56003 of FIG. 19 may be executed for vector group A, and the vector reconstructor 56004 of FIG. 19 may be executed for all vectors.

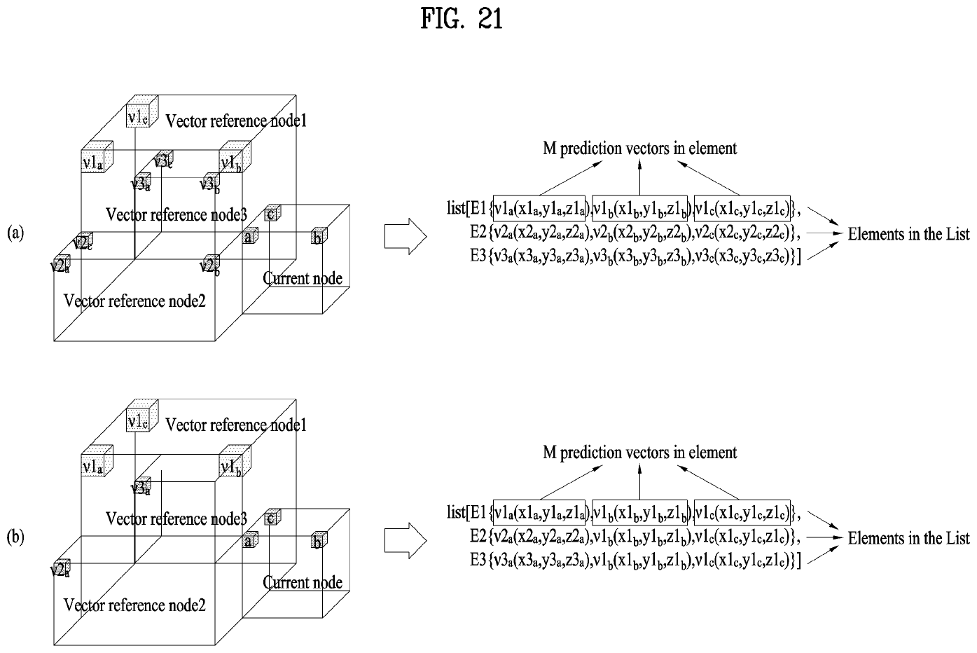

The vector prediction value deriver 56002 may generate M prediction vectors for the vectors of vector group A. In addition, a reference vector list having the M prediction vectors as one element may be configured as shown in FIG. 21-(a) or FIG. 21-(b) to parse anindex (syntax: pred_vector_idx) of an element to be referenced.

FIG. 21-(a) shows an example of a vector reference node and a reference vector list according to embodiments.

FIG. 21-(b) shows another example of a vector reference node and a reference vector list according to embodiments.

For example, as shown in FIG. 21-(a), M vectors of nodes having vectors may be added as one element of the reference vector list to the starting positions of M vectors to be predicted among the neighbor nodes for which coding is completed.

As another example, as shown in FIG. 21-(b), M prediction vectors of one element in the list may be configured as vectors of different nodes.

According to embodiments, a vector may be scaled based on a value obtained by calculating sizes, shapes and ratio of a current node and a node referencing the vector, and added to the reference vector list.

The residual vector parser 56003 may parse a received residual value (syntax: resi_vector_value) or parse the index (syntax: resi_vector_idx) of the residual vector list. The residual value (syntax: resi_vector_value) and/or the index (syntax: resi_vector_idx) of the residual vector list may be provided by the signaling processor 51005. The residual vector list may include a predefined residual vector (dₓ, d_{y}, d_{z}) as an element. In addition, a residual vector corresponding to the parsed residual or a residual vector selected from the residual vector list based on the index of the parsed residual vector list may be designated as the residual vector of the current node.

The vector reconstructor 56004 may reconstruct the M vectors of vector group A by adding the prediction vector generated by the vector prediction value deriver 56002 and the residual vector generated by the residual vector parser 56003. In addition, vectors of vector group B may be generated based the M reconstructed vectors of vector group A. According to embodiments, the vector reconstructor 56004 may derive geometry information about each vertex voxel of the reference region by adding the vectors of vector group A and vector group B to the starting voxel position of each vector.

As described above, once reference region information is derived by the reference region information deriver 55002 of FIG. 18, the reference region transformer 55003 transforms the reference region into the position of the current node based the derived reference region information. In this case, the unit of the transformation may be a reference region or a sub-reference region. The predictive geometry information generator 54003 may generate predictive geometry information based on the reference region transformed into the position of the current node.

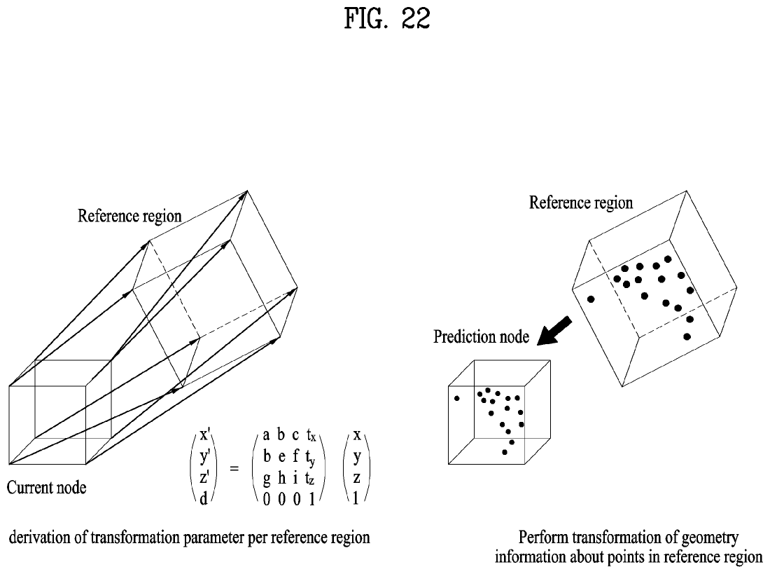

According to embodiments, when the reference region information representation method is vector representation and transformation is performed per reference region, a transformation parameter for transforming the reference region into the position of the current node may be calculated based on the reference region derived based on the reference region information and the eight vertices of the current node, as shown in FIG. 22. In this case, the buffer 52012 determines the point(s) included in the reference region, and performs transformation on one or more corresponding points using a transformation parameter to generate predictive residual information.

FIG. 22 illustrates an example of derivation of a transformation parameter per reference region and transformation of geometry information about points in a reference region according to embodiments.

According to embodiments, when the reference region information representation method is vector representation and transformation is performed per sub-reference region, n*m*l cuboid sub-reference regions having the size of wₛ*hₛ*dₛ that fully or partially overlap the reference region may be derived. Here, each sub-reference region may be derived so as not to overlap or so as to partially overlap other sub-reference regions. The variables n, m, and l may be the number of sub-reference regions (syntax: sub_prednode_num) along the corresponding directions. The variables may be parsed or fixed values may be used. In this case, sub-nodes may be generated by partitioning the current node into n, m, and l pieces along the corresponding spatial axes. According to embodiments, one vertex of the reference region may be designated as a reference vertex, and positions calculated by dividing the space between the reference vertex and a neighboring vertex by the partition number (n, m, or l) in the corresponding direction may be designated as the positions of subnodes. By performing the above-described process, the width, height, and length of the subnode may be calculated. In addition, the sizes and positions of all sub-reference regions may be derived by deriving subnode positions through the above-described calculation operation for the three vertices neighboring the reference vertex.

According to embodiments, a position difference vector v (x, y, z) between the calculated sub-reference region and a corresponding subnode may be calculated. Then, a scale difference s between the area of the sub-reference region and the area of the subnode may be calculated. In addition, predictive geometry information related to each sub-node may be generated by adding or subtracting a vector to or from the geometry information about a point within each sub-reference region and multiplying or dividing the result of the addition or subtraction by the scale difference.

The generated predictive geometry information may be inter-predicted geometry information or intra-predicted geometry information.

According to embodiments, the inter-prediction use mode deriver 54001 of FIG. 17 may not be included in the geometry information intra-predictor 52013 or the geometry information inter-predictor 52014, but may be configured as a separate device or component.

According to embodiments, the inter-prediction use mode deriver 54001 may be included in at least the geometry information intra-predictor 52013 or the geometry information inter-predictor 52014.

According to embodiments, the prediction mode deriver 54002 and the predictive geometry information generator 54003 of FIG. 17 may be included in both the geometry information intra-predictor 52013 and the geometry information inter-predictor 52014, or one of the predictors.

According to embodiments, when the operations of the prediction mode deriver 54002 and the predictive geometry information generator 54003 of FIG. 17 are performed by the geometry information intra-predictor 52013, the generated predictive geometry information corresponds to intra-predicted geometry information. According to embodiments, when the operations of the prediction mode deriver 54002 and the predictive geometry information generator 54003 of FIG. 17 are performed by the geometry information inter-predictor 52014, the generated predictive geometry information corresponds to inter-predicted geometry information.

According to embodiments, the result of parsing by the inter-prediction use mode deriver 54001 of FIG. 17 may control switching of the switching unit 52015. For example, when referencing geometry information about another frame is parsed (or determined), the switching unit 52015 may select the output from the geometry information inter-predictor 52014. When skipping referencing of the geometry information about the other frame is parsed (or determined), the switching unit 52015 may select the output from the geometry information intra-predictor 52013.

According to embodiments, the inter-prediction use mode deriver 54001, the prediction mode deriver 54002, and the predictive geometry information generator 54003 may be collectively referred to as a geometry information predictor.

According to embodiments, the inter-prediction use mode deriver 54001, the geometry information intra-predictor 52013, and the geometry information inter-predictor 52014 may be collectively referred to as a geometry information predictor. In this case, the prediction mode deriver 54002 and the predictive geometry information generator 54003 may be included in both the geometry information intra-predictor 52013 and the geometry information inter-predictor 52014, or one of the predictors.

According to embodiments, the geometry information intra-predictor 52013 and the geometry information inter-predictor 52014 may be collectively referred to as a geometry information predictor. In this case, the inter-prediction use mode deriver 54001, the prediction mode deriver 54002, and the predictive geometry information generator 54003 may be included in both the geometry information intra-predictor 52013 and the geometry information inter-predictor 52014, or one of the predictors.

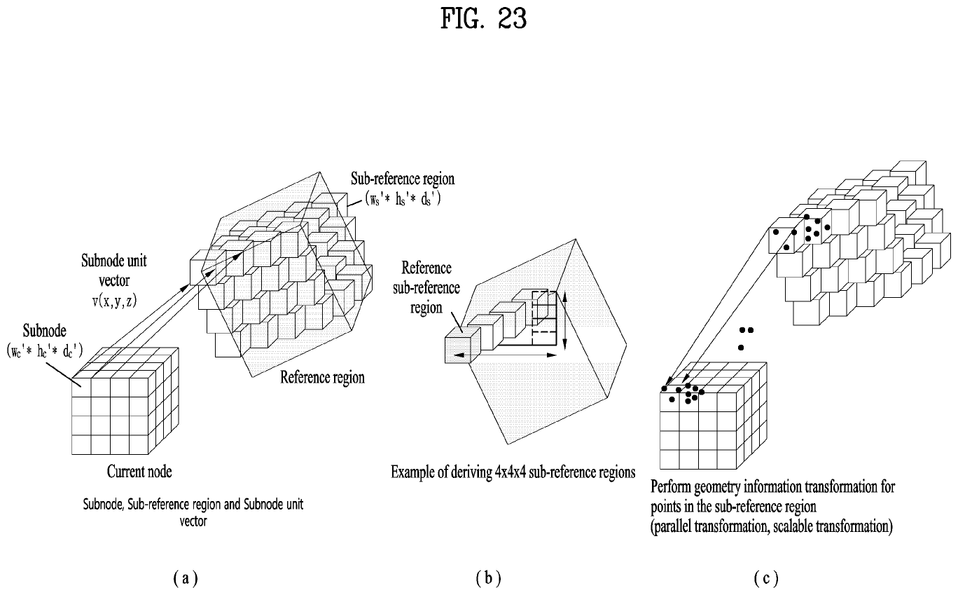

The method of generating predicted geometry information described with reference to FIGS. 15 to 23 may also be applied to attribute information. That is, the attribute information intra-predictor 53011 and the attribute information inter-predictor 53012 may generate inter-predicted attribute information or intra-predicted attribute information by applying the aforementioned process of generating predictive geometry information.

A method/device according to embodiments may signal related information to add/perform operations of embodiments. The signaling information may be used by the transmission device and/or the reception device.

Signaling information used for inter-prediction and/or intra-prediction of the geometry information may be referred to as geometry related prediction information. Detailed information included in the geometry-related prediction information will be described later.

Signaling information used for inter-prediction and/or intra-prediction of the attribute information may be referred to as attribute related prediction information.

In the present disclosure, the geometry-related prediction information and the attribute-related prediction information may be collectively referred to as information related to point cloud data prediction. In other words, the information related to point cloud data prediction may include geometry-related prediction information and attribute-related prediction information.

In an embodiment of the present disclosure, the geometry-related prediction information and attribute-related prediction information masy be signaled in at least one of a sequence parameter set, a geometry parameter set, an attribute parameter set, a tile parameter set, a geometry slice header, geometry slice data, an attribute slice header, or attribute slice data by the signaling processor 51005 and/or the tranmssion processor 51008. The geometry-related prediction information and attribute-related prediction information signaled in at least one of the sequence parameter set, geometry parameter set, attribute parameter set, tile parameter set, geometry slice header, geometry slice data, attribute slice header, or attribute slice data may be entropy-encoded by the geometry information entropy encoder 52016 of the geometry encoder 51006 and the attribute information entropy encoder 53014 of the attribute encoder 51007, respectively.

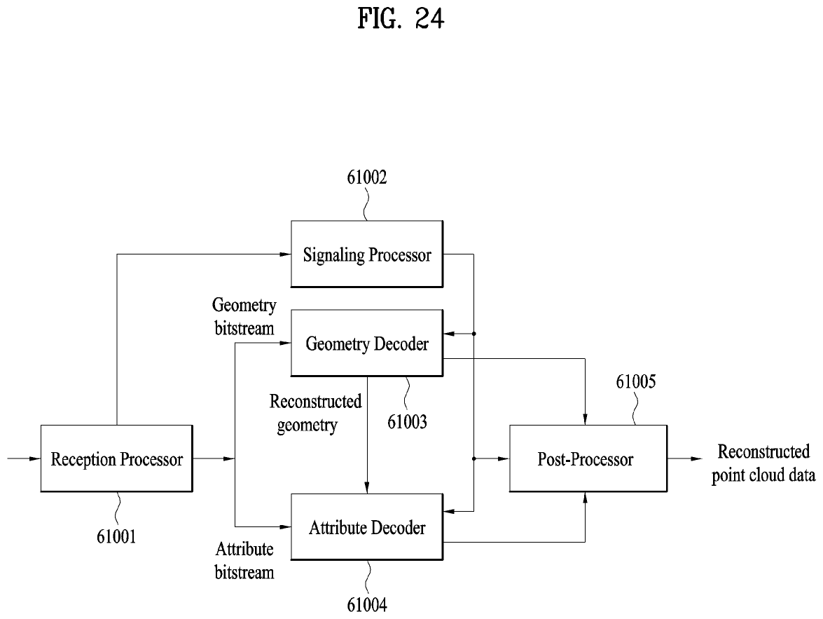

FIG. 24 illustrates another example of a point cloud reception device according to embodiments. Elements of the point cloud reception device shown in FIG. 24 may be implemented as hardware, software, processors, and/or combinations thereof.

According to embodiments, the point cloud reception device may include a reception procesor 61001, a signaling processor 61002, a geometry decoder 61003, an attribute decoder 61004, and a post-processor 61005. According to embodiments, the geometry decoder 61003 and the attribute decoder 61004 may be referred to as a point cloud video decoder. According to embodiments, the point cloud video decoder may be referred to as a PCC decoder, a PCC decoding unit, a point cloud decoder, a point cloud decoding unit, or the like.

According to embodiments, the point cloud video decoder may perform the reverse processes of the operations of the geometry encoder and attribute encoder of the transmission device based on signaling information for a compressed geometry bitstream and attribute bitstream to reconstruct geometry information and attribute information. The point cloud video decoder may perform some or all of the operations described in relation to the point cloud video decoder of FIG. 1, the decoding of FIG. 2, the point cloud video decoder of FIG. 11, and the point cloud video decoder of FIG. 13.

The reception procesor 61001 may receive one bitstream or receive a geometry bitstream, an attribute bitstream, and a signaling bitstream, respectively. When a file and/or segment is received, the reception procesor 61001 may decapsulate the received file and/or segment and output a bitstream for the same.

When one bitstream is received (or decapsulated), the reception procesor 61001 may demultiplex a geometry bitstream, an attribute bitstream, and a signaling bitstream from the bitstream, and output the demultiplexed signaling bitstream to the signaling processor 61003, the demultiplexed geometry bitstream to the geometry decoder 61003, and the demultiplexed attribute bitstream to the attribute decoder 61004.

When a geometry bitstream, an attribute bitstream, and a signaling bitstream are received (or decapsulated), respectively, the reception procesor 61001 may deliver the signaling bitstream to the signaling processor 61003, and the geometry bitstream and the attribute bitstream to the point cloud video decoder 61005.

The signaling processor 61002 may parse and process information included in the signaling information, for example, information included in the SPS, GPS, APS, TPS, or metadata, from the input signaling bitstream and provide the same to the geometry decoder 61003, the attribute decoder 61004, and the post-processor 61005. In another embodiment, the signaling information included in the geometry slice header and/or the attribute slice header may also be parsed by the signaling processor 61002 before decoding of the corresponding slice data.

According to embodiments, the signaling processor 61002 may parse and process geometry-related prediction information and attribute-related prediction information signaled in at least one of the SPS, GPS, APS, TPS, geometry slice header, geometry slice data, attribute slice header, or attribute slice data, and provide the processed information to the geometry decoder 61003, the attribute decoder 61004, and the post-processor 61005.

The geometry-related prediction information, which is used for inter-prediction and/or intra-prediction of geometry information, and the attribute-related prediction information, which is used for inter-prediction and/or intra-prediction of the attribute information, may be collectively referred to as information related to point cloud data prediction.

When the point cloud data is partitioned into tiles and/or slices at the transmitting side according to the embodiments, the TPS may include the number of slices included in each tile. Accordingly, the point cloud video decoder according to the embodiments may check the number of slices, and quickly parse information for parallel decoding.

Accordingly, the point cloud video decoder according to the present disclosure may receive an SPS having a reduced amount of data, and may thus quickly parse a bitstream containing point cloud data. Upon receiving tiles, the reception device may perform decoding slice by slice based on the GPS and APS included in each tile. Thereby, decoding efficiency may be maximized.

That is, the geometry decoder 61003 may reconstruct the compressed geometry information by performing a reverse processe of the operations of the geometry encoder 51006 of FIG. 15 for the geometry bitstream based on the signaling information (e.g., geometry-related parameters including geometry-related prediction information, or information related to point cloud data prediction). According to embodiments, the geometry decoder 61003 may reconstruct the geometry information by performing some or all of the operations in FIGS. 15 to 23 based on the signaling information during inter-prediction or intra-prediction. The geometry decoder 61003 may perform geometry decoding per sub-point cloud or encoding/decoding unit (CU), and may reconstruct geometry information by performing intra-frame prediction (i.e., intra-prediction) or inter-frame prediction (i.e., inter-prediction) for each encoding/decoding unit (CU) based on information (e.g., a flag) indicating whether the prediction is intra-prediction or inter-prediction.

The geometry information restored (or reconstructed) by the geometry decoder 61003 is provided to the attribute decoder 61004.

The attribute decoder 61004 may reconstruct the attribute information by performing the reverse process of the operations of the attribute encoder 51007 of FIG. 15 for the compressed attribute bitstream based on the signaling information (e.g., attribute-related parameters including attribute-related prediction information, or information related to point cloud data prediction) and the reconstructed geometry information. According to embodiments, the attribute decoder 61004 may reconstruct the attribute information by performing all or some of the operations in FIGS. 15 to 23 based on the signaling information during inter-prediction or intra-prediction. The attribute decoder 61004 may perform attribute decoding on the entire point cloud or per sub-point cloud or encoding/decoding unit (CU), and reconstruct the attribute information by performing intra-frame prediction (i.e., intra-prediction) or inter-frame prediction (i.e., inter-prediction) for each encoding/decoding unit (CU) based on information (e.g., a flag) indicating whether the prediction is intra-prediction or inter-prediction. According to embodiments, the attribute information decoder 61004 may be omitted.

According to embodiments, in the case where the point cloud data is partitioned into tiles and/or slices at the transmitting side, the geometry decoder 61003 and the attribute decoder 61004 may perform geometry decoding and attribute decoding on a tile-by-tile basis and/or a slice-by-slice basis.

The post-processor 61005 may match the geometry information (i.e., positions) reconstructed and output by the geometry decoder 61003 to the reconstructed attribute information (i.e., one or more reconstructed attributes) reconstructed and output by the attribute decoder 61004 to reconstruct and display/render the point cloud data.

According to embodiments, the reception device of FIG. 24 may further include a spatial reconstructor, which may be disposed before the geometry decoder 61003. For example, when the received point cloud data is configured in units of tiles and/or slices, a reverse process of spatial partitioning performed at the transmitting side may be performed based on signaling information. For example, when a bounding box is partitioned into tiles and slices, the bounding box may be reconstructed by combining the tiles and/or slices based on the signaling information. In another embodiment, the spatial reconstructor may spatially partition received point cloud data. For example, the received point cloud data may be pardoned accorinding to parsed partition information such as a sub-point cloud, and/or an encoding/decoding unit (CU), a prediction unit (PU), or a transformation unit (TU) determined by the point cloud video encoder of the transmission device. The CU, the PU, and the TU may have the same partition structure or different partition structures according to embodiments.

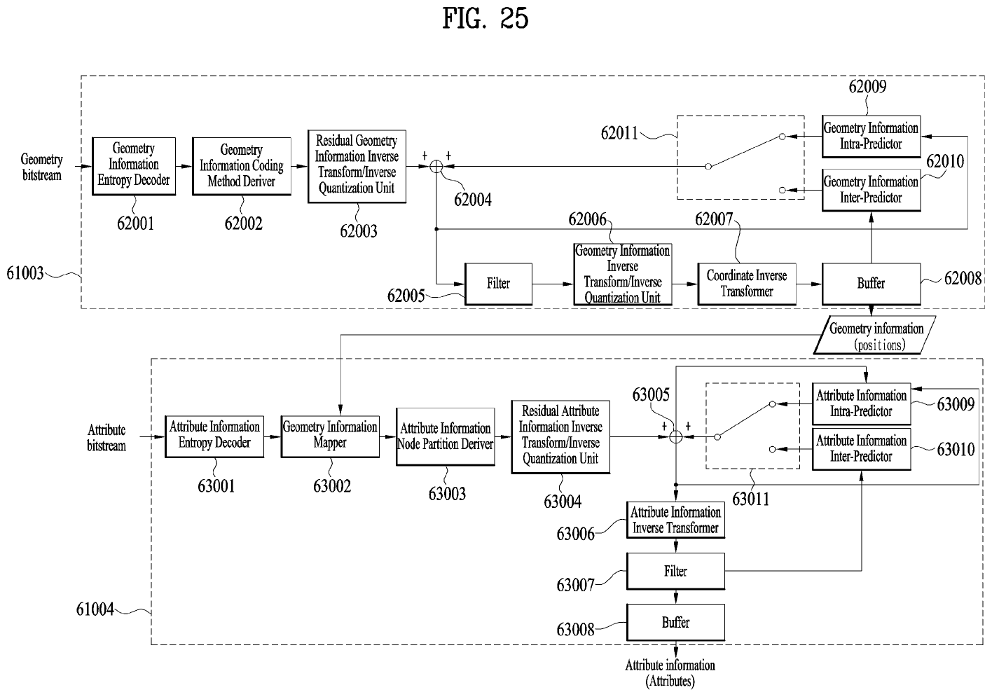

FIG. 25 is a detailed block diagram illustrating another example of the geometry decoder 61003 and the attribute decoder 61004.

According to embodiments, in the geometry decoding and attribute decoding processes in FIG. 25, some or all of the operations of the point cloud video decoder of FIG. 1, 2, 11, or 13 may be performed.

The geometry decoder and attribute decoder of FIG. 25 may include one or more processors and one or more memories electrically or communicatively coupled with the one or more processors for encoding of the point cloud data. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for processing the point cloud data.

Elements of the point geometry decoder and the attribute decoder shown in FIG. 25 may be implemented as hardware, software, processors, and/or combinations thereof.

In FIG. 25, the geometry decoder 61003 may include a geometry information entropy decoder 62001, a geometry information coding method deriver 62002, a residual geometry information inverse transform/inverse quantization unit 62003, an adder 62004, a filter 62005, a geometry information inverse transform/inverse quantization unit 62006, a coordinate inverse transformer 62007, a buffer 62008, a geometry information intra-predictor 62009, a geometry information inter-predictor 62010, and a switching unit 62011. The buffer 62008 may be referred to as a memory or a reconstructed point cloud buffer.

In FIG. 25, the attribute decoder 61004 may include an attribute information entropy decoder 63001, a geometry information mapper 63002, an attribute information node partition information deriver 63003, a residual attribute information inverse transform/inverse quantization unit 63004, an adder 63005, an attribute information inverse transformer 63006, a filter 63007, a buffer 63008, an attribute information intra-predictor 63009, an attribute information inter-predictor 63010, and a switching unit 63011. The buffer 63008 may be referred to as a memory or a reconstructed point cloud buffer.

The buffer 62008 of the geometry decoder 61003 and the buffer 63008 of the attribute decoder 61004 may be the same buffer or separate buffers. That is, the reconstructed geometry information and reconstructed attribute information may be managed in one buffer or independent buffers. When the information is managed in independent buffers, mapping between the geometry information and the attribute information may be performed by storing the reconstructed geometry information and the reconstructed attribute information in the same order.

The geometry information entropy decoder 62001 may perform entropy decoding on the input geometry bitstream and output transformed and/or quantized residual geometry information. For example, for entropy decoding, various methods such as exponential Golomb, context-adaptive variable length coding (CAVLC), and context-adaptive binary arithmetic coding (CABAC) may be applied. According to embodiments, the geometry information entropy decoder 62001 may also entropy-decode geometry-related prediction information (or information related to geometry information prediction) from the transmission device. Then, the transformed and/or quantized residual geometry information is output to the residual geometry information inverse transform/inverse quantization unit 62003.

The geometry information coding method deriver 62002 may derive a coding method such as a coding mode and partition mode of the geometry information, and derive whether and how to execute the residual geometry information inverse quantization unit 62003 and the geometry information intra-predictor 62009, the geometry information inter-predictor 62010 according to the coding method.

The residual geometry information inverse transform/inverse quantization unit 62003 scales the quantized residual geometry information with a quantization value (or quantization parameter) or inversely transforms the same to reconstruct the residual geometry information. The residual geometry information reconstructed by the residual geometry information inverse transform/inverse quantization unit 62003 is output to the adder 62004. The adder 62004 adds the reconstructed residual geometry information and the predicted geometry information to reconstruct the geometry information. The reconstructed geometry information is output to the geometry information intra-predictor 62010 and/or stored in the buffer 62008. The predicted geometry information is geometry information intra-predicted by the geometry information intra-predictor 62009 or geometry information inter-predicted by the geometry information inter-predictor 62010.

According to embodiments, the filter 62005, the geometry information inverse transform/inverse quantization unit 62006, and the coordinate inverse transformer 62007 may be further provided between the adder 62004 and the buffer 62008. According to embodiments, the geometry information output from the filter 62005, the geometry information inverse transform/inverse quantization unit 62006, or the coordinate inverse transformer 62007 may be stored in the buffer 62008.

The filter 62005 may filter the reconstructed geometry based on filtering-related information or characteristics of reconstructed geometry information in the geometry-related prediction information (or information related to point cloud data prediction) provided from the geometry information entropy decoder 62001. The filter 62005 may include a deblocking filter, an offset corrector, and an ALF. According to embodiments, the filter 62005 may be omitted.

The geometry information inverse transform/inverse quantization unit 62006 may perform the reverse process of the transformation performed by the geometry information transform/quantization unit 52002 of the transmission device on the filtered or unfiltered reconstructed geometry information, and generate an inversely quantized reconstructed geometry information by multiplying the result of the reverse process by a quantization value (or quantization parameter). The geometry information inverse transform/inverse quantization unit 62006 may be executed before or after the information is stored in the buffer 62008.

The coordinate inverse transformer 62007 may perform coordinate inverse transformation based on coordinate transformation-related information in the geometry-related prediction information (or information related to point cloud data prediction) provided from the geometry information entropy decoder 62001 and the reconstructed geometry information stored in the buffer 62008.

According to embodiments, the geometry information intra-predictor 62009 and the geometry information inter-predictor 62010 may be collectively referred to as a geometry information predictor.

The geometry information inter-predictor 62010 and the geometry information intra-predictor 62009 included in the geometry information predictor may generate predictive geometry information based on information related to predictive geometry information generation in the geometry-related prediction information (or information related to point cloud data prediction) provided from the geometry information entropy decoder 62001 and previously decoded geometry information provided from the buffer 62008.

For example, the geometry information inter-predictor 62010 may use information necessary for inter-prediction of the current prediction unit in the geometry-related prediction information (or information related to the point cloud data prediction) provided from the geometry information entropy decoder 62001 to perform inter-prediction on the current prediction unit based on information included in at least one one of a previous space (e.g., previous frame) or subsequent space (e.g., subsequent frame) with respect to the current space including the current prediction unit.

As another example, the geometry information intra predictor 62009 may generate predictive geometry information based on reconstructed geometry information about a point in the current space (e.g., frame). According to embodiments, when a prediction unit is subjected to intra-prediction, intra-prediction may be performed on the current prediction unit based on information (e.g., mode information) information necessary for intra-prediction of the prediction unit in the geometry-related prediction information (or information related to the point cloud data prediction) provided from the geometry information entropy decoder 62001.

The geometry information intra-predicted by the geometry information intra-predictor 62009 or the geometry information inter-predicted by the geometry information inter-predictor 62010 is output to the adder 62004 via the switching unit 62011.

The adder 62004 generates reconstructed geometry information by adding the intra-predicted or inter-predicted geometry information and the reconstructed residual geometry information output from the residual geometry information inverse transform/inverse quantization unit 62003.

According to embodiments, the geometry decoder 61003 of FIG. 25 may reconstruct geometry information by performing all or some of the operations of FIGS. 15 to 23 based on the signaling information (e.g., the information related to prediction of the point cloud data) during inter-prediction or intra-prediction.

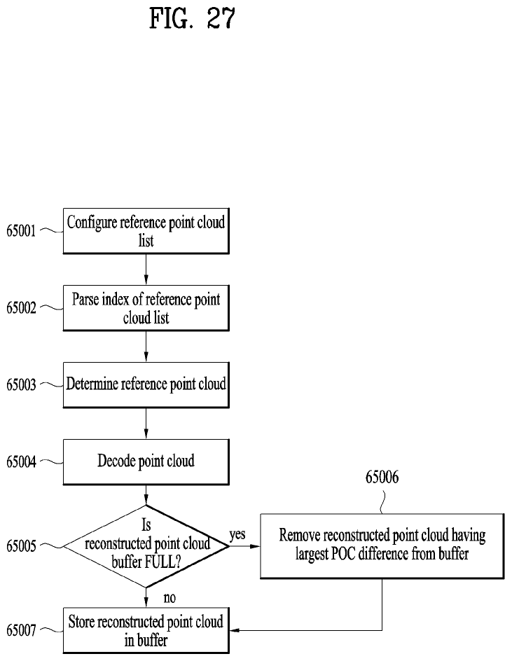

According to embodiments, the geometry decoder 61003 of FIG. 25 may perform all or some of the operations of FIGS. 27 to 32, which will be described later, based on the signaling information (e.g., buffer management information) to manage the buffer 62008.

The attribute information entropy decoder 63001 may perform entropy decoding on an input attribute bitstream and output transformed and/or quantized residual attribute information. For example, for the entropy decoding, various methods such as exponential Golomb, context-adaptive variable length coding (CAVLC), and context-adaptive binary arithmetic coding (CABAC) may be applied. According to embodiments, the attribute information entropy decoder 63001 may entropy-decode attribute-related prediction information (or information related to attribute information prediction) provided from the transmission device. Then, the transformed and/or quantized residual attribute information is output to the geometry information mapper 63002.

The geometry information mapper 63002 maps the transformed and/or quantized residual attribute information output from the attribute information entropy decoder 63001 and the reconstructed geometry information output from the geometry decoder 61003. The residual attribute information mapped to the geometry information may be output to the residual attribute information inverse transform/inverse quantization unit 63004.

The attribute information node partition deriver may parse or derive partition information for positioning attribute information into units in which prediction, transformation, quantization, or the like is to be performed. The partition information may indicate a partition type such as an octree, a quad tree, or a binary tree.

The residual attribute information inverse transform/inverse quantization unit 63004 scales the input transformed and/or quantized residual attribute information with a quantization value (or a quantization parameter) or inversely transforms the same to reconstruct the residual attribute information. The residual attribute information reconstructed by the residual attribute information inverse transform/inverse quantization unit 63004 is output to the adder 63005. For example, the residual attribute information inverse transform/inverse quantization unit 63004 may inversely transform a residual 3D block including the input residual attribute information using a transform type such as DCT, DST, SADCT, or RAHT.

The adder 63005 reconstructs attribute information by adding the reconstructed residual attribute information and the predicted attribute information. The reconstructed attribute information is output to the attribute information intra-predictor 63009 and/or stored in the buffer 63008. The predicted attribute information is attribute information intra-predicted by the attribute information intra-predictor 63009 or attribute information inter-predicted by the attribute information inter-predictor 63010.

According to embodiments, the attribute information inverse transformer 63006 and the filter 63007 may be further provided between the adder 63005 and the buffer 63008. According to embodiments, attribute information output from the attribute information inverse transformer 63006 or the filter 63007 may be stored in the buffer 63008.

The attribute information inverse transformer 63006 may receive the type of attribute information and transformation information in the attribute-related prediction information (or information related to point cloud data prediction) provided by the attribute information entropy decoder 63001, and perform various color space inverse transformations such as RGB-YUV and RGB-YUV.

The filter 63007 may filter reconstructed attribute information. The filter 63007 may include a deblocking filter, an offset corrector, and an ALF.

According to embodiments, the attribute information intra-predictor 63009 and the attribute information inter-predictor 63010 may be collectively referred to as an attribute information predictor.

The attribute information inter-predictor 63010 and the attribute information intra-predictor 63009 included in the attribute information predictor may generate predictive attribute information based on information related to generation of predictive attribute information in the attribute-related prediction information (or information related to point cloud data prediction) provided from the attribute information entropy decoder 63001, and previously decoded attribute information about points provided from the buffer 63008. That is, the attribute information inter-predictor 63010 and the attribute information intra-predictor 63009 may use attribute information or geometry information about points in the same frame or different frames stored in the buffer 63008 for attribute information prediction.

For example, the attribute information inter-predictor 63010 may use information necessary for inter-prediction of the current prediction unit in the attribute-related prediction information (or information related to point cloud data prediction) provided from the attribute information entropy decoder 63001 to perform inter-prediction on the current prediction unit based on information included in at least one of frames before or after the current frame including the current prediction unit.

As another example, the attribute information intra-predictor 63009 may generate predictive attribute information based on reconstructed attribute information about a point in the current frame. According to embodiments, when a prediction unit is subjected to intra-prediction, intra-prediction may be performed on the current prediction unit based on information (e.g., mode information) necessary for intra-prediction of the prediction unit in the attribute-related prediction information (or information related to the point cloud data prediction) provided from the attribute information entropy decoder 63001.

The attribute information intra-predicted by the attribute information intra-predictor 63009 or the attribute information inter-predicted by the attribute information inter-predictor 63010 is output to the adder 63005 via the switching unit 63011.

The adder 63005 generates reconstructed attribute information by adding the intra-predicted or inter-predicted attribute information and the reconstructed residual attribute information output from the residual attribute inverse transform/inverse quantization unit 63004.

According to embodiments, the attribute decoder 61004 of FIG. 25 reconstruct attribute information by performing all or some of the operations of FIGS. 15 to 23 based on the signaling information (e.g., the information related to prediction of the point cloud data) during inter-prediction or intra-prediction.

According to embodiments, the attribute decoder 61004 of FIG. 25 may perform all or some of the operations of FIGS. 27 to 32 based on the signaling information (e.g., buffer management information) to manage the buffer 63008.

Although not shown in the figure, elements of the geometry decoder and the attribute decoder of FIG. 25 may be implemented as hardware including one or more processors or integrated circuits configured to communicate with one or more memories, software, firmware, or combinations thereof. The one or more processors may perform at least one of the operations and/or functions of the elements of the geometry decoder and the attribute decoder of FIG. 25 described above. Additionally, the one or more processors may operate or execute a set of software programs and/or instructions for execution of the operations and/or functions of the elements of the geometry decoder and the attribute decoder of FIG. 25. The one or more memories may include a high speed random access memory, or include a non-volatile memory (e.g., one or more magnetic disk storage devices, flash memory devices, or other non-volatile solid-state memory devices).

Therefore, with the methods and devices for transmitting and receiving point cloud data according to the embodiments, inter-frame prediction may be efficiently performed and point cloud data quickly encoded and decoded based on the operations according to the embodiments.

In the transmission device, a buffer (or referred to as a reconstructed point cloud buffer or memory) configured to store one or more previous frames is used to perform inter-frame prediction (or referred to as inter-prediction) as shown in FIG. 16. In the reception device, a buffer configured to store one or more previous frames is used to perform inter-frame prediction as shown in FIG. 25.

That is, in the structure shown in FIG. 16 or FIG. 25, information about one or more reference frames or a prediction unit to be referenced should be generated for inter-frame prediction, but not all reconstructed point cloud data may be stored and referenced due to the limited capacity of the buffer. Therefore, efficient buffer management is required. However, the current structure does not have a function to manage the buffer.

The present disclosure proposes a method of efficiently managing the buffer in performing encoding/decoding with reference to one or more frames.

According to the embodiments of the present disclosure, the buffer may be efficiently managed by storing, in the buffer, reconstructed point cloud data that is temporally close to the point cloud to be currently encoded/decoded and removing, from the buffer, reconstructed point cloud data that is temporally distant from the point cloud.

According to embodiments of the present disclosure, the point cloud video encoder of the transmission device may determine a reference reconstructed point cloud that is optimal for coding of a current point cloud, and provide the same to the point cloud video decoder of the reception device. Thereby, the buffer may be kept the same between the point cloud video encoder and decoder.

According to embodiments, the buffer corresponds to at least one of a buffer provided in the geometry encoder of the transmission device, a buffer provided in the attribute encoder, a buffer provided in the geometry decoder of the reception device, or a buffer provided in the attribute decoder.

In the present disclosure, the encoder may be a point cloud video encoder, a geometry encoder or an attribute encoder. In the present disclosure, the decoder may be a point cloud video decoder, a geometry decoder or an attribute decoder.

According to embodiments of the present disclosure, point cloud data to be reconstructed may be stored in a buffer. Then, the point cloud data may be encoded (at the transmitting side)/decoded (at the receiving side) in the order in which the data is stored in the buffer. In this case, the point cloud data to be stored in the buffer may have various forms. The order in which the point cloud data is stored in the buffer may be separated from the order in which the point cloud data is displayed.

According to embodiments, the point cloud data stored in the buffer may be referenced in one or more frames/slices/prediction units.

According to embodiments, the point cloud data stored in the buffer may be stored in the buffer or deleted from the buffer as needed.

According to embodiments, point cloud data to be stored in the buffer may include motion vector related information. According to embodiments, the point cloud data to be stored in the buffer may include both geometry information and attribute information or only geometry information.

According to embodiments, the geometry information and the attribute information of the point cloud data to be stored in the buffer may be stored separately.

According to embodiments, the point cloud video encoder and the point cloud video decoder may store up to N reconstructed cloud data in the buffer. Here, N may be determined by an agreement between the encoder/decoder, or the optimal value of N may be calculated by the encoder and transmitted to the decoder. In addition, the reconstructed point cloud data stored in the buffer may be used to predict geometry information or attribute information of the current point cloud data.

According to embodiments, in storing reconstructed point cloud data, only reconstructed geometry information may be stored or reconstructed geometry information and reconstructed attribute information may be stored together.

According to embodiments, the encoder may determine and signal whether to store only reconstructed geometry information about each point cloud or to store both reconstructed geometry information and reconstructed attribute information together, and the decoder may receive the signaling and determine whether to store the geometry information and attribute information of the current point cloud data.

According to an embodiment, the time at which reconstructed geometry information is stored may be stored in the buffer when decoding of geometry information is completed or when decoding of both the geometry information and the attribute information of the point cloud data is completed.

According to an embodiment, for the reconstructed point cloud data, not all point cloud data may be stored. The geometry information and attribute information of sub-point cloud data may be stored, or only a part of the entire point cloud data may be stored in the buffer so as to be used in predicting other point cloud data. According to an embodiment, when only a part of the point cloud data is stored, the encoder of the transmission device may determine an optimal sub-point cloud, transmit information about an index or position and size of the sub-point cloud to the reception device, and the decoder of the reception device may determine sub-point cloud data to be stored based on the information.

According to an embodiment, among the point cloud data reconstructed by the encoder/decoder, sub-cloud data greater than or equal to a specific ratio of the total number of point cloud data or a threshold may be temporarily determined and stored.

According to embodiments, a motion vector used for inter-frame prediction may be additionally stored in the buffer. In this case, the storage unit of the motion vector may be a prediction unit or an N×M×K cube. According to embodiments, the motion vector may be a vector of (x, y, z) or may be (γ, θ, ϕ) when coordinate transformation is applied. The precision of the motion vector may be an integer unit voxel or a sub-voxel of 1/n voxel. Further, motion vectors may be stored in the buffer per integer unit voxel or subvoxel of 1/n voxel.

According to embodiments, geometry information and attribute information may share motion vectors or each motion vector may be separately stored in the buffer. A motion vector stored in the buffer may be used in coding current point cloud data. According to embodiments, the same motion vector of the geometry information and the attribute information may store in the buffer or each motion vector may be stored in the buffer. According to embodiments, when motion vectors of the geometry information and the attribute information are stored in the buffer, a difference between the motion vector of the geometry information (attribute information) and the motion vector of the attribute information (geometry information) may be stored in the buffer.

According to embodiments, when current point cloud data is partitioned into multiple sub-point cloud data and encoded/decoded, the current sub-point cloud data may be coded using different reconstructed point cloud data for each sub-point cloud. In this case, for reconstructed geometry information to be used for respective sub-point cloud data, the encoder may determine optimal reconstructed geometry information and transmit the same to the decoder of the reception device, and the decoder of the reception device may determine sub-point cloud data to be stored based on the information.

According to embodiments, the sub-point cloud data may be a unit of prediction execution, an independent encoding/decoding unit, or the like.

According to embodiments, the reconstructed geometry information may be stored as x, y, z coordinates, an 8-bit occupancy code, or a 3D Morton code. For example, when the reconstructed geometry information is stored as x, y, and z coordinates, the coordinates on the respective axes may be quantized and stored. In this case, the quantized values may be determined by an agreement between the encoder/decoder. Alternatively, they may be determined by the encoder and transmitted to the reception device, and the decoder of the reception device may parse and determine the same.

According to embodiments, duplicated points produced due to quantization of the geometry information may be mapped to one attribute value by averaging or weighted averaging and stored when reconstructed attribute information is stored. Alternatively, each attribute may be stored, and a duplicated point occurrence flag and the number of duplicated points may be additionally signaled in signaling information.

According to embodiments, the reconstructed geometry information and reconstructed attribute information may be managed in one buffer or independent buffers. When the information is managed in independent buffers, mapping between the geometry information and the attribute information may be performed by storing the reconstructed geometry information and the reconstructed attribute information in the same order.

According to embodiments, when reconstructed attribute information is stored, duplicated points may be mapped to one attribute value through averaging or weighted averaging and stored. Alternatively, each attribute may be stored, and a duplicated point occurrence flag and the number of duplicated points may be additionally signaled in signaling information.

According to embodiments, the present disclosure may use the following method to efficiently manage the buffer.

In one embodiment, up to N point cloud data that are temporally close to the point cloud data to be currently coded are stored in the buffer, and a reconstructed point cloud that is temporally distant is automatically removed from the buffer.

In another embodiment, the encoder of the transmission device may determine optimal reference point cloud data and transmit reference information related to the determined reference point cloud data to the decoder of the reception device such that the encoder and the decoder may maintain the same buffer. Here, the reference information means a part or the entirety of the information (frame or prediction unit) encoded/decoded prior to a frame or prediction unit to be encoded/decoded.

Hereinafter, a detailed description will be given of a case where up to N reconstructed point cloud data temporally close to the point cloud data to be currently coded are stored in a buffer, and a reconstructed point cloud that is temporally distant is removed from the buffer.

That is, when up to N pieces of reconstructed geometry information that are at temporally close positions are stored in the buffer, the encoder/decoder may sort the point cloud data having a greater point cloud order count (POC) in output than the current point cloud data in descending order and store the same in the buffer without additional signaling for selecting reconstructed point cloud data to be stored in the buffer, and may use the same in coding the current point cloud.

In this case, the decoding order and the output order (POC) are the same, and the decoded point cloud data is stored in the buffer, and, a temporally distant reconstructed point cloud is removed from the buffer after a delay corresponding to the current maximum buffer size (N).

According to embodiments, the current point cloud may be coded using the current point cloud data or sub-point cloud data among up to N temporally close reconstructed point cloud data stored in the buffer or using different reconstructed point cloud data for each unit of prediction execution. Here, the reconstructed point cloud data used to code the point cloud data of the corresponding unit may be determined by the encoder of the transmission device, and the decoder of the reception device may parse the same and determine the reconstructed point cloud data to be used for decoding.

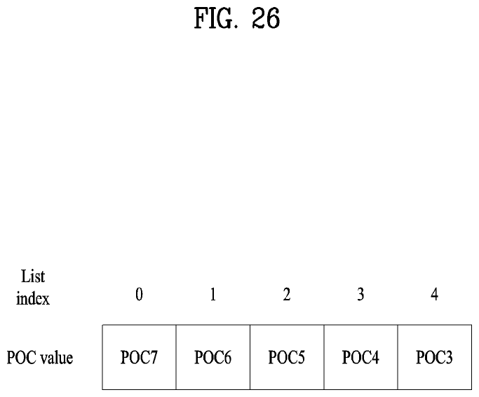

According to embodiments, the encoder/decoder maintain the same reference point cloud list in order to efficiently signal optimal reference point cloud data determined by the encoder of the transmission device. In addition, the index of the same reference point cloud list may be signaled in signaling information, and the decoder of the reception device may receive the same and determine point cloud data to be referenced. According to an embodiment, the reference point cloud list may be configured by arranging POC values of the reconstructed cloud data stored in the buffer in descending order as shown in FIG. 26.

FIG. 26 is a diagram illustrating an exemplary configuration of a reference point cloud list according to embodiments. FIG. 26 illustrates an embodiment of configuring a reference point cloud list by arranging POC values in descending order when the current POC is 8.

In this embodiment, the encoder of the transmission device may transmit the difference between the POC value of the point cloud data to be currently coded and the POC value of the point cloud data to be referenced to the reception device, and the decoder of the reception device may receive and parse the same to select the current point cloud data, sub-point cloud data, or reference reconstructed point cloud data to be used for each unit of prediction execution.

FIG. 27 is a flowchart illustrating an example of a method of managing a buffer according to embodiments. In particular, FIG. 27 is a flowchart illustrating an example of a method of storing up to N reconstructed point cloud data temporally close to point cloud data to be currently coded in a buffer and automatically removing a temporally distant reconstructed point cloud from the buffer. The operations in FIG. 27 may be performed by the decoder of the reception device or the encoder of the transmission device.

According to embodiments, the encoder and/or decoder may include one or more processors and one or more memories electrically or communicatively coupled with the one or more processors to manage the buffer. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for processing the point cloud data.

That is, as described above, a reference point cloud list is configured by arranging POC values of the reconstructed point cloud data stored in the buffer in descending order (operation 65001), and an index of the reference point cloud list is parsed from signaling information (operation 65002).

Then, reference point cloud data is determined based on the parsed index of the reference point cloud list (operation 65003), and point cloud data is reconstructed by decoding the point cloud data based on the determined reference point cloud data (operation 65004).

Then, it is checked whether the buffer is full (operation 65005).

When it is determined in operation 65005 that the buffer is full, the reconstructed point cloud data having the largest POC difference is removed from the buffer (operation 65006), and then the point cloud data reconstructed in operation 65004 is stored in the buffer (operation 65007).

When it is determined in operation 65005 that the buffer is not full, the point cloud data reconstructed in operation 65004 is stored in the buffer without removing the data stored in the buffer (operation 65007).

Next, a detailed description will be given of a case where the encoder of the transmission device determines the optimal reference point cloud data for coding of the current point cloud data, and transmits reference information related to the determined reference point cloud data to the decoder of the reception device such that the encoder of the transmission device and the decoder of the reception device maintain the same buffer.

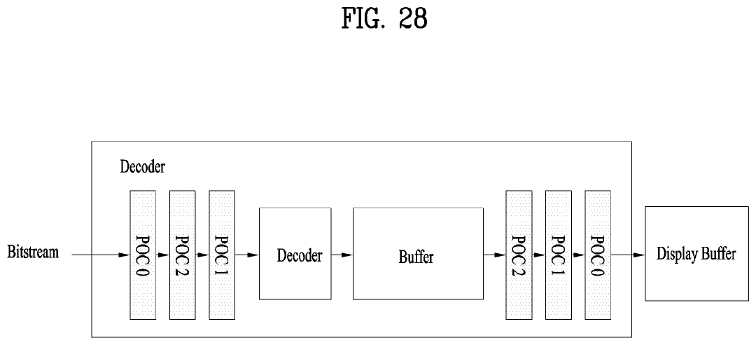

That is, in the case where optimal reference point cloud data is determined by the encoder of the transmission device and transmitted to the reception device, the encoder may determine reference information, and encode the current point cloud data using point cloud data having a greater POC value than the point cloud data to be currently coded as the reference point cloud data. Therefore, as shown in FIG. 28, the output order of point cloud data and the order of encoded/decoded point cloud data may not match.

FIG. 28 is a diagram illustrating an exemplary case where a decoding order and a display order of point cloud data are different from each other according to embodiments.

That is, FIG. 28 illustrates an example in which point cloud data is decoded in order of POC 1->POC 2->POC 0, while being displayed in order of POC 0->POC 1->POC 2. In this case, point cloud data of POC 0 may be decoded with reference to to point cloud data of POC 1 and POC 2.

In FIG. 28, the decoder may correspond to a point cloud data reception device, a point cloud video decoder, a geometry decoder, or an attribute decoder.

According to embodiments, in order for the encoder/decoder to use the same reference point cloud data, the encoder explicitly transmits signaling information including reconstructed point cloud information. According to embodiments, the reconstructed point cloud information may be referred to as a reference point cloud set (RPS) or RPS information. The RPS may include information for dividing the point cloud data stored in the buffer into short/long term reference point cloud data and non-reference point cloud data and information for configuring a reference point cloud list.

According to embodiments, POC information may be signaled in signaling information to distinguish between reference point cloud data and non-reference point cloud data. The POC information may include a difference between a POC value of point cloud data to be currently coded and a POC value of reference reconstructed point cloud data.

According to embodiments, when short-term reference point cloud data and long-term reference point cloud data are marked so as to be distinguished from other, reconstructed point cloud data for the long-term reference point cloud data may be determined based on the value of the least significant bit (LSB) of the POC value of the reference reconstructed point cloud data

According to embodiments, when other point cloud data having the LSB value is also present in the buffer, the value of the most significant bit (MSB) of the POC value may be optionally transmitted to the reception device, and the decoder of the reception device may determine reconstructed point cloud data based thereon. In addition, the RPS may include a 1-bit flag for indicating whether the reconstructed point cloud data is used for encoding/decoding of current point cloud data or sub-point cloud data.

The reconstructed point cloud data selected by the RPS is stored in a buffer as reference point cloud data, and pictures not selected by the RPS are marked as non-reference point cloud data. Although the marked non-reference point cloud data is not referenced by other point cloud data, it may be stored in the buffer for output and than deleted after the output.

Hereinafter, RPS signaling and parsing will be described in detail.

According to embodiments, the RPS may be transmitted from the encoder of the transmission device to the reception device for the entire point cloud data or sub-point cloud data, and the decoder of the reception device may use the RPS for buffer management and/or prediction of point cloud data.

The RPS may include POC information for distinguishing reference/non-reference point cloud data and a 1-bit flag that signals whether the corresponding POC is referenced by current point cloud data or sub-point cloud data.

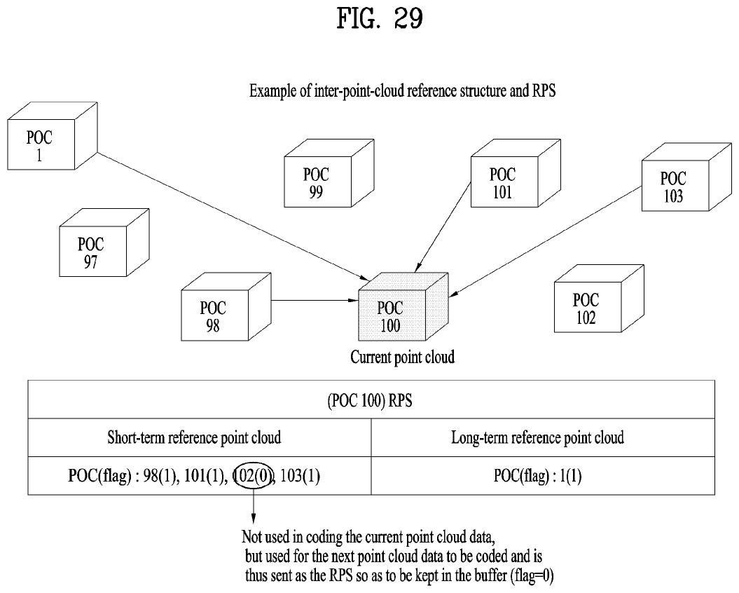

FIG. 29 illustrates an example of an inter-point-cloud reference structure and an RPS according to embodiments. When it is assumed that the POC of the current point cloud data is 100, the RPS of POC 100 is configured as shown in FIG. 29. For example, POC 102 is not used in coding the current point cloud data, but is used for the next point cloud data to be coded and is thus sent as the RPS so as to be kept in the buffer. In this case, the flag has a value of 0.

The decoder of the reception device according to the embodiments maintains reconstructed point cloud data of the POC parsed from the RPS in the buffer, and removes reconstructed point cloud data that is not parsed from the RPS from the buffer.

According to embodiments, among the reconstructed point cloud data stored in the buffer through the RPS, reconstructed point cloud data to be referenced by the current sub-point cloud data per sub-point cloud may constitute a reference point cloud list (or referred to as a reference picture list). The index of the configured reference point cloud list is transmitted to the reception device. Then, the decoder of the reception device may receive the index processed through passing and determine, in the buffer, a reference point cloud to be referenced by the current point cloud data or sub-point cloud data.

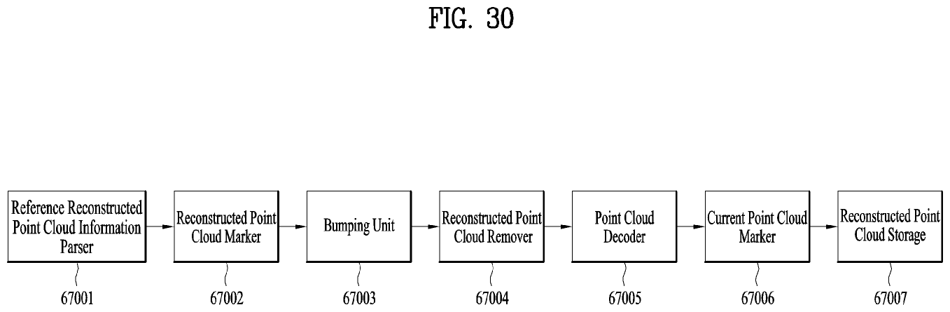

FIG. 30 is a diagram illustrating an example of a method of managing a buffer according to embodiments. Specifically, FIG. 30 illustrates a method of managing a buffer when the encoder of a transmission device determines optimal reference point cloud data for coding of current point cloud data and transmits reference information related to the determined reference point cloud data to the decoder of a reception device. The method in FIG. 30 may be carried out by the encoder of the transmission device or the decoder of the reception device.

In FIG. 30, a reference reconstructed point cloud information parser 67001, a reconstructed point cloud marker 67002, a bumping unit 67003, a reconstructed point cloud remover 67004, a point cloud decoder 67005, a current point cloud marker 67006, and a reconstructed point cloud storage 67007 may be included in the point cloud data transmission device and/or reception device according to embodiments. Each component may correspond to hardware, software, a processor, and/or a combination thereof.

In an embodiment of the present disclosure, the components of FIG. 30 are included in the point cloud data reception device. When the components of FIG. 30 are included in the point cloud data transmission device, the point cloud decoder 67005 may correspond to a case where compressed geometry information is reconstructed for intra-prediction and attribute encoding.

The reference reconstructed point cloud information parser 67001 parses reference reconstructed point cloud information, that is, the RPS, from signaling information.

Based on the RPS provided from the reference reconstructed point cloud information parser 67001, the reconstructed point cloud marker 67002 marks reconstructed point cloud data for which a POC value is transmitted as reference point cloud data, and marks reconstructed point cloud data for which a POC value is not transmitted as non-reference point cloud data. In this case, according to embodiments, the the reference point cloud data may be divided into long-term reference point cloud data and short-term reference point cloud data to perform the marking.

The bumping unit 67003 transmits the reconstructed point cloud data stored in the buffer to a display buffer (or referred to as an output buffer) so as to be output. When the decoding order is different from the display order, the reconstructed point cloud data is sorted in the display order to perform bumping. To this end, the encoder may determine and transmit the minimum delay number necessary for outputting the reconstructed point cloud data from the buffer in accordance with the display order. As another example, by an agreement between the encoder and the decoder, the decoder may perform bumping when the number of point cloud data currently stored in the buffer is greater than the delay number.

The reconstructed point cloud remover 67004 removes the reconstructed point cloud data from the buffer when the reconstructed point cloud data transferred to the display buffer through bumping is non-reference point cloud data.

The point cloud decoder 67005 reconstructs current point cloud data by performing some or all of the operations of the geometry decoder and/or attribute decoder of FIG. 25 based on the reference reconstructed point cloud data stored in the buffer.

The current point cloud marker 67006 marks the current point cloud data reconstructed by the point cloud decoder 67005 as reference/non-reference point cloud data.

The reconstructed point cloud storage 67007 stores the current point cloud data marked as reference/non-reference point cloud data in the buffer. According to embodiments, reconstructed geometry information may be stored in the buffer, or reconstructed geometry information and attribute information may be stored in the buffer. According to embodiments, when the attribute information is to be optionally stored in the buffer, the encoder determines whether to store the attribute information and transmits corresponding information, and the decoder may receive and parse the information to determine whether to store the attribute information. According to embodiments, only a part of the entire reconstructed point cloud data may be stored in the buffer.

According to embodiments, the encoder may determine and transmit optimal reconstructed point cloud data to be used for the current point cloud data, current sub-point cloud data, or each prediction unit among multiple reconstructed point cloud data stored in the buffer, and the decoder may parse the same and determine a reconstructed point cloud to be used for coding of the current point cloud data. In this case, a reference point cloud list may be configured based on the RPS, and an index of the configured reference point cloud list may be transmitted and parsed to determine reference point cloud data to be used for decoding of the current point cloud data. According to embodiments, the encoder may transmit a POC value, a difference between the POC value of the point cloud data to be currently coded and the POC value of the reference reconstructed point cloud data, or the LSB value and MSB value of the POC value of the reference reconstructed point cloud data in place of the index of the reference point cloud list, and the decoder may parse the same to determine a reconstructed point cloud to be used to code the current point cloud data.

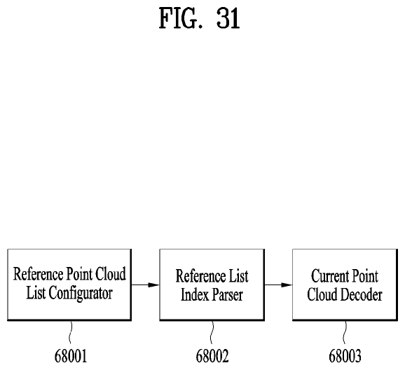

FIG. 31 is an exemplary detailed block diagram of the point cloud decoder 67005 of FIG. 30.

The point cloud decoder 67005 may include a reference point cloud list configurator 68001, a reference list index parser 68002, and a current point cloud decoder 68003.

The reference point cloud list configurator 68001 generates a reference point cloud list having a size of M from reference, short-term reference, or long-term reference point cloud data distinguished by the RPS. Here, the size M may be determined by an agreement between the encoder and the decoder. Alternatively, it may be determined and transmitted by the encoder, and the decoder may determine the size M through parsing. To configure one reference point cloud list according to embodiments, the reference point cloud list is configured by filling in index numbers 0 to M−1 in ascending order of the absolute value of the difference in POC value from the point cloud data to be currently coded.

According to embodiments, when bidirectional prediction is performed using two reconstructed point cloud data, namely, reconstructed point cloud data having a POC value less than that of the current point cloud data and reconstructed point cloud data having a POC value greater than that of the current point cloud data, two reference point cloud lists may be configured. Then, the indexes of the lists may be parsed to determine reconstructed point cloud data to be used for bidirectional prediction. According to embodiments, the two reference point cloud lists (e.g., list 0 and list 1) may be configured as follows. Reference point cloud list 0 may be configured by arranging reconstructed point cloud data having POC values less than that of the point cloud data to be currently coded in descending order among the current reconstructed point cloud data. Reference point cloud list 1 may be configured by arranging reconstructed point cloud data having POC values greater than that of the point cloud data to be currently coded in ascending order. In this regard, when short-term/long-term reference point cloud data is distinguished, information related to the long-term reference point cloud may be added to the end of each of reference point cloud lists 0 and 1.

The reference list index parser 68002 parses indexes of one or more reference point cloud lists for each point cloud, sub-point cloud, or prediction unit from signaling information.

The current point cloud decoder 68003 determines reconstructed point cloud data in the buffer to be used for decoding of current point cloud data based on the indexes of the one or more parsed reference point cloud lists, and decode the current point cloud data based on the determined reconstructed point cloud data. When bidirectional prediction is used according to embodiments, reconstructed point cloud data to be used for bidirectional prediction may be determined based on the indexes for reference point cloud list 0 and reference point cloud list 1.

As such, according to the present disclosure, reconstructed geometry information and/or reconstructed attribute information are stored and managed in a buffer for efficient management of data such as reference frames/slices/prediction units for inter-frame prediction during encoding/decoding of point cloud data. In an embodiment, the buffer may be managed in a manner that reconstructed point cloud data temporally close to the point cloud data to be currently encoded/decoded is stored in the buffer and reconstructed point cloud data temporally distant from the point cloud data to be currently encoded/decoded is removed from the buffer. In another embodiment, the encoder may determine optimal reference reconstructed point cloud data for encoding of current point cloud data and provide the same to the decoder. Thereby, buffers of the encoder/decoder may be maintained to be identical. In this case, storage and management of the reconstructed point cloud data may be performed on a per sub-point cloud basis, and geometry information and attribute information may be independently stored and managed in a buffer. Also, according to embodiments, motion vector information for inter-frame prediction may be additionally stored in the buffer. Through this efficient buffer management, the limitation in use of storage and reference of reference point clouds that may occur due to memory (or capacity) constraints may be addressed. Therefore, according to the present disclosure, buffers required for encoding/decoding may be efficiently managed.

Methods/devices according to embodiments may signal related information to add/perform operations of the embodiments. The signaling information may be used in a transmission device and/or a reception device.

The signaling information used to manage the buffer of the reconstructed geometry information and/or attribute information may be referred to as buffer management information. The buffer management information may include the aforementioned RPS information and POC information.

In an embodiment of the present disclosure, the signaling processor 51005 and/or transmission processor 51008 of FIG. 15 may signal buffer management information, geometry-related prediction information, and/or attribute-related prediction information in at least one of a sequence parameter set, a geometry parameter set, an attribute parameter set, a tile parameter set, a geometry slice header, geometry slice data, an attribute slice header, or attribute slice data. According to embodiments, the SPS may notify that inter-prediction (i.e., inter-frame prediction coding or inter-picture prediction coding) has been performed, and a part or the entirety of the buffer management information may be delivered in the SPS according to an implementation method for buffer management for reconstructed geometry/attribute information. The information may be delivered in the GPS, APS, TPS, slice header, SEI message, or the like. Alternatively, separate RPS_parameter_set may be defined. Buffer management may be dependent on or independent from the existing structure. The buffer management information, geometry-related prediction information, and/or attribute-related prediction information may be defined at a corresponding position or a separate position depending on the application or system such that different application ranges and application methods may be used. In addition, when the syntax elements defined below are applicable to multiple point cloud data streams as well as the current point cloud data stream, the buffer management information, geometry-related prediction information, and/or attribute-related prediction information may be delivered by a higher-level parameter set.

In the present disclosure, the geometry-related prediction information and attribute-related prediction information may be collectively referred to as information related to point cloud data prediction or node prediction mode information.

Hereinafter, signaling information (which may be referred to as metadata, a parameter, a field, a syntax element, or the like) including the buffer management information and the information related to point cloud data prediction according to the embodiments may be generated in a process of the transmission device, and may be transmitted to the reception device and used in a process of reconstructing point cloud data. For example, the signaling information may be generated by the metadata processor (or metadata generator) of or signaling processor of a transmission device according to embodiments, and acquired by the metadata parser or signaling processor of a reception device according to embodiments.

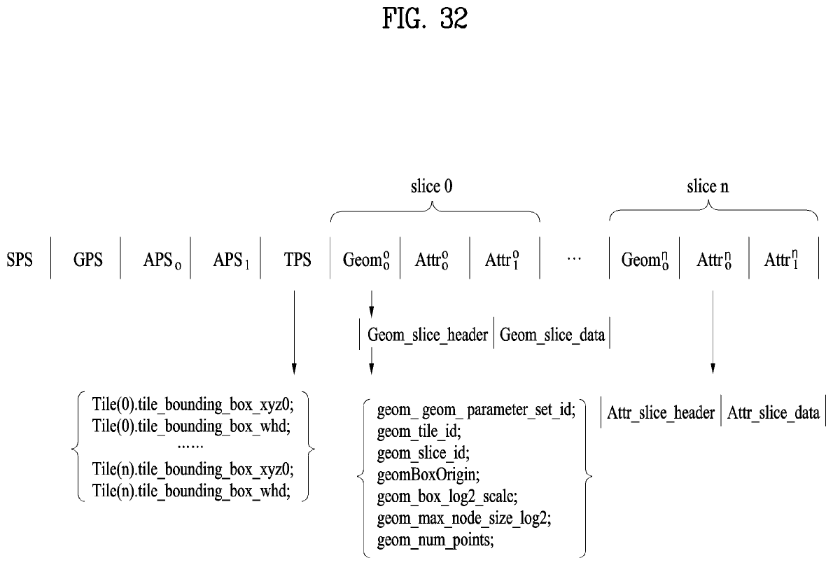

FIG. 32 illustrates an example of a bitstream structure of point cloud data for transmission/reception according to embodiments.

When a geometry bitstream, an attribute bitstream, and a signaling bitstream according to the embodiments are configured in one bitstream by he transmission processor 51008 of FIG. 15, the bitstream may include one or more sub-bitstreams. The bitstream may include a sequence parameter set (SPS) for sequence level signaling, a geometry parameter set (GPS) for signaling of geometry information coding, and one or more attribute parameter sets (APSs) (APS₀ and APS₁) for signaling of attribute information coding, a tile parameter set (TPS) for tile level signaling, and one or more slices (slice 0 to slice n). That is, the bitstream of point cloud data according to the embodiments may include one or more tiles, wherein each tile may be a group of slices including one or more slices (slice 0 to slice n). The TPS may include information about each tile (e.g., coordinate information and height/size information about a bounding box) for one or more tiles. Each slice may include one geometry bitstream Geom0 and one or more attribute bitstreams Attr0 and Attr1. For example, a first slice (slice 0) may include one geometry bitstream Geom0⁰ and one or more attribute bitstreams Attr0⁰ and Attr1⁰.

A geometry bitstream (or referred to as a geometry slice) in each slice may be composed of a geometry slice header (geom_slice_header) and geometry slice data (geom_slice_data). The geometry slice header (geom_slice_header) may include parameter set identification information (geom_parameter_set_id), a tile identifier (geom_tile_id), and a slice identifier (geom_slice_id), which are included in the GPS, and information (geomBoxOrigin, geom_box_log2_scale, geom_max_node_size_log2, geom_num_points) about the data included in the the geometry slice data (geom_slice_data). geomBoxOrigin is geometry box origin information indicating the box origin of the geometry slice data, and geom_box_log2_scale is information indicating the logarithmic scale of the geometry slice data. geom_max_node_size_log2 is information indicating the size of the root geometry octree node, and geom_num_points is information related to the number of points in the geometry slice data. The geometry slice data (geom_slice_data) may include geometry information (or geometry data) of the point cloud data in the corresponding slice.

Each attribute bitstream in each slice (or referred to as an attribute slice) may include an attribute slice header (attr_slice_header) and attribute slice data (attr_slice_data). The attribute slice header (attr_slice_header) may include information about the attribute slice data, and the attribute slice data may include attribute information (or referred to as attribute data or an attribute value) about point cloud data in a corresponding slice. When there are multiple attribute bitstreams in a slice, each attribute bitstream may include different attribute information. For example, one attribute bitstream may include attribute information corresponding to color, and another attribute bitstream may include attribute information corresponding to reflectance.

According to embodiments, the information related to point cloud data prediction and/or buffer management information may be newly defined in a parameter set of point cloud data and/or a corresponding slice. For example, they may be added to the GPS in encoding/decoding geometry information, and to a tile and/or slice in performing tile-based encoding/decoding. According to embodiments, the bitstream of the point cloud data provides tiles or slices such that the point cloud data may be partitioned and processed by regions. The respective regions of the bitstream may have different importances. Accordingly, when the point cloud data is partitioned into tiles, a different filter (encoding method) and a different filter unit may be applied to each tile. When the point cloud data is partitioned into slices, a different filter and a different filter unit may be applied to each slice.

The transmission device according to the embodiments may transmit point cloud data according to the bitstream structure as shown in FIG. 32. Accordingly, a method to apply different encoding operations and use a good-quality encoding method for an important region may be provided. In addition, efficient encoding and transmission may be supported according to the characteristics of point cloud data, and attribute values may be provided according to user requirements.

The reception device according to the embodiments may receive the point cloud data according to the bitstream structure as shown in FIG. 32. Accordingly, different filtering (decoding) methods may be applied to the respective regions (regions partitioned into tiles or into slices), rather than a complexly decoding (filtering) method being applied to the entire point cloud data. Therefore, better image quality in a region important is provided to the user and an appropriate latency to the system may be ensured.

A field, which is the term used in syntaxes of the present disclosure described later, may have the same meaning as a parameter or an element.

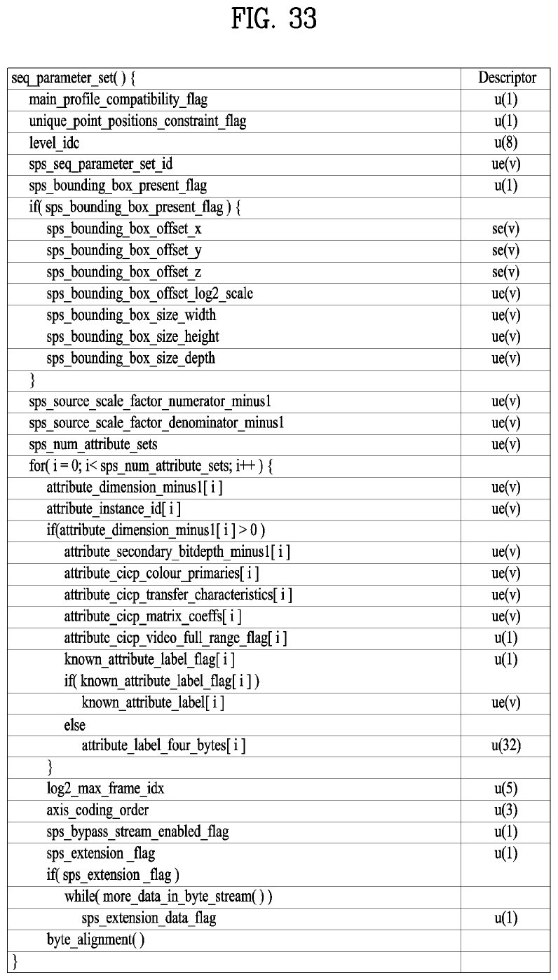

FIG. 33 shows an embodiment of a syntax structure of a sequence parameter set (SPS) (seq_parameter_set( )) according to the present disclosure. The SPS may contain sequence information about a point cloud data bitstream.

The SPS according to the embodiments may include a main_profile_compatibility_flag field, a unique_point_positions_constraint_flag field, a level_idc_field, an sps_seq_parameter_set_id_field, an sps_bounding_box_present_flag field, an sps_source_scale_factor_numerator_minus1 field, an sps_source_scale_factor_denominator_minus1 field, an sps_num_attribute_sets field, log2_max_frame_idx field, an axis_coding_order field, an sps_bypass_stream_enabled_flag field, and an sps_extension_flag field.

The main_profile_compatibility_flag field may indicate whether the bitstream conforms to the main profile. For example, main_profile_compatibility_flag equal to 1 may indicate that the bitstream conforms to the main profile. For example, main_profile_compatibility_flag equal to 0 may indicate that the bitstream conforms to a profile other than the main profile.

When unique_point_positions_constraint_flag is equal to 1, in each point cloud frame that is referred to by the current SPS, all output points may have unique positions. When unique_point_positions_constraint_flag is equal to 0, in any point cloud frame that is referred to by the current SPS, two or more output points may have the same position. For example, even when all points are unique in the respective slices, slices in a frame and other points may overlap. In this case, unique_point_positions_constraint_flag is set to 0.

level_idc indicates a level to which the bitstream conforms.

sps_seq_parameter_set_id provides an identifier for the SPS for reference by other syntax elements.

The sps_bounding_box_present_flag field indicates whether a bounding box is present in the SPS. For example, sps_bounding_box_present_flag equal to 1 indicates that the bounding box is present in the SPS, and sps_bounding_box_present_flag equal to 0 indicates that the size of the bounding box is undefined.

According to embodiments, when sps_bounding_box_present_flag is equal to 1, the SPS may further include an sps_bounding_box_offset_x field, an sps_bounding_box_offset_y field, an sps_bounding_box_offset_z field, an sps_bounding_box_offset_log2_scale field, an sps_bounding_box_size_width field, an sps_bounding_box_size_height field, and an sps_bounding_box_size_depth field.

sps_bounding_box_offset_x indicates the x offset of the source bounding box in Cartesian coordinates. When the x offset of the source bounding box is not present, the value of sps_bounding_box_offset_x is 0.

sps_bounding_box_offset_y indicates the y offset of the source bounding box in Cartesian coordinates. When the y offset of the source bounding box is not present, the value of sps_bounding_box_offset_y is 0.

sps_bounding_box_offset_z indicates the z offset of the source bounding box in Cartesian coordinates. When the z offset of the source bounding box is not present, the value of sps_bounding_box_offset_z is 0.

sps_bounding_box_offset_log2_scale indicates a scale factor for scaling quantized x, y, and z source bounding box offsets.

sps_bounding_box_size_width indicates the width of the source bounding box in Cartesian coordinates. When the width of the source bounding box is not present, the value of sps_bounding_box_size_width may be 1.

sps_bounding_box_size_height indicates the height of the source bounding box in Cartesian coordinates. When the height of the source bounding box is not present, the value of sps_bounding_box_size_height may be 1.

sps_bounding_box_size_depth indicates the depth of the source bounding box in Cartesian coordinates. When the depth of the source bounding box is not present, the value of sps_bounding_box_size_depth may be 1.

sps_source_scale_factor_numerator_minus1 plus 1 indicates the scale factor numerator of the source point cloud.

sps_source_scale_factor_denominator_minus1 plus 1 indicates the scale factor denominator of the source point cloud.

sps_num_attribute_sets indicates the number of coded attributes in the bitstream.

The SPS according to the embodiments includes an iteration statement repeated as many times as the value of the sps_num_attribute_sets field. In an embodiment, i is initialized to 0, and is incremented by 1 each time the iteration statement is executed. The iteration statement is repeated until the value of i becomes equal to the value of the sps_num_attribute_sets field. The iteration statement may include an attribute_dimension_minus1[i] field and an attribute_instance_id[i] field. attribute_dimension_minus1[i] plus 1 indicates the number of components of the i-th attribute.

The attribute_instance_id[i] field specifies the instance ID of the i-th attribute.

According to embodiments, when the value of the attribute_dimension_minus1[i] field is greater than 1, the iteration statement may further include an attribute_secondary_bitdepth_minus1[i] field, an attribute_cicp_colour_primaries[i] field, an attribute_cicp_transfer_characteristics[i] field, an attribute_cicp_matrix_coeffs[i] field, and an attribute_cicp_video_full_range_flag[i] field.

attribute_secondary_bitdepth_minus1[i] plus 1 specifies the bitdepth for the secondary component of the i-th attribute signal(s).

attribute_cicp_colour_primaries[i] indicates the chromaticity coordinates of the color attribute source primaries of the i-th attribute.

attribute_cicp_transfer_characteristics[i] either indicates the reference opto-electronic transfer characteristic function of the color attribute as a function of a source input linear optical intensity with a nominal real-valued range of 0 to 1 or indicates the inverse of the reference electro-optical transfer characteristic function as a function of an output linear optical intensity

attribute_cicp_matrix_coeffs[i] describes the matrix coefficients used in deriving luma and chroma signals from the green, blue, and red, or Y, Z, and X primaries of the i-th attibute.

attribute_cicp_video_full_range_flag[i] specifies the black level and range of the luma and chroma signals as derived from E′Y, E′PB, and E′PR or E′R, E′G, and E′B real-valued component signals of the i-th attibute.

The known_attribute_label_flag[i] field indicates whether a know_attribute_label[i] field or an attribute_label_four_bytes[i] field is signaled for the i-th attribute. For example, when known_attribute_label_flag[i] equal to 0 indicates the known_attribute_label[i] field is signaled for the i-th attribute. known_attribute_label_flag[i] equal to 1 indicates that the attribute_label_four_bytes[i] field is signaled for the i-th attribute.

known_attribute_label[i] specifies the type of the i-th attribute. For example, known_attribute_label[i] equal to 0 may specify that the i-th attribute is color. known_attribute_label[i] equal to 1 may specify that the i-th attribute is reflectance. known_attribute_label[i] equal to 2 may specify that the i-th attribute is frame index. Also, known_attribute_label[i] equal to 4 specifies that the i-th attribute is transparency. known_attribute_label[i] equal to 5 specifies that the i-th attribute is normals.

attribute_label_four_bytes[i] indicates the known attribute type with a 4-byte code.

According to embodiments, attribute_label_four_bytes[i] equal to 0 may indicate that the i-th attribute is color. attribute_label_four_bytes[i] equal to 1 may indicate that the i-th attribute is reflectance. attribute_label_four_bytes[i] equal to 2 may indicate that the i-th attribute is a frame index. attribute_label_four_bytes[i] equal to 4 may indicate that the i-th attribute is transparency. attribute_label_four_bytes[i] equal to 5 may indicate that the i-th attribute is normals.

log2_max_frame_idx indicates the number of bits used to signal a syntax variable frame_idx.

axis_coding_order specifies the correspondence between the X, Y, and Z output axis labels and the three position components in the reconstructed point cloud RecPic [pointidx] [axis] with and axis=0 . . . 2.

sps_bypass_stream_enabled_flag equal to 1 specifies that the bypass coding mode may be used in reading the bitstream. As another example, sps_bypass_stream_enabled_flag equal to 0 specifies that the bypass coding mode is not used in reading the bitstream.

sps_extension_flag indicates whether the sps_extension_data syntax structure is present in the SPS syntax structure. For example, sps_extension_present_flag equal to 1 indicates that the sps_extension_data syntax structure is present in the SPS syntax structure. sps_extension_present_flag equal to 0 indicates that this syntax structure is not present.

When the value of the sps_extension_flag field is 1, the SPS according to the embodiments may further include an sps_extension_data_flag field.

sps_extension_data_flag may have any value.

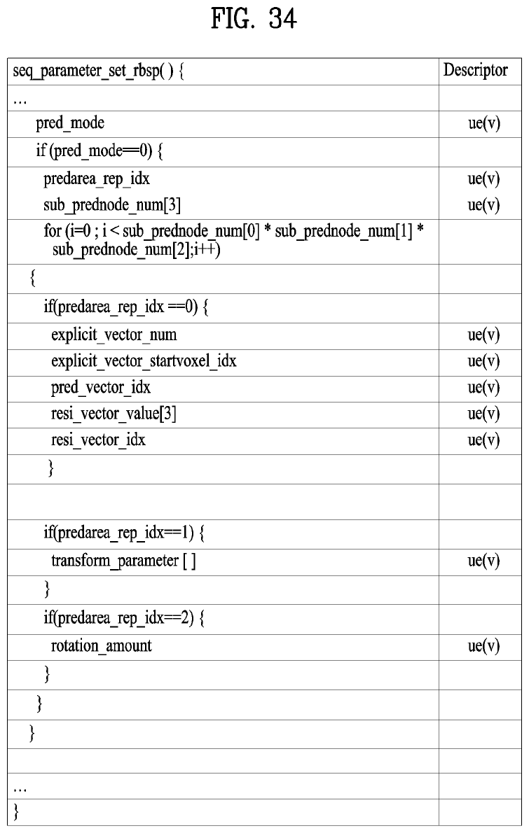

FIG. 34 shows an exemplary syntax structure of a sequence parameter set (sequence_parameter_set( )) (SPS) including information related to prediction of point cloud data according to embodiments.

According to embodiments, in order to perform inter-prediction per frame/content, the SPS may further include information related to point cloud data prediction.

The information related to the point cloud data prediction may include at least one of a pred_mode field, a predarea_rep_idx field, a sub_prednode_num[3] field, an explicit_vector_num field, an explicit_vector_startvoxel_idx field, a pred_vector_idx field, a resi_vector_value[3] field, a resi_vector_idx field, a transform_parameter [ ], and a rotation_amount field.

The pred_mode field may indicate an index of a prediction mode of a current node.

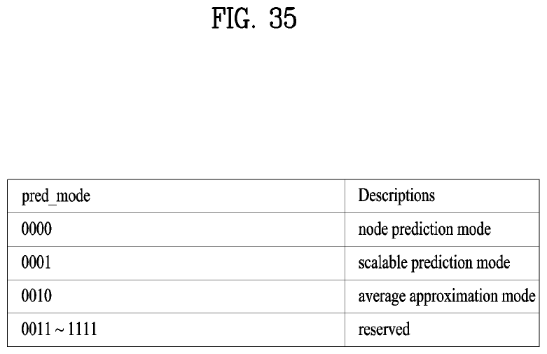

FIG. 35 is a table showing exemplary prediction modes for a current node allocated to the pred_mode field according to embodiments.

For example, among the values of the pred_mode field, 0000 (or 0) may indicate a node prediction mode, 0001 (or 1) may indicate a scalable prediction mode, and 0010 (or 2) may indicate an average approximation mode. A prediction mode may be added to the prediction modes in FIG. 35, or any of the prediction modes may be deleted.

According to embodiments, when the value of the pred_mode field is 0000, that is, when the prediction mode of the current node is the node prediction mode, the predarea_rep_idx field and the sub_prednode_num[3] field are further included in the SPS.

The predarea_rep_idx field may indicate an index of a reference region information representation method for a current node.

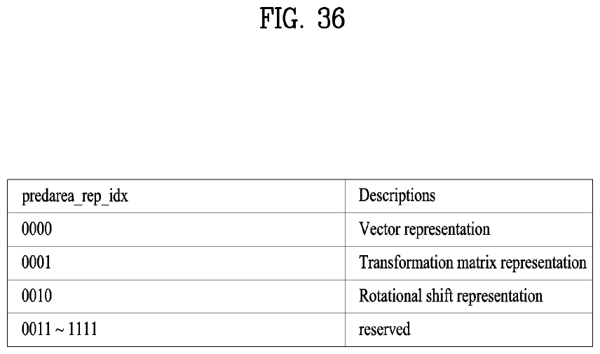

FIG. 36 is a table showing exemplary methods of representing reference region information related to a current node as allocated to the predarea_rep_idx field according to embodiments.

For example, among the values of the predarea_rep_idx field, 0000 (or 0) may indicate vector representation, 0001 (or 1) may indicate transformation matrix representation, and 0010 (or 2) may indicate rotational shift representation. A mehod may be added to the methods for reference region information representation in FIG. 36 or any of the methods may be deleted.

When the prediction mode of the current node is the node prediction mode, the sub_prednode_num[3] field may indicate the number of pieces into which the reference region is to be partitioned along three directions. For example, sub_pred_node_num[0] may indicate the number of pieces into which the reference region is to be partitioned along the x-axis, sub_pred_node_num[1] may indicate the number of pieces into which the reference region is to be partitioned along the y-axis, and sub_pred_node_num[2] may indicate the number of pieces into which the reference region is to be partitioned along the z-axis. When the coordinate values of the geometry information are converted into coordinate values other than (x, y, z), the value/axis information for partitioning may also vary according to the coordinate values.

The SPS according to embodiments includes a loop statement iterating as many times as the value of the sub_prednode_num[3] field. In an embodiment this case, i is initialized to 0, and incremented by 1 each time the loop statement is executed. The loop statement iterates until i reaches the value of the sub_prednode_num[3] field. For example, when the reference region is partitioned into two regions along the x-axis, two regions along the y-axis, and two regions along the z-axis, the loop statement iterates eight times.

According to embodiments, an index of a reference region information representation method may vary each time the loop statement iterates. That is, the predarea_rep_idx field may indicate the index of the reference region information representation method differently according to the value of the sub_pred_node_num field.

According to embodiments, when the value of the predarea_rep_idx field is 0, that is, when the reference region information representation method for the current node is vector representation, the loop statement may include the explicit_vector_num field, the explicit_vector_startvoxel_idx field, the pred_vector_idx field, and the resi_vector_value[3] field, and the resi_vector_idx field.

According to embodiments, the loop statement may include the transform_parameter[ ] field when the value of the predarea_rep_idx field is 1, that is, when the reference region information representation method for the current node is transformation matrix representation.

According to embodiments, the loop statement may include the rotation_amount field when the value of the predarea_rep_idx field is 2, that is, when the reference region information representation method for the current node is rotational shift representation.

When the reference region information representation method is vector representation, the explicit_vector_num field may indicate the number of received vectors for each reference region.

When the reference region information representation method is vector representation, the explicit_vector_startvoxel_idx field may indicate a start voxel index of a received vector for each reference region. According to embodiments, 8 vertices of the current node may be designed to be mapped to indexes 0 to 7. In the present disclosure, a vertex may be added to or deleted from the number of vertices.

The pred_vector_idx field may indicate the index of a vector/vector group in a reference vector list to be referenced for generation of predicted vectors for each reference region when the reference region information representation method is vector representation. According to embodiments, different vectors may have the same index value to indicate the index of a vector group.

The resi_vector_value[ ] field may have a residual of a vector along each axis of geometry information for each reference region when the reference region information representation method is vector representation.

The resi_vector_idx field may indicate an index in a residual vector list for each reference region when the reference region information representation method is vector representation.

The transform_parameter[ ] field may have a value indicating each element of a matrix for each reference region when the reference region information representation method is transformation matrix representation.

The rotation_amount field may have a value indicating a degree of rotation for each reference region when the reference region information representation method is rotational shift representation. The value may be a degree value in a range of from 0 to 360 degrees or a radian value in a range of [−π, 2π].

According to embodiments, information related to point cloud data prediction in FIG. 34 may be included at any position in the SPS of FIG. 33.

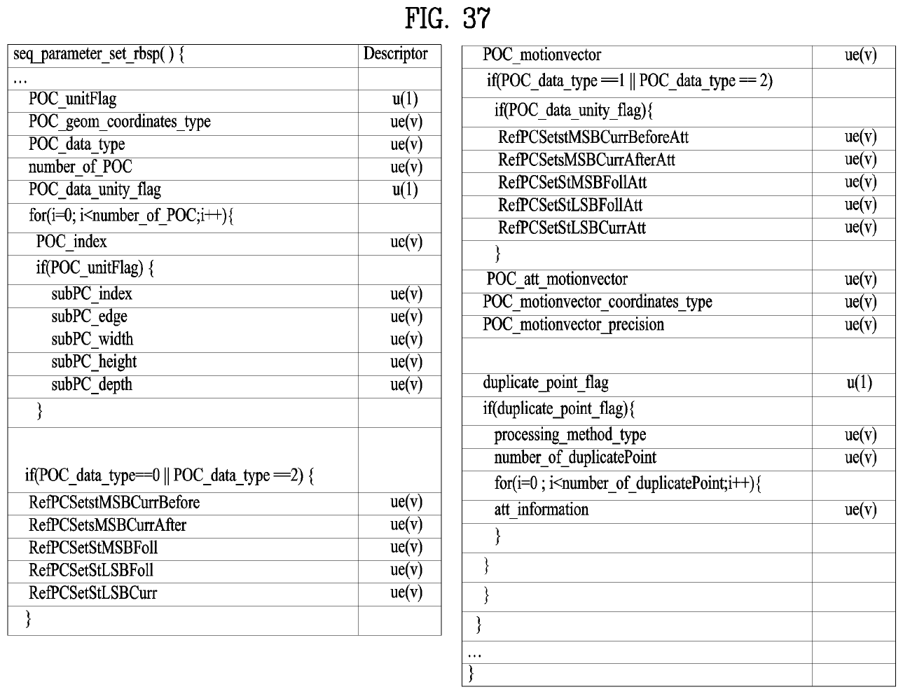

FIG. 37 shows an exemplary syntax structure of a sequence parameter set (sequence_parameter_set( )) (SPS) including buffer management information according to embodiments.

According to embodiments, the SPS may further include buffer management information to perform buffer management per frame/content.

The buffer management information may include a POC_unitFlag field, a POC_geom_coordinates_type field, a POC_data_type field, a number_of_POC field, and a POC_data_unity_flag field.

The POC_unitFlag field may indicate whether reference information to be signaled with the POC is an entire frame or a portion of point cloud data (i.e., a portion of the frame). For example, when the value of the POC_unitFlag field is FALSE (e.g., 0), it may indicate the entire frame. When the value of the POC_unitFlag field is TRUE (e.g., 1), it may indicate a portion of point cloud data (i.e., a portion of the frame).

The POC_geom_coordinates_type field may indicate a data type of reconstructed geometry information.

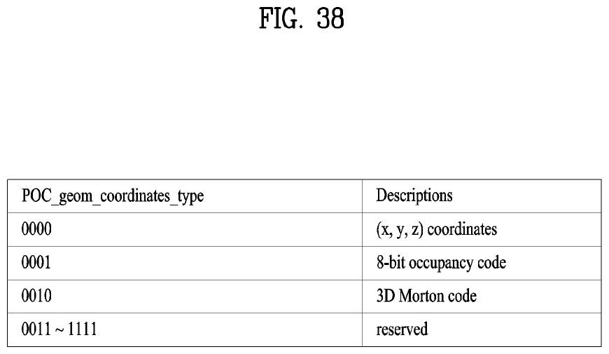

FIG. 38 is a table showing examples of data types of reconstructed geometry information allocated to the POC_geom_coordinates_type field according to embodiments.

For example, among the values of the POC_geom_coordinates_type field, 0000 (or 0) may indicate (x, y, z) coordinates, 0001 (or 1) may indicate an 8-bit occupancy code, and 0010 (or 2) may indicate a 3D Morton code. A data type may be added to or deleted from the data types of the reconstructed geometry information of FIG. 38.

The POC_data_type field may indicate whether the POC stores only geometry information, only attribute information, or both geometry and attribute information in a buffer for each POC.

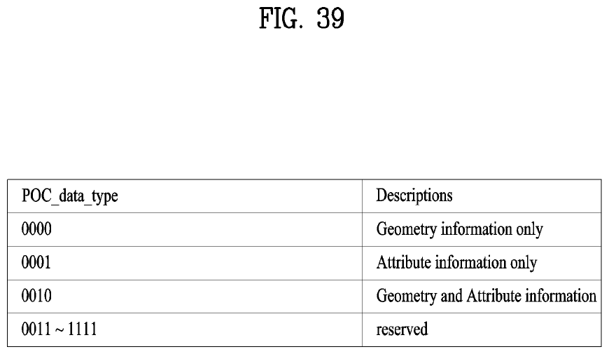

FIG. 39 is a table showing exemplary information storage methods allocated to the POC_data_type field according to embodiments.

For example, among the values of the POC_data_type field, 0000 (or 0) may indicate that only geometry information is stored, and 0001 (or 1) may indicate that only attribute information is stored. 0010 (or 2) may indicate that geometry information and attribute information are stored together. An information storage method may be added to or deleted from the information storage methods of FIG. 39.

That is, when the value of the POC_data_type field is 1 or 2, it means that attribute information is managed with a buffer.

The number_of_POC field may indicate the number of reconstructed cloud data stored in a buffer.

The POC_data_unity_flag field indicates whether to manage reconstructed attribute information together with geometry information in one buffer. For example, when the value of the POC_data_unity_flag field is FALSE (i.e., 0), it indicates that the reconstructed attribute information and the geometry information are managed with one buffer. When the value is TRUE (i.e., 1), it may indicate that the reconstructed attribute information is managed with a buffer independent (or separate) from the buffer for managing the reconstructed geometry information. According to embodiments, when the reconstructed attribute information is managed with one buffer, only the reconstructed attribute information may be added to the same buffer as the buffer for managing the reconstructed geometry information.

The SPS according to embodiments includes a loop statement iterating as many times as the value of the number_of_POC field. In this case, i is initialized to 0, and incremented by 1 each time the loop statement is executed. The loop statement iterates until i reaches the value of the number_of_POC field. The loop statement may include a POC_index field.

The POC_index field may indicate the index of a POC.

When the value of the POC_unitFlag field is TRUE, the loop statement may further include a subPC_index field, a subPC_edge field, a subPC_width field, a subPC_height field, and a subPC_depth field.

The subPC_index field may indicate an index of sub-point cloud data when the POC indicates only partial information of the point cloud data.

The subPC_edge field may indicate position information of sub-point cloud data when the POC indicates only partial information of the point cloud data. Here, the position information may be the same as the POC_geom_coordinates_type field or may be any value capable of indicating a position in space.

The subPC_width field may indicate the width of a node centered on a value of the subPC_edge field, which is position information of sub-point cloud data, when the POC indicates only partial information of the point cloud data.

The subPC_height field may indicate the height of a node centered on the value of the subPC_edge field, which is position information of sub-point cloud data, when the POC indicates only partial information of the point cloud data.

The subPC_depth field may indicate the depth of a node centered on the value of the subPC_edge field, which is position information of sub-point cloud data, when the POC indicates only partial information of the point cloud data.

According to embodiments, when the value of the POC_data_type field is 0 or 2, that is, the value indicates that geometry information is managed with a buffer, the loop statement may further include a RefPCSetstMSBCurrBefore field, a RefPCSetsMSBCurrAfter field, a RefPCSetStMSBFoll field, a RefPCSetStLSBFoll field, and a RefPCSetStLSBCurr field.

The RefPCSetsMSBCurrBefore field is a list of short-term point cloud data referenced by current point cloud data, and point cloud data having a smaller POC than the current point cloud data among the point cloud data may be sorted in descending order of POC and managed.

The RefPCSetsMSBCurrAfter field is a list of short-term point cloud data referenced by the current point cloud data, and point cloud data having a larger POC than the current point cloud data among the point cloud data may be sorted in ascending order of POC and managed.

The RefPCSetMSBFoll field is a list of short-term point cloud data that is not referenced by the current point cloud data, and may signal a POC index or a residual of the POC of the current point cloud data.

The RefPCSetLSBFoll field is a list of long-term point cloud data that is not referenced by the current point cloud data, and may signal a POC index or a residual of the POC of the current point cloud data.

The RefPCSetLSBCurr field is a list of long-term point clouds referenced by current point cloud data. In this case, when short-term/long-term reference point cloud data are distinguished, the long-term reference point cloud data may be added to the end of each of ReFPCSetsMSBCurrBefore (i.e., reference point cloud list 0) and RefPCSetsMSBCurrAfter (i.e., reference point cloud list 1). The RefPCSetLSBCurr field may signal a POC index or a residual of the POC of the current point cloud.

According to embodiments, the loop statement may further include a POC_motionvector field.

The POC_motionvector field may signal a motion vector for each POC. In this case, the storage size of the motion vector may be a prediction unit or may be indicated in the form of a cube of N×M×K.

According to embodiments, when the value of the POC_data_type field is 1 or 2, that is, the value indicates that attribute information is managed with a buffer, and the value of the POC_data_unity_flag field is 1, that is, the buffer for managing the reconstructed attribute information is independent from the buffer for managing the reconstructed geometry information, the loop statement may include a RefPCSetstMSBCurrBeforeAtt field, a RefPCSetsMSBCurrAfterAtt field, a RefPCSetStMSBFollAtt field, a RefPCSetStLSBFollAtt field, and a RefPCSetStLSBCurrAtt field.

The RefPCSetsMSBCurrBeforeAtt field is a list of short-term point cloud data referenced by the current point cloud data when the buffer is divided into geometry information and attribute information for management, and point cloud data having a smaller POC than the current point cloud data among the point cloud data may be sorted in descending order of POC including attribute information and managed.

The RefPCSetsMSBCurrAfterAtt field is a list of short-term point clouds referenced by the current point cloud data when the buffer is divided into geometry information and attribute information for management, and point cloud data having a larger POC than the current point cloud data among the point cloud data may be sorted in ascending order of POC including attribute information and managed.

The RefPCSetMSBFollAtt field is a list of short-term point cloud data including attribute information that is not referenced by the current point cloud data when the buffer is separated into geometry information and attribute information for management, and may signal a POC index or a residual of the POC of the current point cloud data.

The RefPCSetLSBFollAtt field is a list of long-term point cloud data including attribute information that is not referenced by the current point cloud data when the buffer is separated into geometry information and attribute information for management, and may signal a POC index or a residual of the POC of the current point cloud data.

The RefPCSetLSBCurrAtt field is a list of long-term point cloud data including attribute information referenced by current point cloud data when the buffer is divided into geometry information and attribute information for management. In this case, when short-term/long-term reference point cloud data are distinguished, the long-term reference point cloud data may be added to the end of each of RefPCSetsMSBCurrBeforeAtt (i.e., reference point cloud list 0) and RefPCSetsMSBCurrAfterAtt (i.e., reference point cloud list 1). The RefPCSetLSBCurrAtt field may signal a POC index or a residual of the POC of the current point cloud.

According to embodiments, the loop statement may further include a POC_att_motionvector field, a POC_motionvector_coordinates_type field, a POC_motionvector_precision field, and a duplicate_point_flag field.

The POC_att_motionvector field may signal motion vector information related to attribute information when the POC stores geometry information and attribute information together in one buffer and a value of the POC_motionvector field is separately applied for the attribute information. According to embodiments, the size of the motion vector information may be a prediction unit or may be in the form of N×M×K. In addition, for the motion vector data of the attribute information, a residual of a geometry information vector or separate motion vector information may be stored.

The POC_motionvector_coordinates_type field may signal a motion vector for each POC.

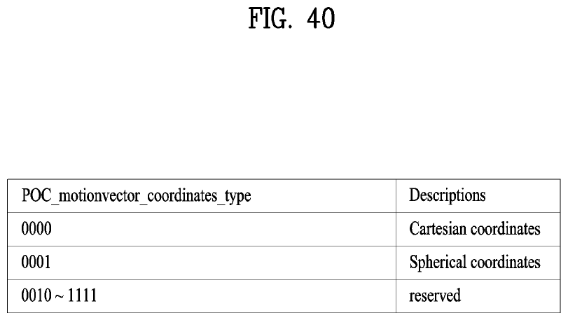

FIG. 40 is a table showing examples of data types of a motion vector allocated to a POC_motionvector_coordinates_type field according to embodiments.

For example, the POC_motionvector_coordinates_type field set to 0000 (or 0) may indicate Cartesian coordinates, and the POC_motionvector_coordinates_type field set to 0001 (or 1) may indicate spherical coordinates. A data type may be added to or deleted from the data types of the motion vector in FIG. 40.

That is, when motion vector data is signaled as (x, y, z) coordinates, the value of the POC_motionvector_coordinates_type field may be 0. When motion vector data is signaled as (γ, θ, ϕ), the value of the POC_motionvector_coordinates_type field may be 1. In addition, any information that may indicate motion vectors may be added.

The POC_motionvector_precision field may indicate motion vector precision. According to embodiments, it may be stored per integer unit voxel or sub-voxel, which is 1/n voxel.

The duplicate_point_flag field may indicate whether there is a duplicate point of attribute information has occurred. For example, the duplicate_point_flag field set to TRUE (e.g., 1) may indicate that there is a duplicate point. The duplicate_point_flag field set to FALSE (e.g., 0) may indicate that there is no duplicate point.

When the value of the duplicate_point_flag field is TRUE, the loop statement may further include a processing_method_type field and a number_of_duplicatePoint field.

The processing_method_type field may indicate a processing method for duplicate points.

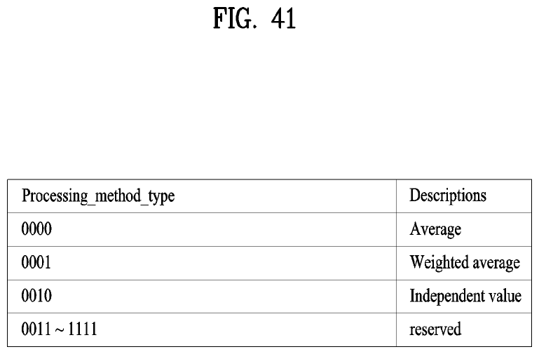

FIG. 41 is a table showing examples of a duplicate point processing method allocated to a processing_method_type field according to embodiments.

For example, the processing_method_type field set to 0000 (or 0) may indicate that duplicate points are averaged and processed. The processing_method_type field set to 0001 (or 1) may indicate that duplicate points are averaged by applying weights. The processing_method_type field set to 0010 (or 2) may indicate that duplicate points are processed as independent values. A duplicate point processing method may be added to or deleted from the duplicate point processing methods of FIG. 41.

When the value of the processing_method_type field is 2, that is, when duplicate points are processed as independent values, the number_of_duplicatePoint field may indicate the number of duplicate points to store each attribute value.

According to embodiments, as many att_information fields as the value of the number_of_duplicatePoint field may be further included.

The att_information field may indicate attribute information when the attribute information is stored and signaled.

According to embodiments, the buffer management information of FIG. 37 may be included at any position in the SPS of FIG. 33.

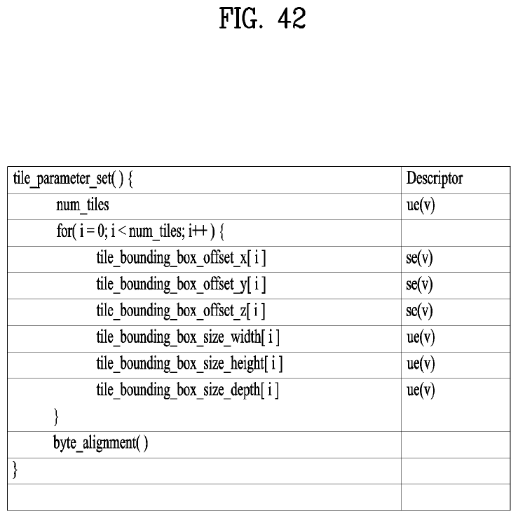

FIG. 42 shows an exemplary syntax structure of a tile parameter set (tile_parameter_set( )) (TPS) according to embodiments. According to embodiments, the TPS may be referred to as a tile inventory. The TPS includes information related to each tile.

The TPS according to embodiments includes a num_tiles field.

The num_tiles field indicates the number of tiles signaled for the bitstream. When not present, num_tiles field is inferred to be 0.

The TPS according to embodiments includes a loop statement iterating as many times as the value of the num_tiles field. In this case, i is initialized to 0, and incremented by 1 each time the loop statement is executed. The loop statement iterates until i reaches the value of the num_tiles field. This loop statement may include a tile_bounding_box_offset_x[i] field, a tile_bounding_box_offset_y[i] field, a tile_bounding_box_offset_z[i] field, a tile_bounding_box_size_width[i] field, a tile_bounding_box_size_height[i] field, a tile_bounding_box_size_depth[i] field, and an attribute_pred_residual_separate_encoding_flag[i] field.

The tile_bounding_box_offset_x[i] field indicates the x offset of the i-th tile in the Cartesian coordinates.

The tile_bounding_box_offset_y[i] field indicates the y offset of the i-th tile in the Cartesian coordinates.

The tile_bounding_box_offset_z[i] field indicates the z offset of the i-th tile in the Cartesian coordinates.

The tile_bounding_box_size_width[i] field indicates the width of the i-th tile in the Cartesian coordinates.

The tile_bounding_box_size_height[i] field indicates the height of the i-th tile in the Cartesian coordinates.

The tile_bounding_box_size_depth[i] field indicates the depth of the i-th tile in the Cartesian coordinates.

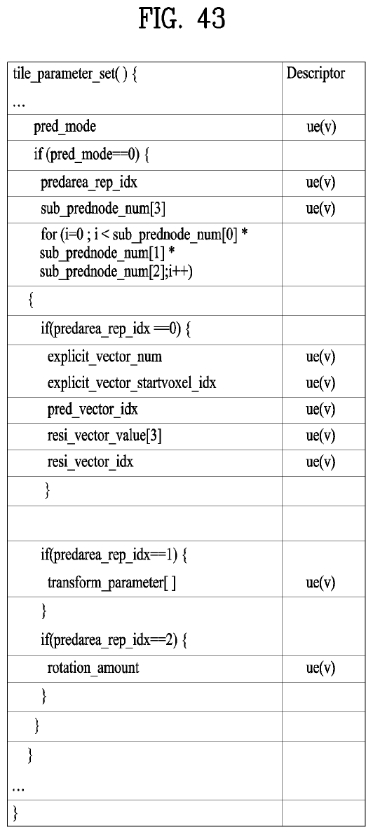

FIG. 43 shows an exemplary syntax structure of a tile parameter set (tile_parameter_set( )) (TPS) including information related to prediction of point cloud data according to embodiments.

Fields included in the information related to prediction of point cloud data in FIG. 43 have been described in detail with reference to FIGS. 34 to 36, and thus a description thereof will be skipped to avoid redundant description.

According to embodiments, the information related to prediction of point cloud data in FIG. 43 may be included at any position (e.g., within the loop statement) in the TPS of FIG. 42. The information related to prediction of the point cloud data in FIG. 43 may be applied when prediction of the point cloud data is performed per tile or tile group.

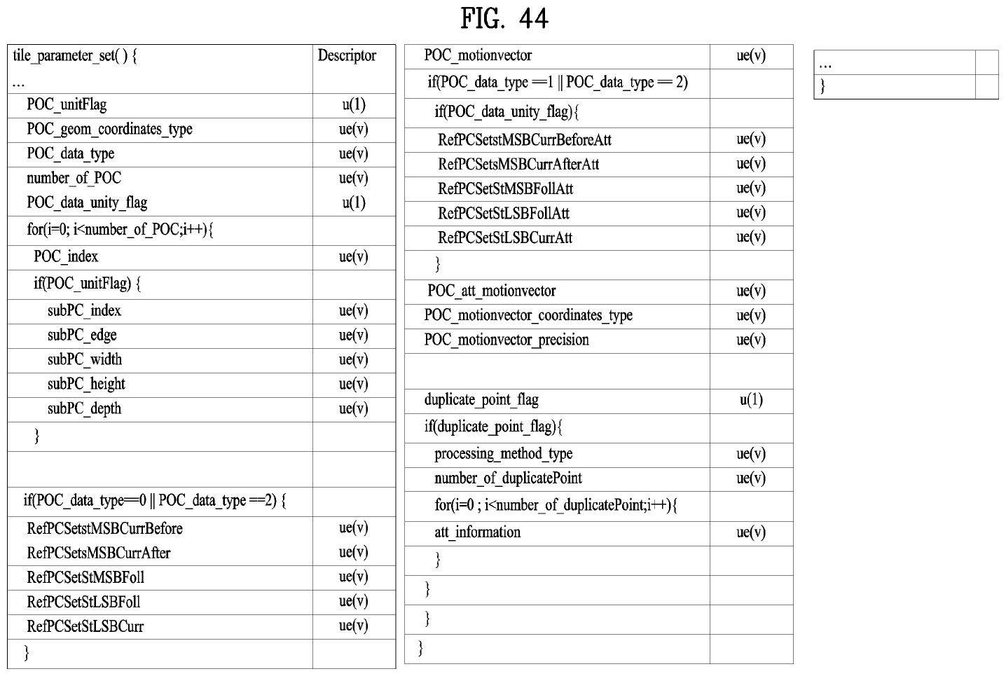

FIG. 44 shows another exemplary syntax structure of a tile parameter set (tile_parameter_set( )) (TPS) including buffer management information according to embodiments.

Fields included in the buffer management information in FIG. 44 have been described in detail with reference to FIGS. 37 to 41, and thus a description thereof will be skipped to avoid redundant description.

According to embodiments, the buffer management information of FIG. 44 may be included at any position (e.g., within the loop statement) in the TPS of FIG. 42. The buffer management information of FIG. 44 may be applied when buffer management of point cloud data is performed per tile or tile group.

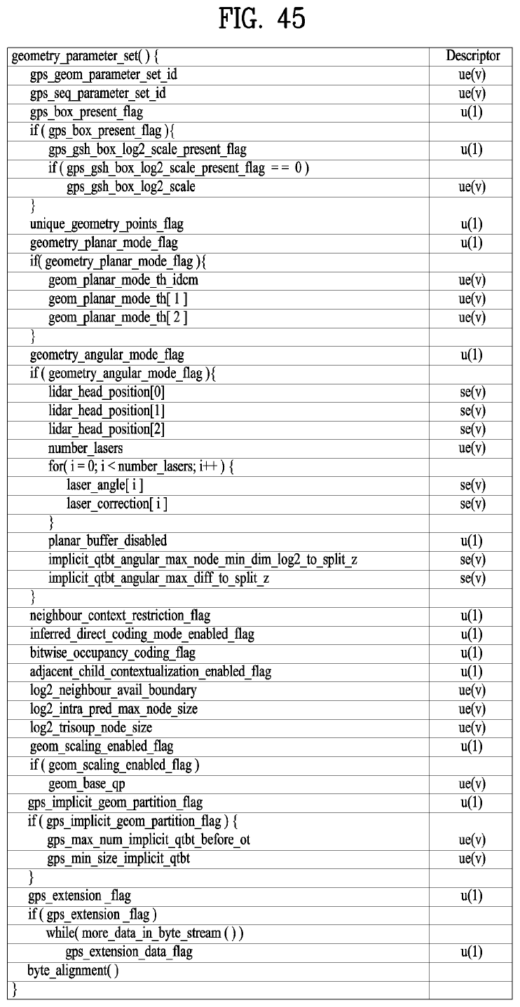

FIG. 45 shows an embodiment of a syntax structure of the GPS (geometry_parameter_set( )) according to the present disclosure. The GPS may include information on a method of encoding geometry information of point cloud data included in one or more slices.

According to embodiments, the GPS may include a gps_geom_parameter_set_id field, a gps_seq_parameter_set_id field, gps_box_present_flag field, a unique_geometry_points_flag field, a geometry_planar_mode_flag field, a geometry_angular_mode_flag field, a neighbour_context_restriction_flag field, a inferred_direct_coding_mode_enabled_flag field, a bitwise_occupancy_coding_flag field, an adjacent_child_contextualization_enabled_flag field, a log2_neighbour_avail_boundary field, a log2_intra_pred_max_node_size field, a log2_trisoup_node_size field, a geom_scaling_enabled_flag field, a gps_implicit_geom_partition_flag field, and a gps_extension_flag field.

The gps_geom_parameter_set_id field provides an identifier for the GPS for reference by other syntax elements.

The gps_seq_parameter_set_id field specifies the value of sps_seq_parameter_set_id for the active SPS.

The gps_box_present_flag field specifies whether additional bounding box information is provided in a geometry slice header that references the current GPS. For example, the gps_box_present_flag field equal to 1 may specify that additional bounding box information is provided in a geometry slice header that references the current GPS. Accordingly, when the gps_box_present_flag field is equal to 1, the GPS may further include a gps_gsh_box_log2_scale_present_flag field.

The gps_gsh_box_log2_scale_present_flag field specifies whether the gps_gsh_box_log2_scale field is signaled in each geometry slice header that references the current GPS. For example, the gps_gsh_box_log2_scale_present_flag field equal to 1 may specify that the gps_gsh_box_log2_scale field is signaled in each geometry slice header that references the current GPS. As another example, the gps_gsh_box_log2_scale_present_flag field equal to 0 may specify that the gps_gsh_box_log2_scale field is not signaled in each geometry slice header and a common scale for all slices is signaled in the gps_gsh_box_log2_scale field of the current GPS.

When the gps_gsh_box_log2_scale_present_flag field is equal to 0, the GPS may further include a gps_gsh_box_log2_scale field.

The gps_gsh_box_log2_scale field indicates the common scale factor of the bounding box origin for all slices that refer to the current GPS.

unique_geometry_points_flag indicates whether all output points have unique positions in one slice in all slices currently referring to GPS. For example, unique_geometry_points_flag equal to 1 indicates that in all slices that refer to the current GPS, all output points have unique positions within a slice. unique_geometry_points_flag field equal to 0 indicates that in all slices that refer to the current GPS, the two or more of the output points may have same positions within a slice.

The geometry_planar_mode_flag field indicates whether the planar coding mode is activated. For example, geometry_planar_mode_flag equal to 1 indicates that the planar coding mode is active. geometry_planar_mode_flag equal to 0 indicates that the planar coding mode is not active.

When the value of the geometry_planar_mode_flag field is 1, that is, TRUE, the GPS may further include a geom_planar_mode_th_idcm field, a geom_planar_mode_th[1] field, and a geom_planar_mode_th[2] field.

The geom_planar_mode_th_idcm field may specify the value of the threshold of activation for the direct coding mode.

geom_planar_mode_th[i] specifies, for i in the range of 0 . . . 2, specifies the value of the threshold of activation for planar coding mode along the i-th most probable direction for the planar coding mode to be efficient.

geometry_angular_mode_flag indicates whether the angular coding mode is active. For example, geometry_angular_mode_flag field equal to 1 may indicate that the angular coding mode is active. geometry_angular_mode_flag field equal to 0 may indicate that the angular coding mode is not active.

When the value of the geometry_angular_mode_flag field is 1, that is, TRUE, the GPS may further include an lidar_head_position[0] field, a lidar_head_position[1] field, a lidar_head_position[2] field, a number_lasers field, a planar_buffer_disabled field, an implicit_qtbt_angular_max_node_min_dim_log2_to_split_z field, and an implicit_qtbt_angular_max_diff_to_split_z field.

The lidar_head_position[0] field, lidar_head_position[1] field, and lidar_head_position[2] field may specify the (X, Y, Z) coordinates of the lidar head in the coordinate system with the internal axes.

number_lasers specifies the number of lasers used for the angular coding mode.

The GPS according to the embodiments includes an loop statement that is repeated as many times as the value of the number_lasers field. In an embodiment, i is initialized to 0, and is incremented by 1 each time the loop statement is executed. The loop statement is repeated until the value of i becomes equal to the value of the number_lasers field. This loop statement may include a laser_angle[i] field and a laser_correction[i] field.

laser_angle[i] specifies the tangent of the elevation angle of the i-th laser relative to the horizontal plane defined by the 0-th and the 1st internal axes.

laser_correction[i] specifies the correction, along the second internal axis, of the i-th laser position relative to the lidar_head_position[2].

planar_buffer_disabled equal to 1 indicates that tracking the closest nodes using a buffer is not used in process of coding the planar mode flag and the plane position in the planar mode. planar_buffer_disabled equal to 0 indicates that tracking the closest nodes using a buffer is used.

implicit_qtbt_angular_max_node_min_dim_log2_to_split_z specifies the log 2 value of a node size below which horizontal split of nodes is preferred over vertical split.

implicit_qtbt_angular_max_diff_to_split_z specifies the log 2 value of the maximum vertical over horizontal node size ratio allowed to a node.

neighbour_context_restriction_flag equal to 0 indicates that geometry node occupancy of the current node is coded with the contexts determined from neighbouring nodes which is located inside the parent node of the current node. neighbour_context_restriction_flag equal to 1 indicates that geometry node occupancy of the current node is coded with the contexts determined from neighbouring nodes which is located inside or outside the parent node of the current node.

The inferred_direct_coding_mode_enabled_flag field indicates whether the direct_mode_flag field is present in the geometry node syntax. For example, the inferred_direct_coding_mode_enabled_flag field equal to 1 indicates that the direct_mode_flag field may be present in the geometry node syntax. For example, the inferred_direct_coding_mode_enabled_flag field equal to 0 indicates that the direct_mode_flag field is not present in the geometry node syntax.

The bitwise_occupancy_coding_flag field indicates whether geometry node occupancy is encoded using bitwise contextualization of the syntax element occupancy map. For example, the bitwise_occupancy_coding_flag field equal to 1 indicates that geometry node occupancy is encoded using bitwise contextualisation of the syntax element ocupancy_map. For example, the bitwise_occupancy_coding_flag field equal to 0 indicates that geometry node occupancy is encoded using the dictionary encoded syntax element occupancy_byte.

The adjacent_child_contextualization_enabled_flag field indicates whether the adjacent children of neighboring octree nodes are used for bitwise occupancy contextualization. For example, the adjacent_child_contextualization_enabled_flag field equal to 1 indicates that the adjacent children of neighboring octree nodes are used for bitwise occupancy contextualization. For example, adjacent_child_contextualization_enabled_flag equal to 0 indicates that the children of neighbouring octree nodes are not used for the occupancy contextualization. The log2_neighbour_avail_boundary field specifies the value of the variable NeighbAvailBoundary that is used in the decoding process.

For example, when the neighbour_context_restriction_flag field is equal to 1, NeighbAvailabilityMask may be set equal to 1. For example, when the neighbour_context_restriction_flag field is equal to 0, NeighbAvailabilityMask may be set equal to 1<<log2_neighbour_avail_boundary.

The log2_intra_pred_max_node_size field specifies the octree node size eligible for occupancy intra prediction.

The log2_trisoup_node_size field specifies the variable TrisoupNodeSize as the size of the triangle nodes.

geom_scaling_enabled_flag indicates specifies whether a scaling process for geometry positions is applied during the geometry slice decoding process. For example, geom_scaling_enabled_flag equal to 1 specifies that a scaling process for geometry positions is applied during the geometry slice decoding process. geom_scaling_enabled_flag equal to 0 specifies that geometry positions do not require scaling.

geom_base_qp indicates the base value of the geometry position quantization parameter.

gps_implicit_geom_partition_flag indicates whether the implicit geometry partition is enabled for the sequence or slice. For example, equal to 1 specifies that the implicit geometry partition is enabled for the sequence or slice. gps_implicit_geom_partition_flag equal to 0 specifies that the implicit geometry partition is disabled for the sequence or slice. When gps_implicit_geom_partition_flag is equal to 1, the following two fields, that is, a gps_max_num_implicit_qtbt_before_ot field and a gps_min_size_implicit_qtbt field, are signaled.

gps_max_num_implicit_qtbt_before_ot specifies the maximal number of implicit QT and BT partitions before OT partitions. Then, the variable K is initialized by gps_max_num_implicit_qtbt_before_ot as follows.

K=gps_max_num_implicit_qtbt_before_ot.

gps_min_size_implicit_qtbt specifies the minimal size of implicit QT and BT partitions. Then, the variable M is initialized by gps_min_size_implicit_qtbt as follows.

M=gps_min_size_implicit_qtbt

gps_extension_flag indicates whether a gps_extension_data syntax structure is present in the GPS syntax structure. For example, gps_extension_flag equal to 1 indicates that the gps_extension_data syntax structure is present in the GPS syntax. For example, gps_extension_flag equal to 0 indicates that the gps_extension_data syntax structure is not present in the GPS syntax.

When gps_extension_flag is equal to 1, the GPS according to the embodiments may further include a gps_extension_data_flag field.

gps_extension_data_flag may have any value. Its presence and value do not affect decoder conformance to profiles.

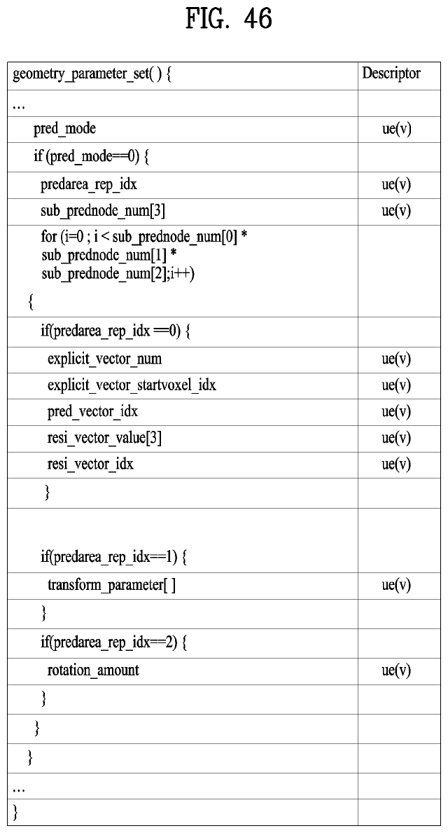

FIG. 46 shows another exemplary syntax structure of a geometry parameter set (geometry_parameter_set( )) (GPS) including information related to prediction of point cloud data according to embodiments.

Fields included in the information related to prediction of the point cloud data of FIG. 46 have been described in detail with reference to FIGS. 34 to 36, and thus a description thereof will be skipped to avoid redundant description.

According to embodiments, the information related to prediction of point cloud data in FIG. 46 may be included at any position in the GPS of FIG. 45. The information related to prediction of the point cloud data in FIG. 46 may be applied when inter-prediction is performed on geometry information.

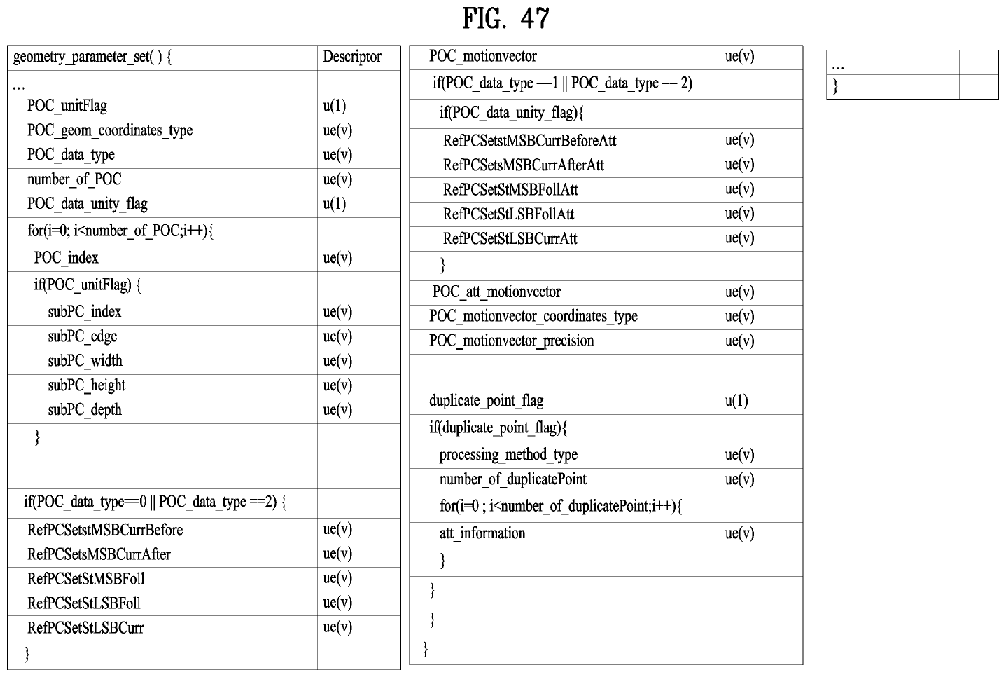

FIG. 47 shows another exemplary syntax structure of a geometry parameter set (geometry_parameter_set( )) (GPS) including buffer management information according to embodiments.

Fields included in the buffer management information of FIG. 47 have been described in detail with reference to FIGS. 37 to 41, and thus a description thereof will be skipped to avoid redundant description.

According to embodiments, the buffer management information of FIG. 47 may be included at any position in the GPS of FIG. 45.

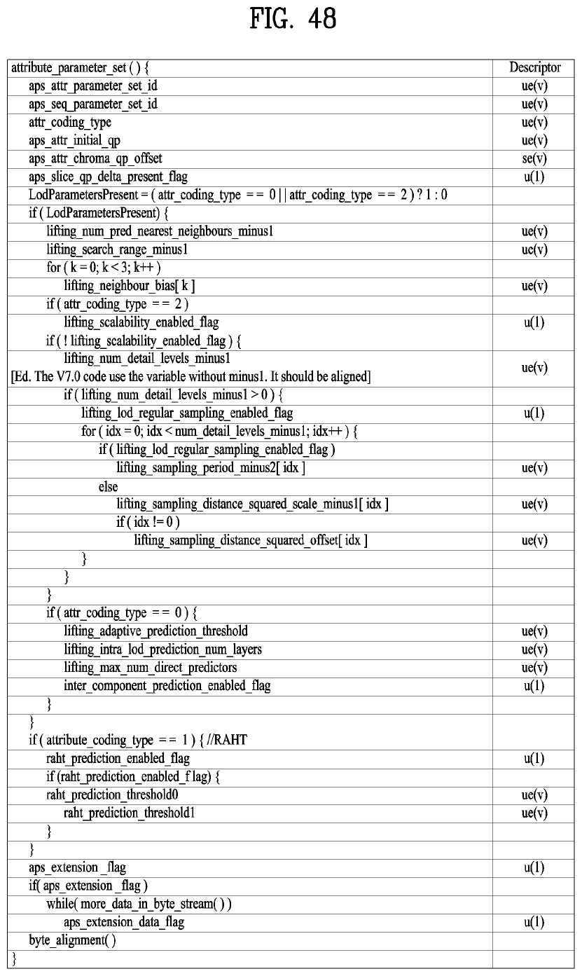

FIG. 48 shows an embodiment of a syntax structure of the attribute parameter set (APS) (attribute_parameter_set( )) according to the present disclosure. The APS according to the embodiments may contain information on a method of encoding attribute information about point cloud data contained in one or more slices.

The APS according to the embodiments may include an aps_attr_parameter_set_id field, an aps_seq_parameter_set_id_field, an attr_coding_type field, an aps_attr_initial_qp field, an aps_attr_chroma_qp_offset field, an aps_slice_qp_delta_present_flag field, and an aps_extension_flag field.

The aps_attr_parameter_set_id field provides an identifier for the APS for reference by other syntax elements.

The aps_seq_parameter_set_id field specifies the value of sps_seq_parameter_set_id for the active SPS.

The attr_coding_type field indicates the coding type for the attribute.

According to embodiments, the attr_coding_type field equal to 0 may indicate predicting weight lifting as the coding type. The attr_coding_type field equal to 1 may indicate RAHT as the coding type. The attr_coding_type field equal to 2 may indicate fix weight lifting.

The aps_attr_initial_qp field specifies the initial value of the variable SliceQp for each slice referring to the APS.

The aps_attr_chroma_qp_offset field specifies the offsets to the initial quantization parameter signaled by the syntax aps_attr_initial_qp.

The aps_slice_qp_delta_present_flag field specifies whether the ash_attr_qp_delta_luma and ash_attr_qp_delta_chroma syntax elements are present in the attribute slice header (ASH). For example, the aps_slice_qp_delta_present_flag field equal to 1 specifies that the ash_attr_qp_delta_luma and ash_attr_qp_delta_chroma syntax elements are present in the ASH. For example, the aps_slice_qp_delta_present_flag field specifies that the ash_attr_qp_delta_luma and ash_attr_qp_delta_chroma syntax elements are not present in the ASH.

When the value of the attr_coding_type field is 0 or 2, that is, the coding type is predicting weight lifting or fix weight lifting, the APS according to the embodiments may further include a lifting_num_pred_nearest_neighbours_minus1 field, a lifting_search_range_minus1 field, and a lifting_neighbour_bias[k] field.

lifting_num_pred_nearest_neighbours plus 1 specifies the maximum number of nearest neighbors to be used for prediction. According to embodiments, the value of NumPredNearestNeighbours is set equal to lifting_num_pred_nearest_neighbours.

lifting_search_range_minus1 plus 1 specifies the search range used to determine nearest neighbours to be used for prediction and to build distance-based levels of detail (LODs). The variable LiftingSearchRange for specifying the search range may be obtained by adding 1 to the value of the lifting_search_range_minus1 field (LiftingSearchRange=lifting_search_range_minus1+1).

The lifting_neighbour_bias[k] field specifies a bias used to weight the k-th components in the calculation of the Euclidean distance between two points as part of the nearest neighbor derivation process.

When the value of the attr_coding_type field is 2, that is, when the coding type indicates fix weight lifting, the APS according to the embodiments may further include a lifting_scalability_enabled_flag field.

The lifting_scalability_enabled_flag field specifies whether the attribute decoding process allows the pruned octree decode result for the input geometry points. For example, the lifting_scalability_enabled_flag field equal to 1 specifies that the attribute decoding process allows the pruned octree decode result for the input geometry points. The lifting_scalability_enabled_flag field equal to 0 specifies that that the attribute decoding process requires the complete octree decode result for the input geometry points.

According to embodiments, when the value of the lifting_scalability_enabled_flag field is FALSE, the APS may further include a lifting_num_detail_levels_minus1 field.

The lifting_num_detail_levels_minus1 field specifies the number of levels of detail for the attribute coding. The variable LevelDetailCount for specifying the number of LODs may be obtained by adding 1 to the value of the lifting_num_detail_levels_minus1 field. (LevelDetailCount=lifting_num_detail_levels_minus1+1).

According to embodiments, when the value of the lifting_num_detail_levels_minus1 field is greater than 1, the APS may further include a lifting_lod_regular_sampling_enabled_flag field.

The lifting_lod_regular_sampling_enabled_flag field specifies whether levels of detail (LODs) are built by a regular sampling strategy. For example, the lifting_lod_regular_sampling_enabled_flag equal to 1 specifies that levels of detail (LOD) are built by using a regular sampling strategy. The lifting_lod_regular_sampling_enabled_flag equal to 0 specifies that a distance-based sampling strategy is used instead.

According to embodiments, when the value of the lifting_scalability_enabled_flag field is FALSE, the APS may further include an loop statement iterated as many times as the value of the lifting_num_detail_levels_minus1 field. In an embodiment, the index (idx) is initialized to 0 and incremented by 1 every time the loop statement is executed, and the loop statement is iterated until the index (idx) is greater than the value of the lifting_num_detail_levels_minus1 field. This loop statement may include a lifting_sampling_period_minus2 [idx] field when the value of the lifting_lod_decimation_enabled_flag field is TRUE (e.g., 1), and may include a lifting_sampling_distance_squared_scale_minus1 [idx] field when the value of the lifting_lod_regular_sampling_enabled_flag field is FALSE (e.g., 0). Also, when the value of idx is not 0 (idx !=0), a lifting_sampling_distance_squared_offset [idx] field may be further included.

lifting_sampling_period_minus2 [idx] plus 2 specifies the sampling period for the level of detail idx.

lifting_sampling_distance_squared_scale_minu1 [idx] plus 1 specifies the scale factor for the derivation of the square of the sampling distance for the level of detail idx.

The lifting_sampling_distance_squared_offset [idx] field specifies the offset of the derivation of the square of the sampling distance for the level of detail idx.

When the value of the attr_coding_type field is 0, that is, when the coding type is predicting weight lifting, the APS according to the embodiments may further include a lifting_adaptive_prediction_threshold field, a lifting_intra_lod_prediction_num_layers field, a lifting_max_num_direct_predictors field, and an inter_component_prediction_enabled_flag field.

The lifting_adaptive_prediction_threshold field specifies the threshold to enable adaptive prediction. According to embodiments, a variable AdaptivePredictionThreshold for specifying a threshold for switching an adaptive predictor selection mode is set equal to the value of the lifting_adaptive_prediction_threshold field (AdaptivePredictionThreshold=lifting_adaptive_prediction_threshold).

The lifting_intra_lod_prediction_num_layers field specifies the number of LOD layers where decoded points in the same LOD layer could be referred to generate a prediction value of a target point. For example, the lifting_intra_lod_prediction_num_layers field equal to LevelDetailCount indicates that target point could refer to decoded points in the same LOD layer for all LOD layers. For example, the lifting_intra_lod_prediction_num_layers field equal to 0 indicates that target point could not refer to decoded points in the same LoD layer for any LoD layers. The lifting_max_num_direct_predictors field specifies the maximum number of predictors to be used for direct prediction. The value of the lifting_max_num_direct_predictors field shall be in the range of 0 to LevelDetailCount.

The inter_component_prediction_enabled_flag field specifies whether the primary component of a multi component attribute is used to predict the reconstructed value of non-primary components. For example, if the inter_component_prediction_enabled_flag field equal to 1 specifies that the primary component of a multi component attribute is used to predict the reconstructed value of non-primary components. The inter_component_prediction_enabled_flag field equal to 0 specifies that all attribute components are reconstructed independently.

According to the embodiments, when the value of the attr_coding_type field is 1, that is, when the attribute coding type is RAHT, the APS may further include a raht_prediction_enabled_flag field.

The raht_prediction_enabled_flag field specifies whether the transform weight prediction from the neighbor points is enabled in the RAHT decoding process. For example, the raht_prediction_enabled_flag field equal to 1 specifies the transform weight prediction from the neighbor points is enabled in the RAHT decoding process. raht_prediction_enabled_flag equal to 0 specifies that the transform weight prediction is disabled in the RAHT decoding process.

According to embodiments, when the value of the raht_prediction_enabled_flag field is TRUE, the APS may further include a raht_prediction_threshold0 field and a raht_prediction_threshold1 field.

The raht_prediction_threshold0 field specifies a threshold to terminate the transform weight prediction from neighbour points.

The raht_prediction_threshold1 field specifies a threshold to skip the transform weight prediction from neighbour points.

The aps_extension_flag field specifies whether the aps_extension_data_flag syntax structure is present in the APS syntax structure. For example, aps_extension_flag equal to 1 indicates that the aps_extension_data syntax structure is present in the APS syntax structure. For example, aps_extension_flag equal to 0 indicates that the aps_extension_data syntax structure is not present in the APS syntax structure.

When the value of the aps_extension_flag field is 1, the APS according to the embodiments may further include an aps_extension_data_flag field.

The aps_extension_data_flag field may have any value. Its presence and value do not affect decoder conformance to profiles.

The APS according to the embodiments may further include information related to LoD-based attribute compression.

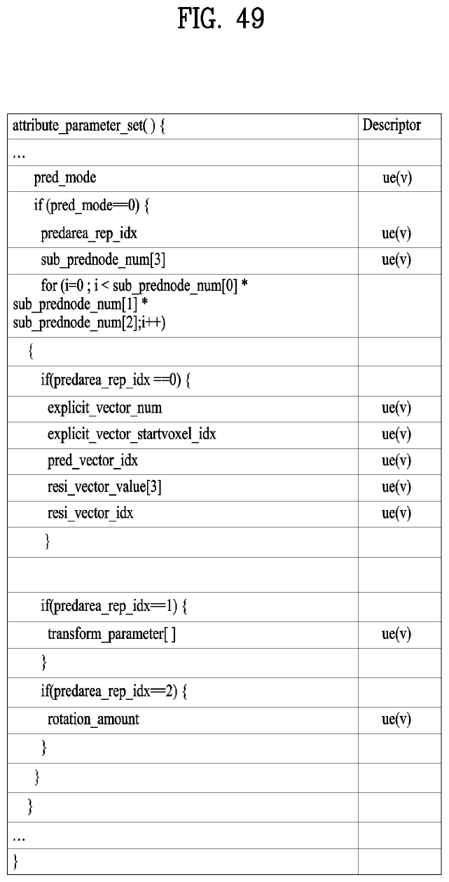

FIG. 49 shows an exemplary syntax structure of an attribute parameter set (attribute_parameter_set( )) (APS) including information related to point cloud data prediction according to embodiments.

Fields included in the information related to point cloud data prediction in FIG. 49 have been described in detail with reference to FIGS. 34 to 36, and thus a description thereof will be skipped to avoid redundant description.

According to embodiments, the information related to prediction of point cloud data in FIG. 49 may be included at any position in the APS of FIG. 48.

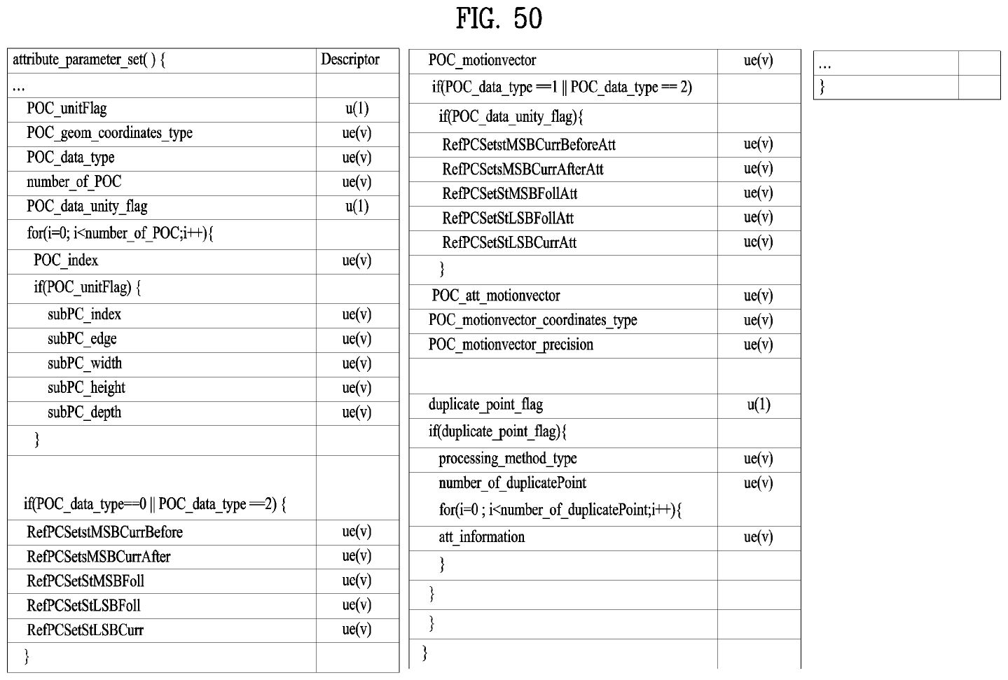

FIG. 50 shows an exemplary syntax structure of an attribute parameter set (attribute_parameter_set( )) (APS) including buffer management information according to embodiments.

Fields included in the buffer management information in FIG. 50 have been described in detail with reference to FIGS. 37 to 41, and thus a description thereof will be skipped to avoid redundant description.

According to embodiments, the buffer management information of FIG. 50 may be included at any position in the APS of FIG. 48.

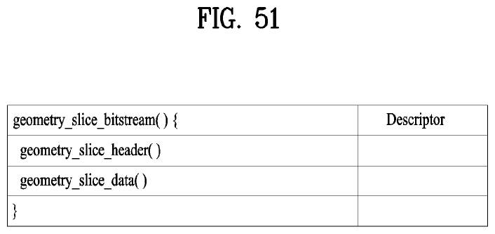

FIG. 51 shows an embodiment of a syntax structure of a geometry slice bitstream( ) according to the present disclosure. According to embodiments, the geometry slice bitstream( ) is referred to as a geometry data unit.

The geometry slice bitstream (geometry_slice_bitstream( )) according to the embodiments may include a geometry slice header (geometry_slice_header( )) and geometry slice data (geometry_slice_data( )).

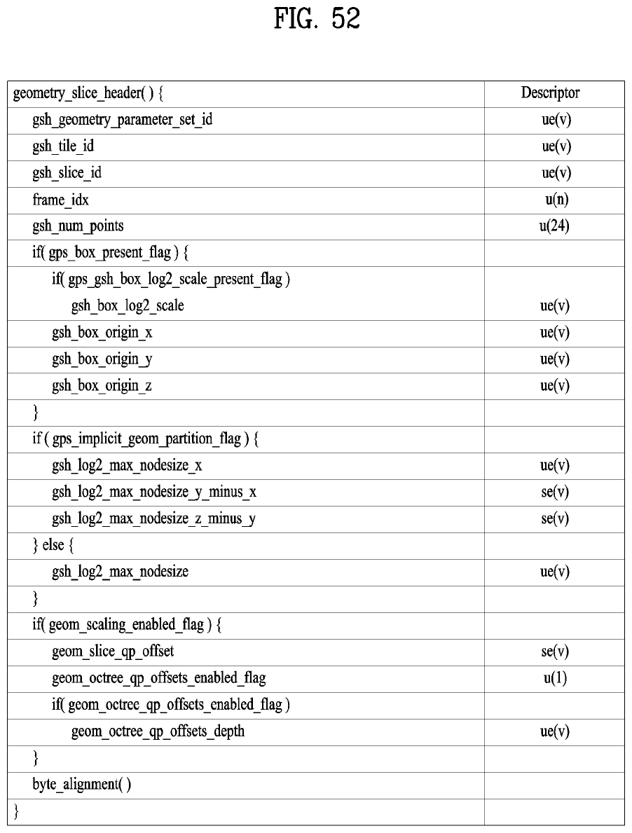

FIG. 52 shows an embodiment of a syntax structure of a geometry slice header (geometry_slice_header( )) according to the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_header( )) according to the embodiments may include a gsh_geometry_parameter_set_id field, a gsh_tile_id field, gsh_slice_id field, a frame_idx field, a gsh_num_points field, and a byte_alignment( ) field.

When the value of the gps_box_present_flag field included in the GPS is TRUE (e.g., 1), and the value of the gps_gsh_box_log2_scale_present_flag field is TRUE (e.g., 1), the geometry slice header (geometry_slice_header( )) according to the embodiments may further include a gsh_box_log2_scale field, a gsh_box_origin_x field, a gsh_box_origin_y field, and a gsh_box_origin_z field.

gsh_geometry_parameter_set_id specifies the value of the gps_geom_parameter_set_id of the active GPS.

The gsh_tile_id field specifies the value of the tile id that is referenced by the GSH.

The gsh_slice_id specifies ID of the slice for reference by other syntax elements.

The frame_idx field indicates log2_max_frame_idx+1 least significant bits of a conceptual frame number counter. Consecutive slices with differing values of frame_idx form parts of different output point cloud frames. Consecutive slices with identical values of frame_idx without an intervening frame boundary marker data unit form parts of the same output point cloud frame.

The gsh_num_points field indicates the maximum number of coded points in a slice. According to embodiments, it is a requirement of bitstream conformance that gsh_num_points is greater than or equal to the number of decoded points in the slice.

The gsh_box_log2_scale field specifies the scaling factor of the bounding box origin for the slice.

The gsh_box_origin_x field specifies the x value of the bounding box origin scaled by the value of the gsh_box_log2_scale field.

The gsh_box_origin_y field specifies the y value of the bounding box origin scaled by the value of the gsh_box_log2_scale field.

The gsh_box_origin_z field specifies the z value of the bounding box origin scaled by the value of the gsh_box_log2_scale field.

Here, the variables slice_origin_x, slice_origin_y, and slice_origin_z may be derived as follows.

When gps_gsh_box_log2_scale_present_flag is equal to 0, originScale is set to gsh_box_log2_scale.

When gps_gsh_box_log2_scale_present_flag is equal to 1, originScale is set to gps_gsh_box_log2_scale.

When gps_box_present_flag is equal to 0, the values of the variables slice_origin_x, slice_origin_y, and slice_origin_z are inferred to be 0.

When gps_box_present_flag is equal to 1, the following equations will be applied to the variables slice_origin_x, slice_origin_y, and slice_origin_z.

slice_origin_x=gsh_box_origin_x<<originScale

slice_origin_y=gsh_box_origin_y<<originScale

slice_origin_z=gsh_box_origin_z<<originScale

When the value of the gps_implicit_geom_partition_flag field is TRUE (i.e., 0), the geometry slice header ((geometry_slice_header( )) may further include a gsh_log2_max_nodesize_x field, a gsh_log2_max_nodesize_y_minus_x field, and a gsh_log2_max_nodesize_z_minus_y field. When the value of the gps_implicit_geom_partition_flag field is FALSE (i.e., 1), the geometry slice header may further include a gsh_log2_max_nodesize field.

The gsh_log2_max_nodesize_x field specifies the bounding box size in the x dimension, i.e., MaxNodesizeXLog2 that is used in the decoding process as follows.

MaxNodeSizeXLog2=gsh_log2_max_nodesize_x

MaxNodeSizeX=1<<MaxNodeSizeXLog2

The gsh_log2_max_nodesize_y_minus_x field specifies the bounding box size in the y dimension, i.e., MaxNodesizeYLog2 that is used in the decoding process as follows.

MaxNodeSizeYLog2=gsh_log2_max_nodesize_y_minus_x+MaxNodeSizeXLog2.

MaxNodeSizeY=1<<MaxNodeSizeYLog2.

The gsh_log2_max_nodesize_z_minus_y field specifies the bounding box size in the z dimension, i.e., MaxNodesizeZLog2 that is used in the decoding process as follows.

MaxNodeSizeZLog2=gsh_log2_max_nodesize_z_minus_y+MaxNodeSizeYLog2

MaxNodeSizeZ=1<<MaxNodeSizeZLog2

When the value of the gps_implicit_geom_partition_flag field is 1, gsh_log2_max_nodesize is obtained as follows.

gsh_log2_max_nodesize=max{MaxNodeSizeXLog2, MaxNodeSizeYLog2, MaxNodeSizeZLog2}

The gsh_log2_max_nodesize field specifies the size of the root geometry octree node when gps_implicit_geom_partition_flag is equal to 0.

Here, the variables MaxNodeSize and MaxGeometryOctreeDepth are derived as follows.

MaxNodeSize=1<<gsh_log2_max_nodesize

MaxGeometryOctreeDepth=gsh_log2_max_nodesize-log2_trisoup_node_size

When the value of the geom_scaling_enabled_flag field is TRUE, the geometry slice header (geometry_slice_header( )) according to the embodiments may further include a geom_slice_qp_offset field and a geom_octree_qp_offsets_enabled_flag field.

The geom_slice_qp_offset field specifies an offset to the base geometry quantization parameter geom_base_qp.

The geom_octree_qp_offsets_enabled_flag field specifies whether the geom_octree_qp_ofsets_depth field is present in the geometry slice header. For example, geom_octree_qp_offsets_enabled_flag equal to 1 specifies that the geom_octree_qp_ofsets_depth field is present in the geometry slice header. geom_octree_qp_offsets_enabled_flag equal to 0 specifies that the geom_octree_qp_ofsets_depth field is not present.

The geom_octree_qp_offsets_depth field specifies the depth of the geometry octree.

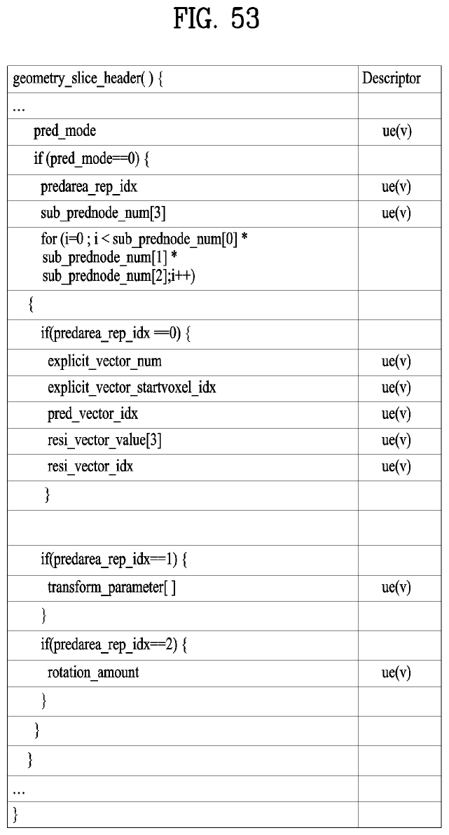

FIG. 53 shows an exemplary syntax structure of a geometry slice header (geometry_slice_header( )) including information related to prediction of point cloud data according to embodiments.

Fields included in the information related to prediction of point cloud data in FIG. 53 have been described in detail with reference to FIGS. 34 to 36, and thus a description thereof will be skipped to avoid redundant description.

According to embodiments, the information related to prediction of point cloud data in FIG. 53 may be included at any position in the geometry slice header of FIG. 52. The information related to prediction of the point cloud data in FIG. 53 may be applied when prediction of the point cloud data is performed on a per slice basis.

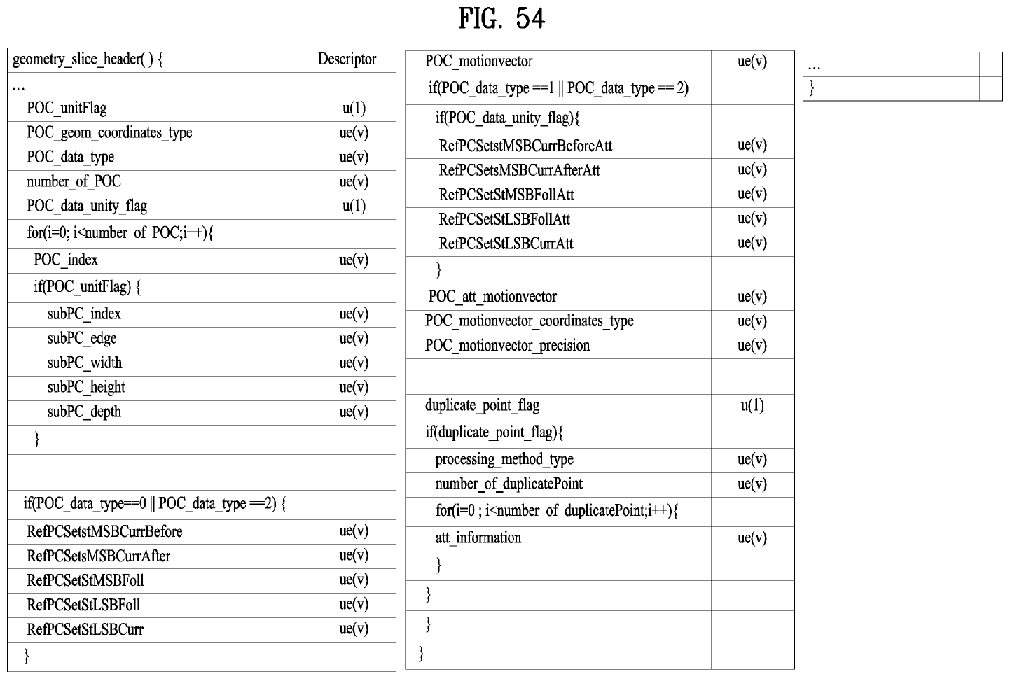

FIG. 54 shows another exemplary syntax structure of a geometry slice header (geometry_slice_header( )) including buffer management information according to embodiments.

Fields included in the buffer management information in FIG. 54 have been described in detail with reference to FIGS. 37 to 41, and thus a description thereof will be skipped to avoid redundant description.

According to embodiments, the buffer management information of FIG. 54 may be included at any position in the geometry slice header of FIG. 52. The buffer management information of FIG. 54 may be applied when buffer management of point cloud data is performed on a per slice basis.

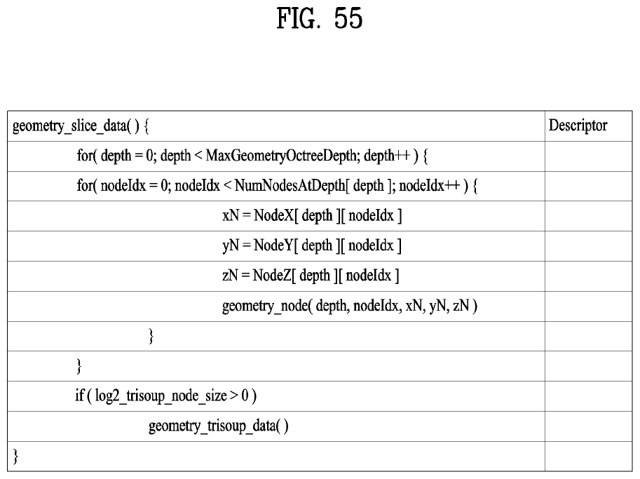

FIG. 55 shows an embodiment of a syntax structure of geometry slice data (geometry_slice_data( )) according to the present disclosure. The geometry slice data (geometry_slice_data( )) according to the embodiments may carry a geometry bitstream belonging to a corresponding slice.

The geometry_slice_data( ) according to the embodiments may include a first loop statement repeated as many times as by the value of MaxGeometryOctreeDepth. In an embodiment, the depth is initialized to 0 and is incremented by 1 each time the loop statement is executed, and the first loop statement is repeated until the depth becomes equal to MaxGeometryOctreeDepth. The first loop statement may include a second loop statement repeated as many times as the value of NumNodesAtDepth. In an embodiment, nodeidx is initialized to 0 and is incremented by 1 each time the loop statement is executed. The second loop statement is repeated until nodeidx becomes equal to NumNodesAtDepth. The second loop statement may include xN=NodeX[depth][nodeIdx], yN=NodeY[depth][nodeIdx], zN=NodeZ[depth][nodeIdx], and geometry_node(depth, nodeIdx, xN, yN, zN). MaxGeometryOctreeDepth indicates the maximum value of the geometry octree depth, and NumNodesAtDepth[depth] indicates the number of nodes to be decoded at the corresponding depth. The variables NodeX[depth][nodeIdx], NodeY[depth][nodeIdx], and NodeZ[depth][nodeIdx] indicate the x, y, z coordinates of the idx-th node in decoding order at a given depth. The geometry bitstream of the node of the depth is transmitted through geometry_node(depth, nodeIdx, xN, yN, zN).

The geometry slice data (geometry_slice_data( )) according to the embodiments may further include geometry_trisoup_data( ) when the value of the log2_trisoup_node_size field is greater than 0. That is, when the size of the triangle nodes is greater than 0, a geometry bitstream subjected to trisoup geometry encoding is transmitted through geometry_trisoup_data( ).

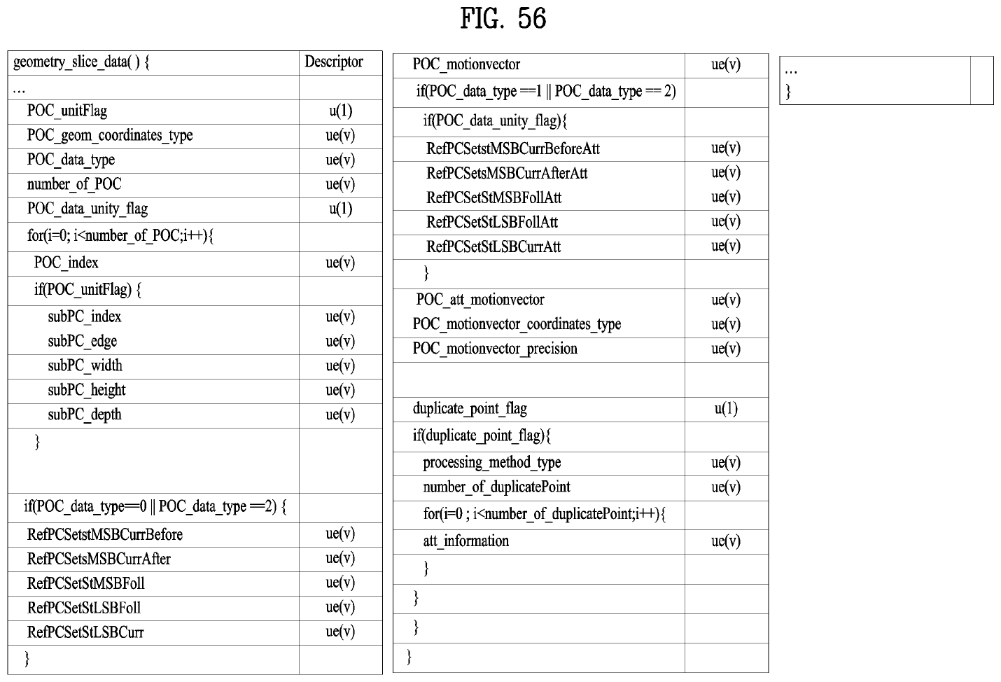

FIG. 56 shows an exemplary syntax structure of geometry slice data (geometry_slice_data( )) including buffer management information according to embodiments.

Fields included in the buffer management information in FIG. 56 have been described in detail with reference to FIGS. 37 to 41, and thus a description thereof will be skipped to avoid redundant description.

According to embodiments, the buffer management information of FIG. 56 may be included at any position in the geometry slice data of FIG. 55. The buffer management information of FIG. 56 may be applied when buffer management is performed on a per slice basis.

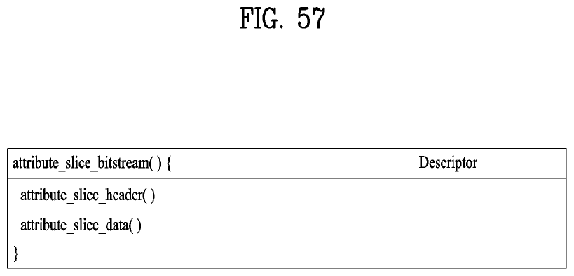

FIG. 57 shows an embodiment of a syntax structure of an attribute slice bitstream( ). According to embodiments, the attribute slice bitstream( ) is referred to as an attribute data unit.

The attribute slice bitstream (attribute_slice_bitstream ( )) according to the embodiments may include an attribute slice header (attribute_slice_header( )) and attribute slice data (attribute_slice_data( )).

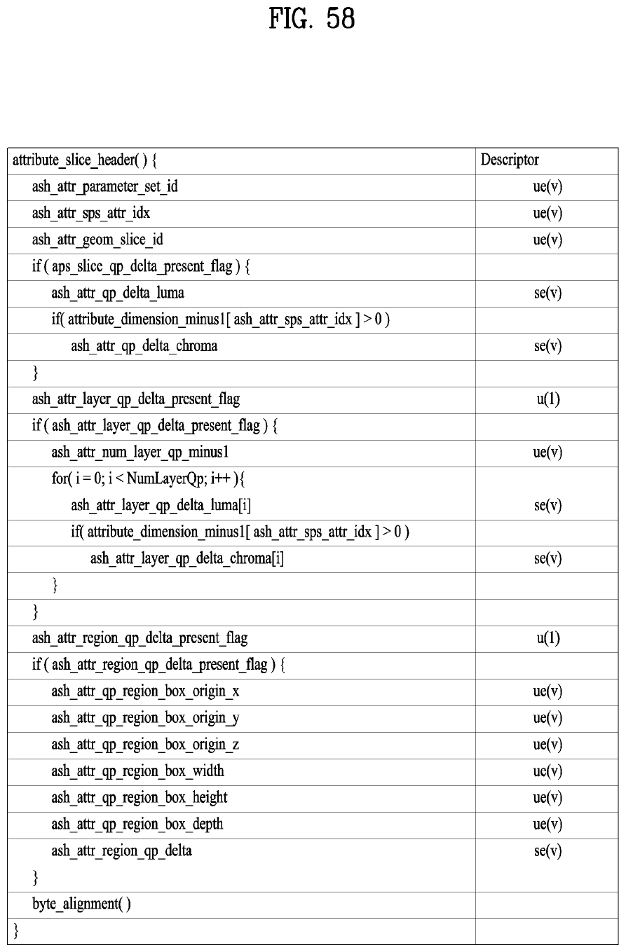

FIG. 58 shows an embodiment of a syntax structure of an attribute slice header (attribute_slice_header( )) according to the present disclosure.

The attribute slice header (attribute_slice_header( )) according to the embodiments may include an ash_attr_parameter_set_id field, an ash_attr_sps_attr_idx field, an ash_attr_geom_slice_id field, an ash_attr_layer_qp_delta_present_flag field, and an ash_attr_region_qp_delta_present_flag field.

When the value of the aps_slice_qp_delta_present_flag field of the APS is TRUE (e.g., 1), the attribute slice header (attribute_slice_header( )) according to the embodiments may further include a ash_attr_qp_delta_luma field. When the value of the attribute_dimension_minus1 [ash_attr_sps_attr_idx] field is greater than 0, the attribute slice header may further include an ash_attr_qp_delta_chroma field.

The ash_attr_parameter_set_id field specifies the value of the aps_attr_parameter_set_id field of the current active APS.

The ash_attr_sps_attr_idx field specifies an attribute set in the current active SPS.

The ash_attr_geom_slice_id field specifies the value of the gsh_slice_id field of the current geometry slice header.

The ash_attr_qp_delta_luma field specifies a luma delta quantization parameter qp derived from the initial slice qp in the active attribute parameter set.

The ash_attr_qp_delta_chroma field specifies the chroma delta qp derived from the initial slice qp in the active attribute parameter set.

The variables InitialSliceQpY and InitialSliceQpC are derived as follows.

InitialSliceQpY=aps_attrattr_initial_qp+ash_attr_qp_delta_luma

InitialSliceQpC=aps_attrattr_initial_qp+aps_attr_chroma_qp_offset+ash_attr_qp_delta_chroma

The ash_attr_layer_qp_delta_present_flag field specifies whether the ash_attr_layer_qp_delta_luma field and the ash_attr_layer_qp_delta_chroma field are present in the ASH for each layer. For example, when the value of the ash_attr_layer_qp_delta_present_flag field is 1, it indicates that the ash_attr_layer_qp_delta_luma field and the ash_attr_layer_qp_delta_chroma field are present in the ASH. When the value is 0, it indicates that the fields are not present.

When the value of the ash_attr_layer_qp_delta_present_flag field is TRUE, the ASH may further include an ash_attr_num_layer_qp_minus1 field.

ash_attr_num_layer_qp_minus1 plus 1 indicates the number of layers through which the ash_attr_qp_delta_luma field and the ash_attr_qp_delta_chroma field are signaled. When the ash_attr_num_layer_qp field is not signaled, the value of the ash_attr_num_layer_qp field will be 0. According to embodiments, NumLayerQp specifying the number of layers may be obtained by adding 1 to the value of the ash_attr_num_layer_qp_minus1 field (NumLayerQp=ash_attr_num_layer_qp_minus1+1).

According to embodiments, when the value of the ash_attr_layer_qp_delta_present_flag field is TRUE, the geometry slice header may include a loop iterated as many times as the value of NumLayerQp. In this case, in an embodiment, i may be initialized to 0 and incremented by 1 every time the loop is executed, and the loop is iterated until the value of i reaches the value of NumLayerQp. This loop contains an ash_attr_layer_qp_delta_luma[i] field. Also, when the value of the attribute_dimension_minus1[ash_attr_sps_attr_idx] field is greater than 0, the loop may further include an ash_attr_layer_qp_delta_chroma[i] field.

The ash_attr_layer_qp_delta_luma field indicates a luma delta quantization parameter qp from InitialSliceQpY in each layer.

The ash_attr_layer_qp_delta_chroma field indicates a chroma delta quantization parameter qp from InitialSliceQpC in each layer.

The variables SliceQpY[i] and SliceQpC[i] with i=0, . . . , NumLayerQPNumQPLayer−1 are derived as follows.

for ( i = 0; i < NumLayerQPNumQPLayer; i++) {
SliceQpY[i] = InitialSliceQpY + ash_attr_layer_qp_delta_luma[i]
SliceQpC[i] = InitialSliceQpC + ash_attr_layer_qp_delta_chroma[i]
}

ash_attr_region_qp_delta_present_flag equal to 1 indicates that ash_attr_region_qp_delta, region bounding box origin, and size are present in the current the attribute slice header (attribute_slice_header( )) according to the embodiments. ash_attr_region_qp_delta_present_flag equal to 0 indicates that the ash_attr_region_qp_delta, region bounding box origin, and size are not present in the current attribute slice header.

That is, when the value of the ash_attr_layer_qp_delta_present_flag field is 1, the attribute slice header may further include an ash_attr_qp_region_box_origin_x field, an ash_attr_qp_region_box_origin_y field, an ash_attr_qp_region_box_origin_z field, an ash_attr_qp_region_box_width field, an ash_attr_qp_region_box_height field, an ash_attr_qp_region_box_depth field, and an ash_attr_region_qp_delta field.

The ash_attr_qp_region_box_origin_x field indicates the x offset of the region bounding box relative to slice_origin_x.

The ash_attr_qp_region_box_origin_y field indicates the y offset of the region bounding box relative to slice_origin_y.

The ash_attr_qp_region_box_origin_z field indicates the z offset of the region bounding box relative to slice_origin_z.

The ash_attr_qp_region_box_size_width field indicates the width of the region bounding box.

The ash_attr_qp_region_box_size_height field indicates the height of the region bounding box.

The ash_attr_qp_region_box_size_depth field indicates the depth of the region bounding box.

The ash_attr_region_qp_delta field indicates delta qp from SliceQpY[i] and SliceQpC[i] of a region specified by the ash_attr_qp_region_box field.

According to embodiments, the variable RegionboxDeltaQp specifying a region box delta quantization parameter is set equal to the value of the ash_attr_region_qp_delta field (RegionboxDeltaQp=ash_attr_region_qp_delta).

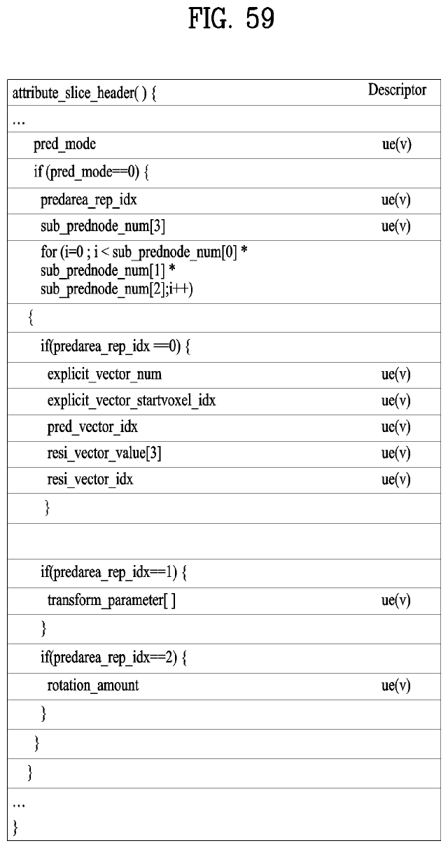

FIG. 59 shows an exemplary syntax structure of an attribute slice header (attribute_slice_header( )) including information related to point cloud data prediction according to embodiments.

Fields included in the information related to prediction of point cloud data in FIG. 59 have been described in detail with reference to FIGS. 34 to 36, and thus a description thereof will be skipped to avoid redundant description.

According to embodiments, the information related to prediction of point cloud data in FIG. 59 may be included at any position in the attribute slice header of FIG. 58. The information related to prediction of the point cloud data in FIG. 59 may be applied when prediction of the point cloud data is performed on a per slice basis.

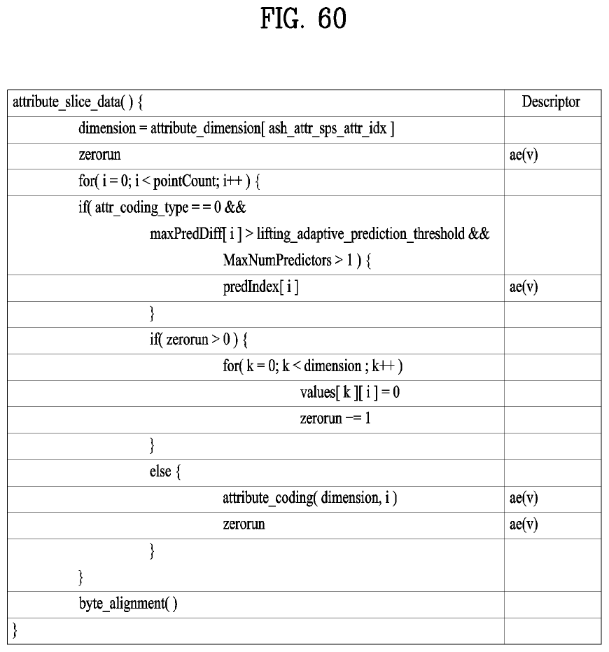

FIG. 60 shows an embodiment of a syntax structure of attribute slice data (attribute_slice_data( )) according to the present disclosure. The attribute slice data (attribute_slice_data( )) may carry an attribute bitstream belonging to a corresponding slice. The attribute slice data may include attributes or attribute-related data in relation to some or all of the point clouds.

In the attribute slice data (attribute_slice_data( )) of FIG. 60, dimension=attribute_dimension[ash_attr_sps_attr_idx] indicates the attribute_dimension of an attribute set identified by the ash_attr_sps_attr_idx field in the corresponding attribute slice header. The attribute_dimension represents the number of components constituting an attribute. An attributes according to embodiments indicates reflectance, color, or the like. Therefore, the number of components differs among attributes. For example, an attribute corresponding to color may have three color components (e.g., RGB). Accordingly, an attribute corresponding to reflectance may be a mono-dimensional attribute, and an attribute corresponding to color may be a three-dimensional attribute.

The attributes according to the embodiments may be attribute-encoded per dimension.

For example, an attribute corresponding to reflectance and an attribute corresponding to color may be each attribute-encoded. Also, attributes according to the embodiments may be attribute-encoded together regardless of the dimensions. For example, an attribute corresponding to reflectance and an attribute corresponding to color may be attribute-encoded together.

In FIG. 60, zerorun specifies the number of 0 prior to residual.

Also, in FIG. 60, according to an embodiment, i represents the value of the i-th point for the attribute, and the attr_coding_type field and the lifting_adaptive_prediction_threshold field are signaled in the APS.

MaxNumPredictors in FIG. 60 is a variable used in the point cloud data decoding process, and may be obtained based on the value of the lifting_adaptive_prediction_threshold field signaled in the APS as follows.

MaxNumPredictors=lifting_max_num_direct_predicots+1

Here, the lifting_max_num_direct_predictors field indicates the maximum number of predictors to be used for direct prediction.

predIndex[i] according to the embodiments specifies the predictor index (or referred to as prediction mode) to decode the i-th point value of the attribute. The value of the predIndex[i] ranges from 0 to the value of the lifting_max_num_direct_predictors field.

Operations of the above-described embodiments may also be performed through components of a point cloud transmission/reception device/method according to embodiments described below. Each component may correspond to hardware, software, a processor, and/or a combination thereof. In the present embodiment, a method of compressing geometry information of point cloud data is described. However, the method described in the present disclosure may be applied to attribute information compression and other compression methods.

In the present disclosure, an RPS parameter set may be newly defined, and buffer management information may be added to the RPS parameter set and signaled.

According to embodiments, the RPS parameter set may belong to the SPS, GPS, APS, TPS, geometry slice header, and geometry slice data, or may operate independently.

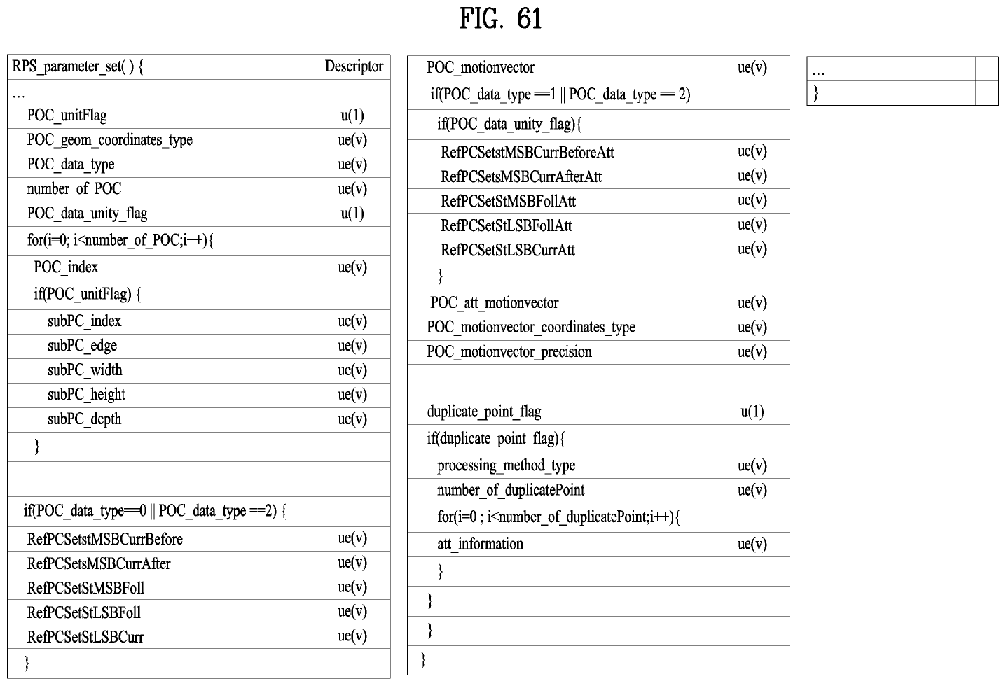

FIG. 61 shows an exemplary syntax structure of an RPS parameter set (RPS_parameter_set( )) including buffer management information according to embodiments.

Fields included in the buffer management information in FIG. 61 have been described in detail with reference to FIGS. 37 to 41, and thus a description thereof will be skipped to avoid redundant description.

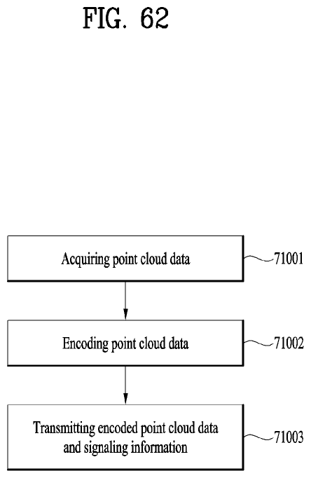

FIG. 62 is a flowchart of a point cloud data transmission method according to embodiments.

The point cloud data transmission method according to the embodiments may include acquiring point cloud data (71001), encoding the point cloud data (71002), and transmitting the encoded point cloud data and signaling information (71003). In this case, a bitstream containing the encoded point cloud data and signaling information may be encapsulated in a file and transmitted.

In the operation 71001 of acquiring point cloud data, some or all of the operations of the point cloud video acquisition unit 10001 of FIG. 1 or some or all of the operations of the data input unit 12000 of FIG. 12 may be performed.

In the operation 71002 of encoding the point cloud data, some or all of the operations of the point cloud video encoder 10002 of FIG. 1, the encoding 20001 of FIG. 2, the point cloud video encoder of FIG. 4, the point cloud video encoder of FIG. 12, the geometry encoder and attribute encoder of FIG. 15, and the geometry encoder and attribute encoder of FIG. 16 may be performed.

In the operation 71002 of encoding the point cloud data, the geometry information and/or attribute information are compressed by applying inter-prediction or intra-prediction and entropy-encoded to output a geometry bitstream and/or an attribute bitstream, as described above with reference to FIGS. 15 to 23. In addition, in the operation 71002 of encoding the point cloud data, a buffer configured to store reconstructed geometry information and/or reconstructed attribute information is managed for intra-prediction or inter-prediction as described in FIGS. 26 to 31.

Information related to prediction of the point cloud data used to compress the point cloud data by applying intra-prediction or inter-prediction to the point cloud data and/or buffer management information used to manage the buffer may be signaled at least one of an SPS, a GPS, an APS, a TPS, an SEI message, a geometry slice header, geometry slice data, a attribute slice header, and attribute slice data and transmitted to the reception device. The buffer management information may be signaled in a separate RPS parameter set and transmitted to the reception device. For fields included in the information related to prediction of the point cloud data, refer to the descriptions of FIGS. 34 to 36. For fields included in the buffer management information, refer to the descriptions of FIGS. 37 to 41.

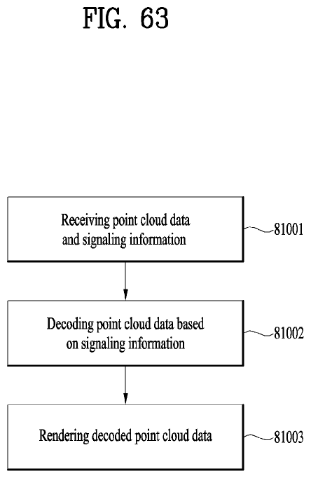

FIG. 63 is a flowchart of a point cloud data reception method according to embodiments.

The point cloud data reception method according to the embodiments may include receiving encoded point cloud data and signaling information (81001), decoding the point cloud data based on the signaling information (81002), and rendering the decoded point cloud data (81003).

The operation 81001 of receiving the point cloud data and signaling information may be performed by the receiver 10005 of FIG. 1, the transmission 20002 or the decoding 20003 of FIG. 2, the receiver 13000 or the reception processor 13001 of FIG. 13.

The signaling information may include information related to compression of the point cloud data and/or buffer management information. The information related to compression of the point cloud and/or the buffer management information is signaled in at least one of an SPS, a GPS, an APS, a TPS, an SEI message, a geometry slice header, geometry slice data, an attribute slice header, and attribute slice data and received by the reception device. The buffer management information may be signaled in a separate RPS parameter set. For fields included in the information related to prediction of the point cloud data, refer to the descriptions of FIGS. 34 to 36. For fields included in the buffer management information, refer to the descriptions of FIGS. 37 to 41.

In the operation 81002 of decoding the point cloud data, some or of the operations of the point cloud video decoder 10006 of FIG. 1, the decoding 20003 of FIG. 2, the point cloud video decoder of FIG. 11, the point cloud video decoder of FIG. 13, the geometry video decoder 61003 and the attribute decoder 61004 of FIG. 25, and the geometry video decoder 61003 and the attribute decoder 61004 of FIG. 26 may be performed.

In the operation 81002 of decoding the point cloud data, the received geometry bitstream and/or attribute bitstream are decompressed by applying inter-prediction or intra-prediction based on information related to prediction of the point cloud data, as described above with reference to FIGS. 15 to 31. Also, a buffer configured to store reconstructed geometry information and/or reconstructed attribute information referenced in inter-prediction or intra-prediction may be managed based on the buffer management information.

According to embodiments, in the operation 81002 of decoding the point cloud data, residual geometry information included in the received geometry bitstream may be entropy-decoded, and one or more reference regions of a current node of geometry information to be decoded may be derived from reconstructed geometry information stored in the buffer based on the information related to prediction of the point cloud data. Then, predictive geometry information may be generated based on the one or more derived reference regions. In addition, geometry information may be reconstructed by adding the entropy-decoded residual geometry information and the predictive geometry information. In this case, the reconstruction geometry information is stored in the buffer in order to derive one or more reference regions from the reconstruction geometry information.

In the rendering operation 81003, the point cloud data may be reconstructed based on the decoded (or decompressed) geometry information and attribute information and then rendered according to various rendering methods. For example, points of the point cloud content may be rendered as a vertex having a specific thickness, a cube having a specific minimum size centered at the vertex position, or a circle centered at the vertex position. All or some regions of the rendered point cloud content are provided to the user through a display (e.g., VR/AR display, general display, etc.). The rendering 81003 of point cloud data may be performed by the renderer 10007 of FIG. 1, the rendering 20004 of FIG. 2, or the renderer 13011 of FIG. 13.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in the present disclosure may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

### MODE FOR INVENTION

As described above, related contents have been described in the best mode for carrying out the embodiments.

### INDUSTRIAL APPLICABILITY

As described above, the embodiments may be fully or partially applied to the point cloud data transmission/reception device and system. It will be apparent to those skilled in the art that variously changes or modifications may be made to the embodiments within the scope of the embodiments. Thus, it is intended that the embodiments cover the modifications and variations of this disclosure provided they come within the scope of the appended claims and their equivalents.

1. A method of transmitting point cloud data, the method comprising:
acquiring the point cloud data;
encoding geometry information including positions of points of the point cloud data by applying inter-prediction or intra-prediction;
encoding attribute information including attribute values of the points of the point cloud data by applying the inter-prediction or the intra-prediction based on the geometry information; and
transmitting the encoded geometry information, the encoded attribute information, and signaling information,
wherein the signaling information includes information related to prediction of the point cloud data, and
wherein the information related to the prediction of the point cloud data includes geometry-related prediction information and attribute-related prediction information.

2. The method of claim 1, wherein the encoding of the geometry information comprises:
deriving one or more reference regions of a current node of the geometry information from reconstructed geometry information stored in a buffer, and generating predicted geometry information based on the one or more derived reference regions;
outputting a difference between the geometry information and the predicted geometry information as residual geometry information; and
entropy-encoding the residual geometry information and outputting a geometry bitstream.

3. The method of claim 2, wherein the encoding of the geometry information comprises:
reconstructing the geometry information by adding the predicted geometry information and the residual geometry information; and
storing the reconstructed geometry information in the buffer for the derivation of the one or more reference regions from the reconstructed geometry information.

4. The method of claim 2, wherein the encoding of the geometry information comprises:
storing, in the buffer, reconstructed geometry information temporally close to the geometry information to be currently encoded and removing, from the buffer, reconstructed geometry information temporally distant from the geometry information to be currently encoded.

5. The method of claim 4, wherein the signaling information further includes buffer management information related to management of the buffer.

6. A device for transmitting point cloud data, the device comprising:
a data acquirer configured to acquire the point cloud data;
a geometry encoder configured to encode geometry information including positions of points of the point cloud data by applying inter-prediction or intra-prediction;
an attribute encoder configured to encode attribute information including attribute values of the points of the point cloud data by applying the inter-prediction or the intra-prediction based on the geometry information; and
a transmitter configured to transmit the encoded geometry information, the encoded attribute information, and signaling information,
wherein the signaling information includes information related to prediction of the point cloud data, and
wherein the information related to the prediction of the point cloud data includes geometry-related prediction information and attribute-related prediction information.

7. The device of claim 6, wherein the geometry encoder comprises:
a geometry information predictor configured to derive one or more reference regions of a current node of the geometry information from reconstructed geometry information stored in a buffer, and generating predicted geometry information based on the one or more derived reference regions;
a residual geometry information generator configured to output a difference between the geometry information and the predicted geometry information as residual geometry information; and
an entropy encoder configured to output entropy-encode the residual geometry information and output a geometry bitstream.

8. The device of claim 7, wherein the geometry encoder comprises:
a geometry information reconstructor configured to reconstruct the geometry information by adding the predicted geometry information and the residual geometry information; and
a buffer configured to store the reconstructed geometry information for the derivation of the one or more reference regions from the reconstructed geometry information.

9. The device of claim 7, wherein the geometry encoder stores, in the buffer, reconstructed geometry information temporally close to the geometry information to be currently encoded and removes, from the buffer, reconstructed geometry information temporally distant from the geometry information to be currently encoded.

10. The device of claim 9, wherein the signaling information further includes buffer management information related to management of the buffer.

11. A method of receiving point cloud data, the method comprising:
receiving geometry information, attribute information, and signaling information;
decoding the geometry information by applying inter-prediction or intra-prediction based on the signaling information and reconstructing positions of points;
decoding the attribute information by applying the inter-prediction or the intra-prediction based on the signaling information and the geometry information and reconstructing attribute values of the points; and
rendering the point cloud data that is reconstructed based on the positions and attribute values of the points,
wherein the signaling information includes information related to prediction of the point cloud data, and
wherein the information related to the prediction of the point cloud data includes geometry-related prediction information and attribute-related prediction information.

12. The method of claim 11, wherein the decoding of the geometry information comprises:
entropy-decoding residual geometry information included in the received geometry information;
deriving one or more reference regions of a current node of geometry information to be decoded from reconstructed geometry information stored in a buffer based on the signaling information, and generating predicted geometry information based on the one or more derived reference regions; and
outputting reconstructed geometry information by adding the entropy-decoded residual geometry information and the predicted geometry information.

13. The method of claim 12, wherein the decoding of the geometry information further comprises:
storing the reconstructed geometry information in the buffer for the derivation of the one or more reference regions from the reconstructed geometry information.

14. The method of claim 12, wherein the decoding of the geometry information further comprises:
storing reconstructed geometry information temporally close to the geometry information to be currently decoded in the buffer and removing, from the buffer, reconstructed geometry information temporally distant from the geometry information to be currently decoded.

15. The method of claim 14, wherein the signaling information further includes buffer management information related to management of the buffer.
